(19) United States
(12) Patent Application Publication
(10) Pub. No.: US 2025/0209617 A1
(43) Pub. Date: Jun. 26, 2025

(54) IMAGE REGISTRATION IN PRIMARY ANALYSIS

(71) Applicant: Element Biosciences, Inc., San Diego, CA (US)

(72) Inventors: Minghao GUO, San Diego, CA (US); Haosen WANG, San Diego, CA (US); Rui MA, San Diego, CA (US); Francisco GARCIA, San Diego, CA (US); Semyon KRUGLYAK, San Diego, CA (US)

(21) Appl. No.: 18/968,535

(22) Filed: Dec. 4, 2024

Related U.S. Application Data
(63) Continuation of application No. PCT/US2023/067931, filed on Jun. 5, 2023.
(60) Provisional application No. 63/349,421, filed on Jun. 6, 2022.

(51) Int. Cl. G06T 7/00

(52) U.S. Cl. CPC G06T 7/0012; G06T 2207/10004; G06T 2207/30024

(57) ABSTRACT

Systems, methods, and computer storage media for image registration in primary analysis are provided. In some embodiments, coordinates of polonies in a reference coordinate system are determined, wherein the polonies are obtained from flow cell images in one or more reference cycles. One or more template images in the reference coordinate system are generated by registering the polonies to the one or more template images using the coordinates thereof. A flow cell image in a cycle is obtained. A plurality of transformations of the flow cell image is then determined based on the one or more template images, each of the plurality of transformations corresponding to a subtile of the flow cell image and configured to register the subtile of the flow cell image to the one or more template images.

### CROSS REFERENCE TO RELATED APPLICATIONS

This application is a continuation of PCT/US2023/067931 filed Jun. 5, 2023, which claims the benefit of U.S. Provisional Patent Application No. 63/349,421, filed Jun. 6, 2022, which are hereby incorporated by reference in their entireties.

### TECHNICAL FIELD

This disclosure relates generally to imaging registration, and particularly to image registration of flow cell images acquired in different sequencing cycles and from different channels for making accurate base calling during DNA sequencing.

### BACKGROUND

In next-generation sequencing (NGS) or NGS-like applications such as sequencing by synthesis, sequencing by binding, or sequencing by avidity, in order to identify the sequence of a target nucleic acid, a new strand is synthesized one nucleotide base at a time. During each cycle, 3′-blocked nucleotides attach at complementary positions on the strands, ensuring that only one base will attach to any given strand during a single cycle. At the imaging step of each sequencing cycle, one or more images are recorded. A base-calling algorithm is applied to the images to “read” the successive signals from each cluster or polony and convert the optical signals into an identification of the nucleotide base sequence added to each DNA fragment. However, between sequencing cycles, the stage of the flow cell can move relative to the objective lens so the clusters and polonies do not appear at exact same locations in the images. Even if the stage stays at the exact position across cycles, the clusters or polonies may drift on the flow cell to different positions. Further, small changes induced by the filters and dyes may introduce image transformation between channels. As a result, the accuracy of base calling of a given cluster or polony can be reduced. There is a need for image registration that can bring flow cell images across cycles and/or channels into a common coordinate system, i.e., by image registration, for accurate base calling.

### SUMMARY

Provided herein are system, apparatus, method, and/or computer program product embodiments, and/or combinations and sub-combinations thereof which enables image registration and/or image registration rescue of flow cell images during primary analysis of DNA sequencing analysis. The flow cell images can come from different sequencing cycles and/or different channels. As a particular application of such, provided herein are embodiments of method, system, and media for image registration and/or image registration rescue, so that the image intensity, location, and/or size of clusters or polonies can be relied on for accurate base calling.

Other embodiments of these embodiments include corresponding computer systems, apparatus, and computer program products recorded on computer storage device(s), which, alone or in combination, are configured to perform the actions or operations of the methods. For a computer system configured or to be configured to perform the operations or actions, the computer system has installed on it software, firmware, hardware, or their combinations that in operation cause the computer system to perform the operations or actions. For a computer program product configured or to be configured to perform the operations or actions, the computer program product includes instructions that, when executed, by a hardware processor, cause the hardware processor to perform the operations or actions.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 illustrates a block diagram of a system for performing DNA sequencing, image registration, and image registration rescue of flow cell images, according to some embodiments.

FIG. 2 shows a schematic diagram of flow cell images, subtiles, and regions with polonies or clusters, according to some embodiments.

FIG. 3 shows a schematic diagram of a portion of a flow cell with multiple tiles, according to some embodiments.

FIG. 4 illustrates a block diagram of a computer system for performing image registration, according to some embodiments.

FIG. 5 illustrates a flow chart of a method for performing image registration of flow cell images, according to some embodiments.

FIGS. 6A-6B show a schematic diagram of an image transformation and corresponding 2D shifts, according to some embodiments.

FIG. 7 is a schematic showing an example linear single stranded library molecule.

FIG. 8 is a schematic showing an example linear single stranded library molecule.

FIG. 9 is a schematic of various example configurations of multivalent molecules.

FIG. 10 is a schematic of an example multivalent molecule comprising a generic core attached to a plurality of nucleotide-arms.

FIG. 11 is a schematic of an example multivalent molecule comprising a dendrimer core attached to a plurality of nucleotide-arms.

FIG. 12 shows a schematic of an example multivalent molecule comprising a core attached to a plurality of nucleotide-arms, where the nucleotide arms comprise biotin, spacer, linker and a nucleotide unit.

FIG. 13 is a schematic of an example nucleotide-arm comprising a core attachment moiety, spacer, linker and nucleotide unit.

FIG. 14 shows the chemical structure of an example spacer (top), and the chemical structures of various example linkers, including an 11-atom Linker, 16-atom Linker, 23-atom Linker and an N3 Linker (bottom).

FIG. 15 shows the chemical structures of various example linkers, including Linkers 1-9.

FIG. 16 shows the chemical structures of various example linkers joined/attached to nucleotide units.

FIG. 17 shows the chemical structures of various example linkers joined/attached to nucleotide units.

FIG. 18 shows the chemical structures of various example linkers joined/attached to nucleotide units.

FIG. 19 shows the chemical structures of various example linkers joined/attached to nucleotide units.

FIG. 20 shows the chemical structure of an example biotinylated nucleotide-arm. In this example, the nucleotide unit is connected to the linker via a propargyl amine attachment at the 5 position of a pyrimidine base or the 7 position of a purine base.

FIG. 21 shows example flow cell images from four different color channels of a specific flow cycle, according to some embodiments.

FIG. 22 shows example index assignment rates that are improved using an embodiment of the image registration rescue methods herein.

FIG. 23 shows example index mismatch rates that are improved using an embodiment of the image registration rescue methods herein.

FIG. 24A illustrates a flow chart of a method for performing image registration rescue of flow cell images, according to some embodiments.

FIG. 24B illustrates a flow chart of a method for performing image registration rescue of flow cell images, according to some embodiments.

FIG. 25 is a schematic of an example test target, according to some embodiments.

FIG. 26 illustrates a schematic drawing of an example beaded flow cell having surfaces coated with fluorescent beads.

FIG. 27 provides a schematic illustration of an example embodiment of the low binding solid supports of the present disclosure in which the support comprises a glass substrate and alternating layers of hydrophilic coatings which are covalently or non-covalently adhered to the glass, and which further comprises chemically-reactive functional groups that serve as attachment sites for oligonucleotide primers.

FIG. 28 is a schematic showing example embodiments of padlock probes, according to some embodiments.

FIG. 29 is a schematic showing a workflow for generating inside a cell circularized padlock probes, comprising generating first and second cDNAs from first and second target RNA molecules (respectively), hybridizing first and second padlock probes to the first and second cDNA molecules (respectively) to generate first and second circularized padlock probes (respectively), according to some embodiments.

FIG. 30 is a schematic showing a rolling circle and sequencing workflow inside a cell, comprising generating first and second concatemers by conducting rolling circle amplification using first and second covalently closed circular molecules (respectively), according to some embodiments.

FIG. 31 is a schematic showing an example workflow for sequencing a concatemer that is generated inside the cell, according to some embodiments.

FIG. 32 is a schematic showing an example workflow for sequencing a concatemer that is generated inside the cell, according to some embodiments.

FIG. 33 is a schematic showing an example workflow for sequencing a concatemer that is generated inside the cell, according to some embodiments.

FIG. 34 is a schematic showing an example workflow for sequencing a concatemer that is generated inside the cell, according to some embodiments.

### DETAILED DESCRIPTION

Provided herein are system, apparatus, method, and/or computer program product embodiments, and/or combinations and sub-combinations thereof which enables image registration and/or image registration rescue of flow cell images for accurate base calling. The image registration and registration rescue techniques can be used on flow cell images obtained from various imaging and/or sequencing techniques. The techniques can be used on flow cell images obtained from various sequencing samples including in situ samples. The techniques disclosed herein are useful for base calling in next generation sequencing, and base calling will be used as the primary example herein for describing the application of these techniques. However, such imaging analysis techniques may also be useful in other applications where spot-detection and/or charge coupled device (CCD) imaging is used.

In DNA sequencing, identifying the centers of clusters or polonies (which are often formed on beads) and generating base calls of the identified clusters and polonies are sometimes referred to as primary analysis. Primary analysis may also involve the formation of a template for the flow cell. The template can include the estimated locations of all detected clusters or polonies in a common coordinate system. Templates may be generated by identifying cluster or polony locations in all images in the first few cycles of the sequencing process. Ideally, during sequencing cycles, clusters or polonies remain at the same locations, so that base calling can be made with respect to the same clusters or polonies. However, the stage of the sequencer and/or the flow cell may not stay at the same location in every cycle, e.g., relative to the objective lens. In addition, the clusters or polonies may drift relative to the flow cell across different cycles. Changes induced by the filters and fluorescent dyes between different color channels may further introduce transformation of clusters or polonies in images acquired across different channels. A cluster or polony can be as small as 1-2 pixels, polonies tend to distribute on a flow cell image in a relatively random pattern. A small drift of a couple of pixels can significantly deteriorate accuracy and reliability on base calling of a given cluster or polony. For example, in cycle k, a first polony could have drifted to a location where a second polony used to be in cycle k−1, and without image registration, the base calling of the second polony in cycle k could be incorrect. The techniques disclosed herein can be used for image registration of flow cell images so that base calling in primary analysis can be performed accurately and reliably. A variety of algorithms exist for image registration. These existing algorithms may suffer from various shortcomings. For example, image registration by deriving a non-linear transformation of a flow cell image between cycles can exerts additional complexity to the algorithms and causes undesired delay in the registration and downstream operations. Additionally, the image registration using entire flow cell images can be computationally intensive and prone to delays and failures. Image registration method of adding external fiducial markers in the flow cell images may not reflect image offsets and other transformation between channels or across cycles and fiducial marks may add interference to the image intensities from polonies or clusters that require additional handling of such interference.

The techniques disclosed herein advantageously utilizes a plurality of transformations corresponding to subtiles of a flow cell image to estimate the image transformation of an entire flow cell image. The techniques disclosed herein are rooted in the characteristics of the transformation of flow cell images across cycles and between channels so that the transformation of subtiles can provide a reasonable estimation of the transformation of the flow cell image without excessive computational burden and delay to subsequent sequencing analysis. The determination of the plurality of transformations advantageously saves computational time, system data storage space, and reduces computational complexity while achieving accurate and efficient image registration results. The techniques disclosed herein also advantageously utilizes information in the neighboring subtiles when determining each individual transformation of a subtile. That way, the technologies herein allow improved image registration over methods that determine the transformation based on the subtile itself without increasing computational complexity or computational time. The technologies herein also enable reliable and accurate image registration even if the images are of low nucleotide diversity.

### Sequencing Systems

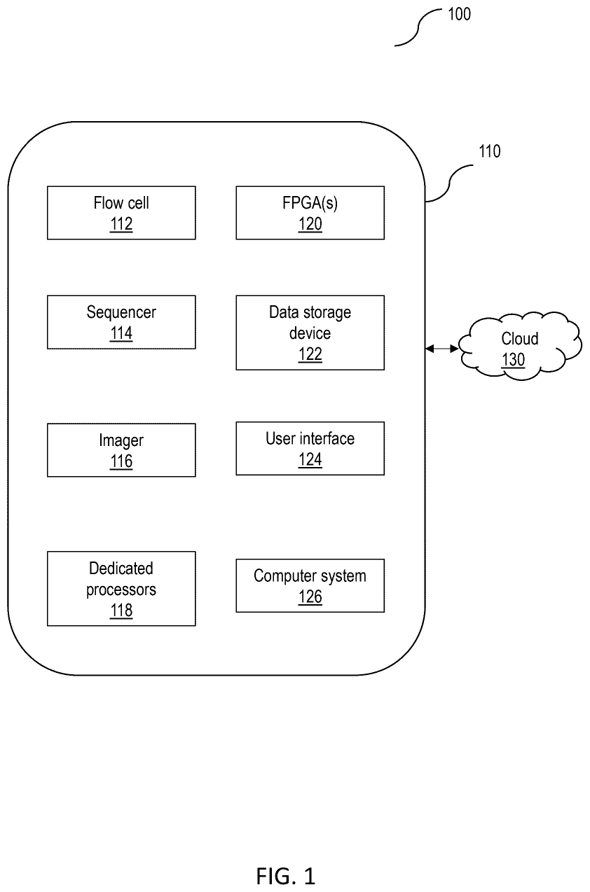

FIG. 1 illustrates a block diagram of a computer-implemented system 100, according to one or more embodiments disclosed herein. The system 100 has a sequencing system 110 that includes a flow cell 112, a sequencer 114, an imager 116, data storage 122, and user interface 124. The sequencing system 110 may be connected to a cloud 130. The sequencing system 110 may include one or more of dedicated processors 118, Field-Programmable Gate Array(s) (FPGAs) 120, and a computer system 126.

In some embodiments, the flow cell 112 is configured to capture DNA fragments and form DNA sequences for base-calling on the flow cell. The flow cell 112 may include the support as disclosed herein. The support can be a solid support. The support can include a surface coating thereon as disclosed herein. The surface coating can be a polymer coating as disclosed herein.

A flow cell 112 can include multiple tiles or imaging areas thereon, and each tile may be separated into a grid of subtiles. Each subtile can include a plurality of clusters or polonies thereon. As a nonlimiting example, a flow cell can have 424 tiles, and each tile can be divided into a 6×9 grid, therefore 54 subtiles. The flow cell image as disclosed herein can be an image including signals of a plurality of clusters or polonies. The flow cell image can include one or more tiles of signals or one or more subtiles of signals. In some embodiments, each tile or subtile may include millions of polonies or clusters. As a nonlimiting example, a tile may include 1,000 to 10 millions of clusters or polonies. Each polony may be a collection of many copies of DNA fragments. In some embodiments, a flow cell image may be an image that includes at least part of the tiles and approximately all signals thereon. The flow cell image may be acquired from a channel during an imaging or sequencing cycle using the imager 116.

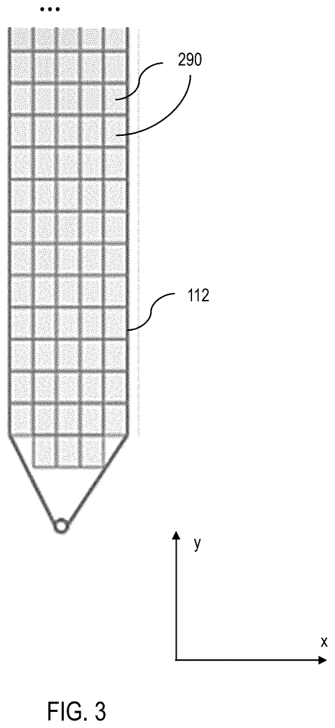

In cases where 3D samples, e.g., cells or tissues are immobilized on the flow cell, the flow cell images may be at multiple z levels which are orthogonal to the image plane of the flow cell images. As such, the flow cell images can include multiple z-levels in order to cover the whole sample in 3D. The z axis can extend from the objective lens of the optical system disclosed herein to the support, e.g., flow cell. Each z level of flow cell images may be separated from the adjacent z level(s) for a predetermined distance, for example, for about 0.1 um to about 15 ums. Each z level of flow cell images may be separated from the adjacent level(s) for 1 um to 10 ums. At each z-level, a flow cell image can be acquired from one or more sequencing cycles and/or one or more channels. Each flow cell image may include in its field of view at least part of one or more tiles or subtiles of the flow cell. FIG. 3 shows a portion of a flow cell 112 with multiple tiles 290. The image plane is defined by the x and y axis. And the z axis is orthogonal to the x-y plane. Although the flow cell images, samples, and the z axis are described in a Cartesian coordinate system as shown in FIG. 3, any other coordinate systems can be used to define spatial locations and relationships of the polonies or clusters and their images herein. Other coordinate systems can include but are not limited to the polar coordinate system, cylindrical, or spherical coordinate systems.

The sequencer 114 may be configured to flow a nucleotide mixture onto the flow cell 112, cleave blockers from the nucleotides in between flowing steps, and perform other steps for the formation of the DNA sequences on the flow cell 112. The nucleotides may have fluorescent elements attached that emit light or energy in a wavelength that indicates the type of nucleotide. Each type of fluorescent element may correspond to a particular nucleotide base (e.g., A, G, C, T). The fluorescent elements may emit light in visible wavelengths. In some embodiments, the sequencer 114 and the flow cell 112 may be configured to perform various sequencing methods disclosed herein, for example, sequencing-by-avidite.

For example, each nucleotide base may be assigned a color. Different types of nucleotides can have different colors. Adenine (A) may be red, cytosine (C) may be blue, guanine (G) may be green, and thymine (T) may be yellow, for example. The color or wavelength of the fluorescent element for each nucleotide may be selected so that the nucleotides are distinguishable from one another based on the wavelengths of light emitted by the fluorescent elements.

The imager 116 may be configured to capture images of the flow cell 112 after each flowing step. In an embodiment, the imager 116 is a camera configured to capture digital images, such as a CMOS or a CCD camera. The camera may be configured to capture images at the wavelengths of the fluorescent elements bound to the nucleotides. The images can be called flow cell images.

In some embodiments, the imager 116 can include one or more optical systems disclosed herein. The optical system(s) can be configured to capture optical signals from the flow cell and generate corresponding digital images thereof. The digital images can then be used for base calling.

In an embodiment, the images of the flow cell may be captured in groups, where each image in the group is taken at a wavelength or in a spectrum that matches or includes only one of the fluorescent elements. In another embodiment, the images may be acquired as single images that capture all of the wavelengths of the fluorescent elements. The resolution of the imager 116 controls the level of detail in the flow cell images, including pixel size. In existing systems, this resolution is very important, as it controls the accuracy with which a spot-finding algorithm identifies the polony centers. In some embodiments, the image resolution of flow cell images disclosed herein can be about 10 nanometers (nms) to a couple of hundreds of nms or greater. One way to increase the accuracy of spot finding is to improve the resolution of the imager 116, or improve the processing performed on images taken by imager 116. Detecting polony centers in pixels other than those detected by a spot-finding algorithm can be performed. These methods can allow for improved accuracy in detection of polony centers without increasing the resolution of the imager 116. The resolution of the imager may even be less than existing systems with comparable performance, which may reduce the cost of the sequencing system 110. In some embodiments, the resolution of the imager may be the same as existing systems but achieve superior performance as compared to those existing systems due to the image processing.

The image quality of the flow cell images controls the base calling quality. One way to increase the accuracy of base calling is to improve the imager 116, or improve the processing performed on images taken by imager 116 to result in a better image quality. The methods described herein register the flow cell images to a common coordinate system so that the base calling with respect to a cluster or polony can be more accurate than without such registration. These methods can allow for accurate and efficient image registration. Further, since the methods disclosed here are computationally less intensive than traditional methods so that the heat dissipation by the computer/processors can be easier to manage so that it is unlikely to cause undesired shift from the proper chemistry of sequencing techniques disclosed herein. These methods can be advantageously performed in parallel in the computer-implemented system 100, without interference with or delay of existing sequencing workflow of the system 100. The results of image registration can be available for making actual base calling in the current cycle in the sequencing workflow. Further, some or all of the operations disclosed herein can be advantageously performed by the FPGA(s) and data can be communicated between the CPU(s) and FPGA(s) to reduce the total operational time from methods operating without the FPGA(s). Furthermore, instead of directly registering multiple flow cell images which may require saving the images before and/or after registration, image intensities and corresponding positions of selected polonies are extracted to estimate the transformation of the entire flow cell image. Further, transformation matrices instead of images can be saved, which can save memory space needed and improve efficiency of the image registration process, thereby advantageously enabling image registration and subsequent analysis while a sequencing run is being performed.

The sequencing system 110 may be configured to perform image registration of the flow cell images across different cycles and/or channels. The operations or actions disclosed herein may be performed by the dedicated processors 118, the FPGA(s) 120, the computing system 126, or a combination thereof. One or more operations or actions in methods 500, 2400 disclosed herein may be performed by the dedicated processors 118, the FPGA(s) 120, the computing system 126, or a combination thereof. In some embodiments, which operations or actions are to be performed by performed by the dedicated processors 118, the FPGA(s) 120, the computing system 126, or their combinations can be determined based on one or more of: a computation time for the specific operation(s), the complexity of computation in the specific operation(s), the need for data transmission between the hardware devices, or their combinations. Image registration disclosed herein can be performed after the flow cell images are acquired but before actual base calling of the flow cell images is performed in a cycle.

The computing system 126 can include one or more general purpose computers that provide interfaces to run a variety of programs in an operating system, such as Windows™ or Linux™. Such an operating system typically provides great flexibility to a user.

In some embodiments, the dedicated processors 118 may be configured to perform operations in the methods of image registration. They may not be general-purpose processors, but instead custom processors with specific hardware or instructions for performing those steps. Dedicated processors directly run specific software without an operating system. The lack of an operating system reduces overhead, at the cost of the flexibility in what the processor may perform. A dedicated processor may make use of a custom programming language, which may be designed to operate more efficiently than the software run on general-purpose computers. This may increase the speed at which the steps are performed and allow for real time processing.

In some embodiments, the FPGA(s) 120 may be configured to perform operations of the image registration methods herein. An FPGA is programmed as hardware that will only perform a specific task. A special programming language may be used to transform software steps into hardware componentry. Once an FPGA is programmed, the hardware directly processes digital data that is provided to it without running software. The FPGA instead uses logic gates and registers to process the digital data. Because there is no overhead required for an operating system, an FPGA generally processes data faster than a general-purpose computer. Similar to dedicated processors, this is at the cost of flexibility.

The lack of software overhead may also allow an FPGA to operate faster than a dedicated processor, although this will depend on the exact processing to be performed and the specific FPGA and dedicated processor.

A group of FPGA(s) 120 may be configured to perform the steps in parallel. For example, a number of FPGA(s) 120 may be configured to perform a processing step for an image, a set of images, a subtile, or a select region in one or more images. Each FPGA(s) 120 may perform its own part of the processing step at the same time, reducing the time needed to process data. This may allow the processing steps to be completed in real time. Further discussion of the use of FPGAs is provided below.

Performing the processing steps in real time may allow the system to use less memory, as the data may be processed as it is received. This improves over conventional systems that may need to store the data before it may be processed, which may require more memory or accessing a computer system located in the cloud 130.

In some embodiments, the data storage 122 is used to store information used in the image registration methods. This information may include the images themselves or information derived from the images (e.g., pixel intensities, colors, etc.) captured by the imager 116. The DNA sequences determined from the base-calling may be stored in the data storage 122. Parameters identifying polony locations may also be stored in the data storage 122. Raw and/or processed image intensities of each polony may be stored in the data storage. The region and/or subtile that each polony corresponds to may also be stored in the data storage 122. The transformation matrix of each region and/or subtile for different cycle(s) and/or channel(s) may also be stored in the data storage 122.

The user interface 124 may be used by a user to operate the sequencing system or access data stored in the data storage 122 or the computer system 126.

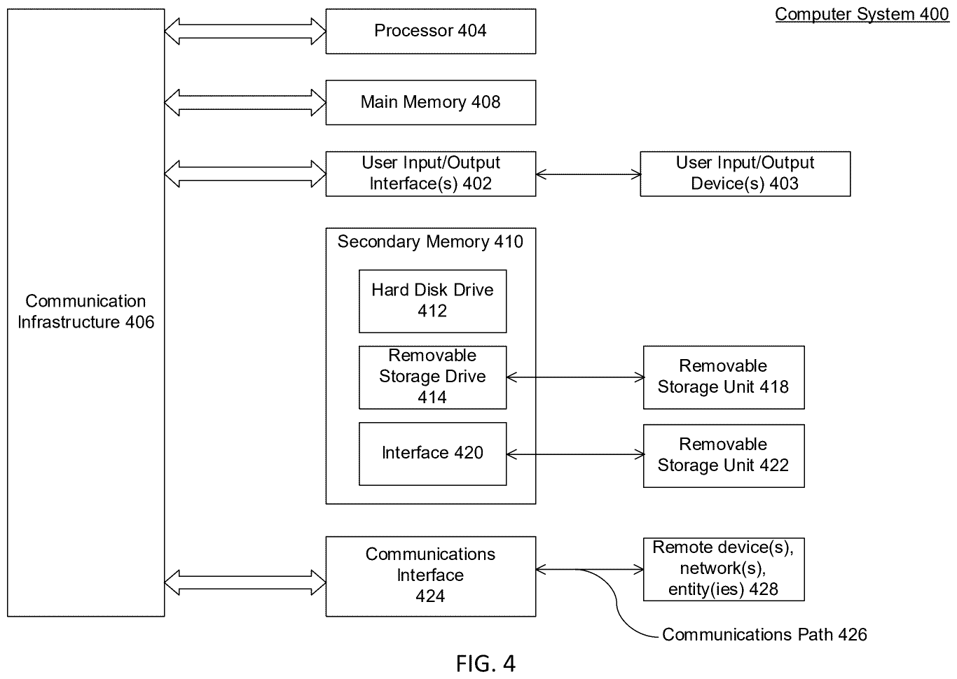

The computer system 126 may control the general operation of the sequencing system and may be coupled to the user interface 124. It may also perform steps in image registration and proceeding operations, and/or subsequent including but not limited to base-calling. In some embodiments, the computer system 126 is a computer system 400, as described in more detail in FIG. 4. The computer system 126 may store information regarding the operation of the sequencing system 110, such as configuration information, instructions for operating the sequencing system 110, or user information. The computer system 126 may be configured to pass information between the sequencing system 110 and the cloud 130.

As discussed above, the sequencing system 110 may have dedicated processors 118, FPGA(s) 120, or the computer system 126. The sequencing system may use one, two, or all of these elements to accomplish necessary processing described above. In some embodiments, when these elements are present together, the processing tasks are split between them. For example, the FPGA(s) 120 may be used to perform some or all of: the preprocessing operations, image registration, and the subsequent operations, while the computer system 126 may perform other processing functions for the sequencing system 110 such as base calling. Those skilled in the art will understand that various combinations of these elements will allow various system embodiments that balance efficiency and speed of processing with cost of processing elements.

The cloud 130 may be a network, remote storage, or some other remote computing system separate from the sequencing system 110. The connection to cloud 130 may allow access to data stored externally to the sequencing system 110 or allow for updating of software in the sequencing system 110.

### Image Registration

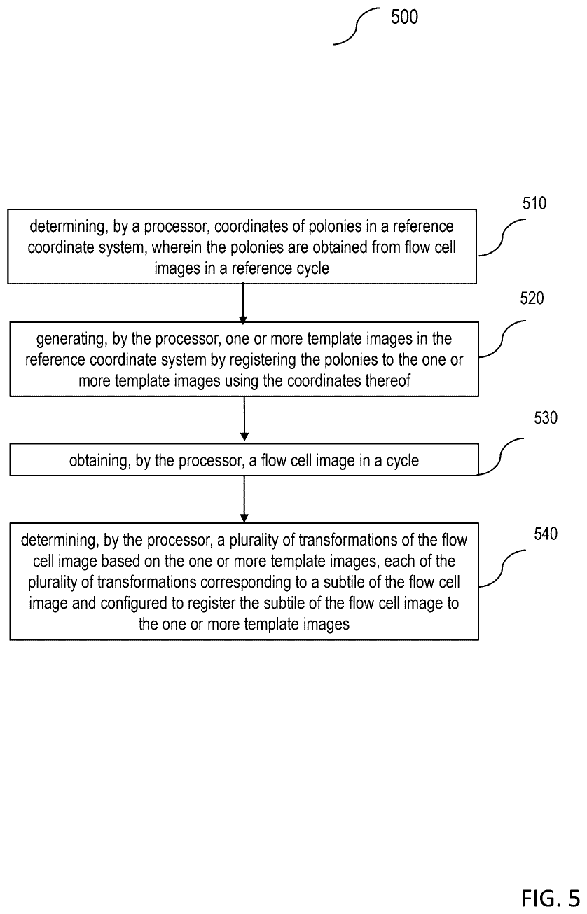

FIG. 5 shows a flow chart of an example embodiment of a computer-implemented method 500 for image registration of flow cell images acquired in different sequencing cycles and from different channels for making accurate base-calling during DNA sequencing, according to some embodiments. The method 500 can include some or all of the operations disclosed herein. The operations may be performed in but are not limited to the order that is described herein.

The method 500 can be performed by one or more processors disclosed herein. In some embodiments, the processor can include one or more of: a processing unit, an integrated circuit, or their combinations. For example, the processing unit can include a central processing unit (CPU) and/or a graphic processing unit (GPU). The integrated circuit can include a chip such as a field-programmable gate array (FPGA). In some embodiments, the processor can include the computing system 400.

In some embodiments, some or all operations in method 500 can be performed by the FPGA(s). In embodiments when some operations are performed by FPGA(s), the data after an operation performed by the FPGA(s) can be communicated by the FPGA(s) s to the CPU(s) so that CPU(s) can perform subsequent operation(s) in method 500 using such data. Similarly, data can also be communicated from the CPU(s) to the FPGA(s) for processing by the FPGA(s). In some embodiments, all the operations in method 500 can be performed by CPU(s). Alternatively, the operations performed by CPU(s) can be performed by other processors such as the dedicated processors, or GPU(s). In some embodiments, all the operations in method 500 can be performed by FPGA(s).

In some embodiments, the method 500 is configured to align or register flow cell images across different sequencing cycles and/or from different color channels to a common coordinate system. The common coordinate system can be the reference coordinate system disclosed herein. The common coordinate system can be predetermined. The common coordinate system may be a Cartesian coordinate system as shown in FIG. 3. Various other coordinate systems may be used. Other coordinate systems can include but are not limited to the polar coordinate system, cylindrical, or spherical coordinate systems.

The flow cell images can be acquired using the optical system disclosed herein, from one of the 1, 2, 3, 4, or more channels of the imager 116. Each flow cell image can include one or more tiles (e.g., imaging areas), and each tile can be divided into multiple subtiles. Each subtile can include a plurality of polonies or clusters. Each subtile can include multiple regions with each region including a number of polonies or clusters. For example, the polonies or clusters can be extracted from corresponding regions of flow cell images from 4 different channels in a given flow cycle. As another example, the polonies or clusters can be extracted from flow cell images from a single channel. An example technique for extracting the plurality of polonies in a flow cell is described in U.S. Pat. No. 11,200,446, which is hereby incorporated by reference in its entirety. The flow cell image as disclosed herein can be an image that is acquired using a flow cell 112 as shown in FIG. 1.

The flow cell 112 may include sample(s) immobilized thereon. The sample(s) may include a plurality of nucleic acid template molecules. The sample(s) may include a two dimensional (2D) sample or a three-dimensional (3D) volumetric sample. The nucleic acid template molecules may be distributed randomly or in various patterns on the flow cell 112. In some embodiments, the plurality of polonies or clusters herein may be extracted from specific regions of a tile, e.g., each subtile. With each subtile, the polonies may be extracted with a predetermined pattern or randomly.

In some embodiments, the polonies or clusters being sequenced in a flow cycle may have a certain nucleotide diversity. The method 500 may allow image registration of flow cell images even if the polonies or clusters are of low or unbalanced diversity in sequencing cycle(s). The nucleotide diversity of a population of nucleotide acid molecules, e.g., polonies or clusters, can refer to the relative proportion of nucleotides A, G, C, and T/U that are present in each flow cycle. An optimally high or balanced diversity data can generally have approximately equal proportions of all four nucleotides represented in each flow cycle of a sequencing run. A low or unbalanced diversity data can generally include a high proportion of certain nucleotides and low proportion of other nucleotides in some flow cycles of a sequencing run, e.g., less than 10% of the total number of all 4 nucleotides. As a result, images corresponding to the high portion of certain nucleotides can have more signal spots (polonies or clusters) than images corresponding to the low portion of certain nucleotides. As an example of low or unbalanced diversity data in a flow cycle, the bases A, T, C, G can be about 1%, about 2%, about 1%, and about 95%, respectively, of the total number of polonies, in a certain flow cycle. As another example of low or unbalanced diversity data, the bases A, T, C, G in polonies at multiple flow cycles can be about 2%, about 5%, about 10%, and about 83%, respectively. In embodiments where low or unbalanced diversity data is present in a particular cycle and is imaged for sequencing analysis, image registration using existing technologies may fail because image(s) from one or more channels are too dark (e.g., signal spots of polonies are too sparse and/or dim) comparing with images acquired from other channels.

In addition to the base biases affecting diversity, plexity can also be a factor that affects image registration. In general, plexity can indicate source(s) of the sample. A uniplex sample may include DNA fragments or molecules from a same sample region in a genome or a same sample source. A multiplex sample may include DNA fragments or molecules from different sample sources, e.g., liver, kidney, heart, cancerous tissue, etc., or from one or more sample regions in the genome. When plexity is lower than a number, e.g., 8 or 16, the signal may be of low diversity. For example, in a 2-cycle sequence, all polonies are of AT or TG or GC or CA. Every base is 25% of the total number of bases in that cycle, but its plexity is less than 8, and the sequence is not all random. In some embodiments, the methods 500 is configured to register flow cell images even if the polonies are of low diversity and/or low plexity.

In some embodiments, the method 500 is performed during a cycle N that is different from a reference cycle. The template image can be generated in the reference cycle and polonies from one or more channels within the reference cycle can be included in the template image in a reference coordinate system, while base calling of cycle N is yet to be performed. In some embodiments, cycle N is the current cycle. N can be any non-zero integer. For example, N can be any integer from 1 to 300 or 1 to 400.

In some embodiments, the method 500 is performed during a cycle N while sequencing and image acquisition in subsequent cycles, e.g., cycle N+1, is being performed or yet to be performed. In some embodiments, the method 500 is performed in parallel with the sequence run to advantageously reduce the total time for sequencing and primary analysis. In some embodiments, the method 500 is performed in parallel with the sequence run to advantageously reduce storage space needed for saving flow cell images. For example, after image registration is performed for cycle N, transformations in cycle N and a list of polonies or clusters with their intensity and location information can be saved which requires less storage space than actual flow cell images. In some embodiments, the method 500 can be performed after the sequencing run is completed.

In some embodiments, the method 500 may allow image registration of flow cell images of in situ sample(s). In situ sample(s) may include the cellular sample disclosed herein which has a depth along the z axis in FIG. 3, and orthogonal to the image plane of flow cell images. The in situ sample(s) may have a 3D volume and the polonies or clusters may be distributed in the 3D volume. To image optical signals from polonies or clusters, flow cell images may be acquired at multiple z locations spaced part from each other along the axial direction. In some embodiments, the operations of method 500 can be performed for flow cell images at each different z-levels.

In some embodiments, the method 500 can include an operation 510 of determining coordinates of the polonies or clusters in a reference coordinate system.

The polonies can be from a subtile of flow cell images within a reference cycle, and more specifically, from one or more selected regions of the subtile. The flow cell images can be from different channels of 1, 2, 3, 4, or more channels of the system 100. As a nonlimiting example, a reference cycle can be any cycle of the first 5 or 6 cycles. In some embodiments, the reference cycle can be any cycle that is greater than 0. In some embodiments, the reference cycle is the first cycle.

The region in the subtile can be selected in various ways to include at least part of the subtile. For example, the region can be selected as enclosing center pixel(s) of the subtile. For images from cellular samples or other various samples that distributed heterogeneously over the FOV, the region for each subtile may be selected to be at various locations in the subtile. In some embodiments, the region is selected to ensure that at least a threshold number of cells or polonies are within the selected region. For example, the operation 510 may comprise an operation of determining the number of cells and/or polonies within the region. The region including center pixels, e.g., 128 by 128, may be a default selection. In response to determining that the center region does not include cells and/or polonies meeting a predetermined threshold, the method 500 may include an operation of moving the selected region until a region meeting the predetermined threshold is found. The selected region may be at the same location across different color channels and/or cycles. The predetermined number of polonies or clusters can be 20, 40, 60, 80 or more. The predetermined number of cells can be 1, 2, 5, 8, 10, or more.

The region for each subtile may be selected to be at various locations in the subtile. In some embodiments, the region is selected based on the various standards such as largest signal variance, highest average signal intensity, or largest standard deviation of signal intensity, etc., within the selected region among multiple candidate regions within the same subtile. The region selected with the various standard(s) may be more likely to contain stronger signals of polonies and/or cells than other regions with lower signal variances and may facilitate registration. In some embodiments, some or all of the possible options of selecting the region within the subtile are included as candidate regions. For example, for a 100 by 100 region size, sliding the window through all rows and columns of the subtile may provide all possible options of selecting the 100 by 100 region. In some embodiments, the selected region can be at different locations for different subtiles. The selected region may remain identical for the same subtile at different cycles or across different color channels. In some embodiments, each subtile may include one or more selected regions. Two different subtiles may include a different number of selected regions. The size of the selected regions may be identical or different. For example, subtile 1 may have a single selected region including its center pixels, subtile 2 may have 3 selected regions and none of them include any center pixels, and the 3 selected regions can be different in size. Such selection based on the predetermined threshold may also be used for 2D samples with sparse polony or cluster distribution within the subtiles, e.g., less than 100 polonies in 128 by 128 region or dim signals within the subtiles, e.g., less than 10%, 20% or other percentages of average signal intensity than another region.

The operation of selecting the region(s) within each subtile may help to ensure that the Fourier transform of the selected region contains at least some signal from the polonies but not just background and/or noises.

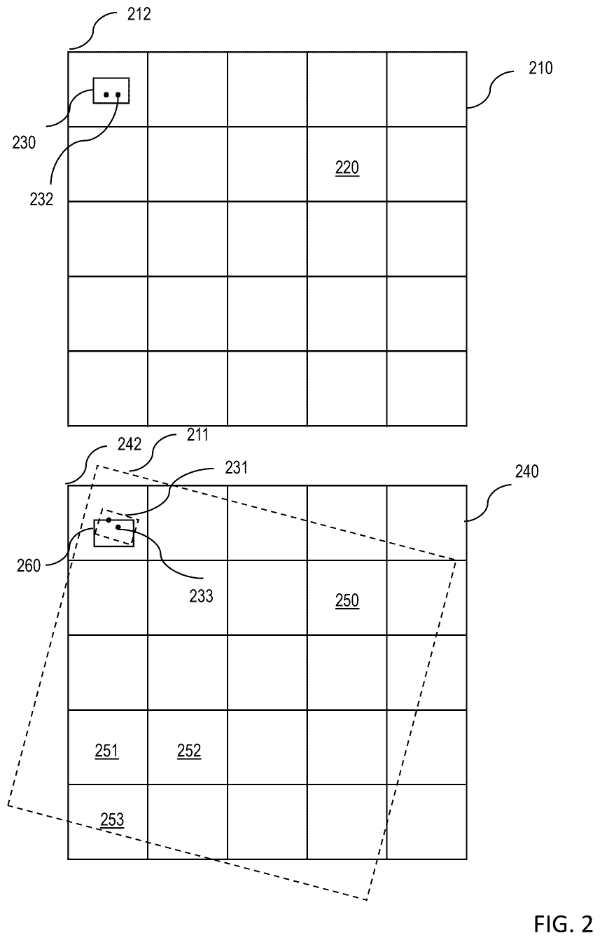

The selected region may be various two-dimensional shapes, e.g., rectangle, circle, or square. As a nonlimiting example, the selected region can include one or more center pixels of the subtile. A nonlimiting example of the selected region 230 is shown in FIG. 2. The region 230 can include multiple polonies 232, e.g., as shown in FIG. 2. The size of the region can be determined to balance the trade-off between different factors including but not limited to computational complexity, time consumption, polony density on the flow cell, and accuracy of image registration. For example, selecting a 64×64 region can be computationally simpler than selecting a 128×128 region but may not be as accurate for certain samples immobilized on the flow cell.

Once the region is selected, coordinates of polonies therewithin can be determined by registering the selected region in flow cell images across channels. The operation 510 can include an operation of registering the selected region in flow cell images across channels. The registration of regions across different channels, e.g., from a same cycle, can be based on multiple fiducial markers external to sample(s) immobilized on the flow cell. In some embodiments, the multiple fiducial markers are distributed in a predetermined pattern so that the size of markers, distance between markers, and intensity of markers are predetermined. In some embodiments, the multiple fiducial marks can be distributed randomly, e.g., as a coating on the flow cell. Flow cell images can be acquired from different channels with the identical fiducial markers but without any polonies e.g., flow cell images of the test target herein. In some embodiments, the fiducial markers may include intensity levels that are comparable to those of the polonies to simulate the presence of polonies. In some embodiments, the fiducial markers may include intensity levels that are comparable to those of the polonies to simulate the presence of polonies.

Such images of fiducial markers can be additional to the flow cell images acquired during a sequencing run and can be used for registration and registration rescue of flow cell images and/or calibration of the imager 116. In some embodiments, such images of fiducial markers can be used to register offset and other transformations across channels within a single flow cycle, and such offset and other transformations may remain consistent in different flow cycles, e.g., several cycles that are continuous with each other in a sequence run. For example, the offset and transformation between channel 1 and channel 2 may be considered as identical in immediately adjacent cycles such as cycles 50 to 55.

When the selected regions are of low diversity data, the image registration rescue operations in method 2400 can be performed. The image registration rescue of images from cycles with low diversity data can be based on the fiducial markers.

In some embodiments, when image registration or registration rescue across channels are not needed in certain cycles, images with only the fiducial markers are not acquired in such cycles. In some embodiments, the fiducial markers are only used for acquiring additional images in the cycle(s) for registering images across the different channels, e.g., within the reference cycle(s) or within the first 1-5 cycles.

In some embodiments, images with the fiducial markers, e.g., the test target or the beaded flow cell, are acquired in one or more cycles that are not the reference cycle(s). In some embodiments, images with the fiducial markers are acquired in one or more cycles before any cycle of a sequencing run. In some embodiments, images with the external fiducial markers, e.g., the test target or the beaded flow cell are acquired in one or more cycles where the data is of low diversity.

In some embodiments, instead of using the fiducial markers for registration between channels, image registration information from a previous cycle or any rescue cycle can be used instead to register images from the channel(s) with low diversity data, e.g., the channel(s) with less than 10% of the total polonies in all channels. Comparing with acquiring additional images with fiducial markers in every cycle, imaging fiducial markers in reference cycles, in low diversity cycles, or in a regular pattern every several cycles, using image registration information from a previous cycle can reduce total imaging time and data to be processed while still achieve accurate and reliable image registration results using the methods herein.

Various methods can be used for registering flow cell images from multiple channels based on such fiducial markers so that a fiducial marker with image intensity I with its center at location (x1, y1) can be positioned at location (xr, yr) with intensity I in the reference coordinate system, where (xr, yr)≅Mr*(x1, y1), and Mr is the transformation matrix. Similarly, the inverse transformation matrix Mr⁻¹ can be determined such that (x1, y1)≅Mr⁻¹*(xr, yr). Multiple fiducial markers, e.g., at least 3, can be used to estimate the transformation matrix, Mr, for the selected region. The transformation matrix, Mr, for the selected region can be used as transformation matrix for the corresponding subtile. The image registration of images across different color channels may be in 2D and may include translation, scaling, rotation, and/or shearing of flow cell images among different channels. In some embodiments, polonies or clusters can be used as fiducial marks for registering flow cell images between channels when they appear in such corresponding channels.

In some embodiments, the method 500 includes determining coordinates of the polonies or clusters in a reference coordinate system by multiplying the coordinates of the polonies or clusters with the transformation matrix, Mr, as (xrp, yrp)=Mr*(xp, yp), wherein xrp and yrp are the coordinates of each polony within the reference coordinate system, and xp and yp are coordinates of the polony in each flow cell image.

A reference coordinate system that is common to all the flow cell images in the reference cycle can be determined. For example, a reference coordinate system can be the coordinate system of the flow cell image from one channel. As another example, the reference coordinate system can be based on the external fiducial markers or other objects external to the flow cell images.

In some embodiments, the method 500 includes an operation 520 of generating one or more template images in the reference coordinate system by registering the polonies to the one or more template images using the coordinates thereof. FIG. 2 shows a schematic diagram of one or more template images generated in the reference cycle in a reference coordinate system. The template image 210, in some embodiments, include a size that is about identical to a single tile. In this embodiment as shown FIG. 2, the tile 210 includes a 5×5 grid of subtiles 220. A region 230 is selected in each subtile and includes center pixels of the corresponding subtile. The reference coordinate system in this embodiment has an origin 212 at its top left pixel. In some embodiments, each tile may include multiple template images, and each template image can include an individual region such as region 230. Each template image can include a plurality of polonies or cluster 232 therein.

In some embodiments, the template image can be of about the same size of a flow cell image so that all the polonies, from different tiles, 210 in FIGS. 2-3, and from multiple channels, can be registered to the same template image. The template image may contain polonies that will not be used in at least some operations described herein to reduce computational burden without sacrificing accuracy. In some embodiments, more than one template image can be generated, and each template image 230 corresponds to at least part of a subtile of a flow cell image from a channel.

The template image herein can be initialized as a virtual image that has a black or dark background with no signals from polonies. For example, the template image can be initialized to be zero or include otherwise minimal image intensity at all pixels.

After the coordinates of a polony is determined in operation 510 by image registration of flow cell images across different channels, the intensity of the polony can be added to the template image at the location determined by the coordinates and with the size and shape determined based on registration. The template image can be a virtual image that combines image intensity from polonies obtained from 2, 3, 4, or even more channels at the reference cycle. The pixels of the template containing no polonies in them remain to be black or dark so that the template image can have a cleaner background without noise that appears in actual flow cell images.

In some embodiments, the method 500 includes an operation of obtaining image intensities, sizes, shapes, or their combinations of the polonies from at least a portion of one or more subtiles in the reference cycle so that such information can be used to include the polonies in the template image. In some embodiments, polonies can have a fixed shape and/or size. In some embodiments, a point spread function determined by the optical system herein is used to determine the fixed shape and/or size of polonies. In some embodiments, the polonies have a fixed spot size that is based on the sigma of a Gaussian point spread function. In some embodiments, one or more polonies have a size of 1-9 pixels. In some embodiments, one or more polonies have a size of 1-3 pixels.

The template image can include polonies from different channels along with the channel information. As an example, the channel information can be provided as a label or a specific order of how the polonies are included.

In some embodiments with multiple template images, each template image 230 can cover a region within a subtile, and such template image may but is not required to include all the polonies within the subtile.

In some embodiments, the template image may be a list of entries that is simpler and more efficient to handle than a 2D or 3D virtual image. For example, each polony or cluster within the template image may have its coordinates, e.g., center pixel, and corresponding intensity in an entry of list. And such coordinates can be in the reference coordinate system. Intensities in different color channels may also be included in the same entry.

In some embodiments, the method 500 includes an operation 530 of obtaining a flow cell image in a cycle after the reference cycle. The operation 530 can include passively receiving or actively requesting the flow cell image from an optical system disclosed herein after the flow cell image is generated by the optical system. The operation 530 may include acquiring the flow cell image using the optical system. The optical system can be included in the imager 116 in FIG. 1.

In some embodiments, the operation 530 may comprise an operation of providing a plurality of nucleic acid template molecules immobilized on a support. Each nucleic acid template molecule may comprise an insert sequence of interest. The insert sequence can be different in different template molecules. Each template molecule may correspond to a polony of optical signals in flow cell images.

In some embodiments, the operation 530 may comprise an operation of generating the flow cell images by conducting one or more cycles of sequencing reactions of the plurality of nucleic acid template molecules immobilized on the support. The flow cell images can be generated or acquired by the sequencing system disclosed herein. Conducting the one or more cycles of the sequencing reactions may comprise: contacting the plurality of nucleotide acid template molecules using a plurality of nucleotide reagents comprising a mixture of different types of nucleotide bases A, G, C and T/U. Individual nucleotide reagent may comprise a different detectable color label that corresponds with each different type of nucleotide base.

In some embodiments, conducting the one or more cycles of the sequencing reactions may comprise: contacting the plurality of nucleotide acid template molecules with a plurality of sequencing primers, a plurality of polymerases and a mixture of different types of avidites. An individual avidite in the mixture may comprise a core attached with multiple nucleotide arms and each arm of the individual avidite comprises the same type of nucleotide base. In some embodiments, conducting the one or more cycles of the sequencing reactions comprises: in each of the one or more cycles, imaging optical color signals emitted from nucleotide reagents that are bound to the plurality of template molecules. Imaging the optical signals may be performed by an optical system, e.g., the imager 116, disclosed herein. In some embodiments conducting the one or more cycles of the sequencing reactions may comprise: in each of the one or more cycles, acquiring the flow cell images comprising optical color signals emitted from nucleotide reagents that are bound to the plurality of template molecules.

In some embodiments, the flow cell images comprises optical signals emitted from nucleotide reagents bound to a unbalanced diversity of nucleotide bases of A, G, C and T/U among the plurality of nucleic acid template molecules immobilized on the support in the one or more cycles. In some embodiments, the plurality of polonies comprise a unbalanced diversity of nucleotide bases of A, G, C and T/U, and wherein the unbalanced diversity comprises a percentage of: (1) a number of one or more types of nucleotide bases to (2) a total number of nucleotide bases, and the percentage is less than 20%, 15%, 10%, or 5% in the cycle N. The plurality of polonies corresponds to the plurality of nucleotide acid template molecules.

In some embodiments, the operation 530 may comprise providing a cellular sample having a plurality of concatemer molecules immobilized on a support, wherein each concatemer molecule corresponds to a target RNA of a cellular sample.

In some embodiments, the operation 530 may comprise generating, by a sequencing system, flow cell images by conducting one or more cycles of sequencing reactions of the plurality of concatemer molecules immobilized on the support. Conducting the one or more cycles of the sequencing reactions may comprise: contacting the plurality of concatemer molecules using a plurality of nucleotide reagents comprising a mixture of different types of nucleotide bases A, G, C and T/U. Conducting the one or more cycles of the sequencing reactions may comprise: contacting the plurality of concatemer molecules with a plurality of sequencing primers, a plurality of polymerases, and a mixture of different types of avidites. The individual avidite in the mixture comprises a core attached with multiple nucleotide arms and each arm of the individual avidite comprises the same type of nucleotide base. Conducting the one or more cycles of the sequencing reactions may comprise: in each of the one or more cycles, imaging, by the optical system, optical color signals emitted from nucleotide reagents that are bound to the plurality of concatemer molecules. In some embodiments, conducting the one or more cycles of the sequencing reactions may comprise: in each of the one or more cycles, acquiring, by an optical system, the flow cell images comprising optical color signals emitted from nucleotide reagents that are bound to the plurality of concatemer molecules.

The flow cell image can include some or all of the same polonies in the template image(s) of the reference cycle. In particular, the flow cell image can include some or all of the same polonies in regions corresponding to the selected region in the reference cycle.

FIG. 2 shows the flow cell image acquired in a cycle different from the reference cycle at the bottom. The flow cell image 240 is acquired with multiple subtiles 250. The selected region 260 in this cycle can be at the same relative location to the origin 242 in this cycle as the selected region 230 relative to the origin 212 in the reference cycle. In this cycle, the flow cell image 210 in the reference may have transformed to the transformed image 211, and the selected region 230 correspondingly transformed to region 231 with some overlap to region 260. The image transformation herein can be 2D, and can include translation, scaling, rotation, and/or shearing.

In some embodiments, the method 500 is configured to align template image, e.g., 210 or 230, in the reference cycle and the transformed image, e.g., 211 or 231, in another cycle to the reference coordinate system.

In some embodiments, instead of using region 231 or 211 directly in image registration, the method 500 can include an operation of selecting region 230 and 260 for simpler and more convenient determination of image registration. The region 260 can include at least part of the polonies 232 that were in the template image in the reference cycle, e.g., 230.

In some embodiments, the method 500 comprises an operation 540 of determining a plurality of transformations of the flow cell image 240 based on the one or more template images 210 or 230. As shown in FIG. 2, each of the plurality of transformations can correspond to a subtile 250 of the flow cell image 240 and is configured to register the subtile 250 of the flow cell 240 image to a corresponding portion of the template image 210 (if the template image includes the entire tile) or a corresponding template image 230 (if there are multiple template images within the tile).

In some embodiments, the operation 540 may include determining each transformation corresponding to a subtile of the flow cell image. More particularly, each transformation can correspond to a selected region in each of some or all the subtiles. A region can be selected in various ways from a subtile to include at least part of the subtile. The region may be a predetermined two-dimensional shape, e.g., rectangle, circle, or square. As a non-limiting example, the selected region can include one or more center pixels of the subtile as shown in FIG. 2 at 260. The size of the region can be determined to balance the trade-off between computational complexity and accuracy of image registration. For example, selecting a 64×64 region can be computationally simpler than selecting a 128×128 region but may not be as accurate. In some embodiments, the selected region includes some or all of the polonies 232 registered in the template image(s) in the reference cycle so that the same polonies and their relative locations in the template image(s) and the flow cell image can be used for determining the transformation. In some embodiments, the size of the template image, e.g., 230 and the region 260 can be identical or about identical. In some embodiments, the size of the template image 210 or 220 and the selected region 260 can be different.

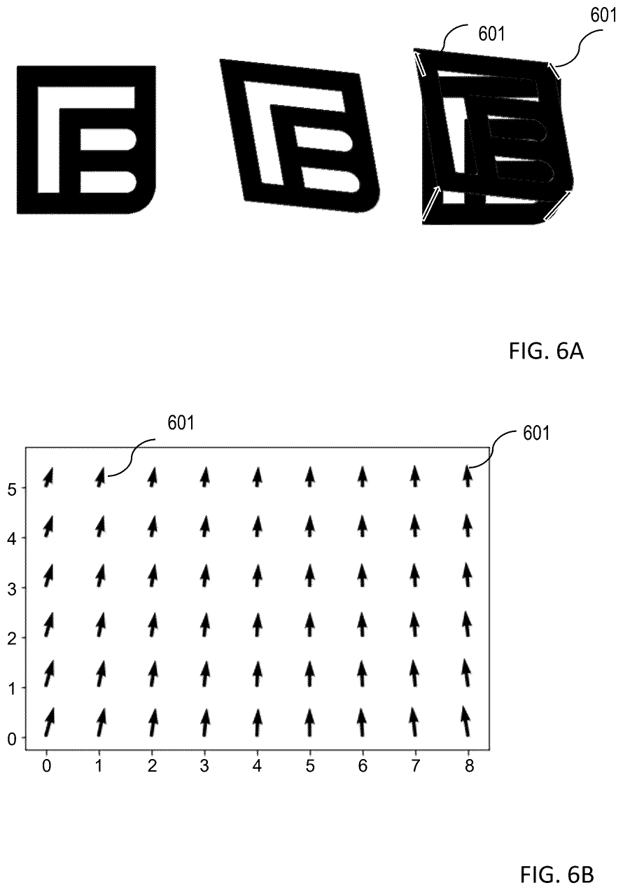

FIGS. 6A-6B show a schematic diagram of an image transformation and corresponding 2D shifts, according to some embodiments. In some embodiments, cross correlation of the selected region and the template image can be computed for determining a 2D shift of the selected region relative to the template image. FIG. 6A shows a reference image (left) that is transformed with 2D shear, scaling, and rotation into a different image (middle). 2D shifts 601 at the four corners of the reference image can be determined, for example, using the methods disclosed herein with calculation of cross correlation. And the 2D shifts at four corners can be used to estimate the transformation between the two images.

In some embodiments, cross correlation can be calculated in the spatial domain. In some embodiments, cross correlation can be calculated in the spatial frequency domain after Fourier transform (FT). The method 500 may comprise generating a corresponding Fourier Transformed Image (FTI) of a template image and a Fourier transform of the selected region. The Fourier transformation herein can be calculated using discrete FT (DFT), fast FT (FFT), or the like. The cross correlation can be determined based on the FTI and the Fourier transform of the selected region. As a nonlimiting example, the cross correlation can be the elementwise multiplication of the FTI with the FT of the selected region, with a complex conjugate or rotation of the one of them. Then, an inverse FT of the elementwise multiplication can be obtained. In some embodiments, the cross correlation can be a 2D image with a peak intensity at its coordinate [xp, yp]. In some embodiments, a 2D shift can be determined based on the coordinates [xp, yp] in comparison to the coordinates of a peak obtained from cross-correlation of two original images without transformation. The 2D shift of the selected region 260 can be used to estimate the 2D shift for the entire subtile. In some embodiments, results of calculating the cross correlation in the spatial domain or Fourier domain can be equivalent. In some embodiments, calculation in the Fourier domain can be simpler and more efficient than calculation in the spatial domain. In some embodiments, the Fourier Transformed Image (FTI) of the template image is stored in the storage device herein to reduce computational time in image registration. In some embodiments, the Fourier Transformed Image (FTI) of the template image but not the template image in the spatial domain is stored in the storage device herein to reduce storage needed in image registration.

In some embodiments, the image transformation of the subtile can be determined from 2D shifts from some or all neighboring subtiles with or without the 2D shift from itself. In some embodiments, 2D shifts from all immediate neighbors can be used. For example, to determine transformation of subtile 253, 2D shifts from 3 neighboring subtiles and the 2D shift from itself can be used. For subtile 251, a total number of 6 2D shifts including immediate neighboring subtiles and itself can be used. For subtile 252, a total number of 9 2D shifts including neighboring subtiles and itself can be used. In some embodiments, 2D shifts from some but not all neighboring subtiles can be used. In some embodiments, 2D shifts from all neighboring subtiles except 1-2 outlier neighbors can be used to determine the transformation. The outlier neighbor(s) can be excluded using a predetermined criterion, e.g., more than 30% or 50% different from other 2D shifts.

FIG. 6B is an image showing 2D shifts within an example tile of a flow cell image. In this embodiment, the tile has a 6×9 grid of subtiles, and each subtile has a 2D shift 601 that is determined using the technologies disclosed herein. Each shift has a magnitude of less than about 5 pixels along x or y axis. A pixel size may vary depending on imaging parameters, an example pixel can be from 0.1 um to 0.9 um. The 2D shifts 601 can be used to calculate transformation, e.g., affine matrix, for the tile, by individually calculating a transformation for each subtile. In this embodiment, an affine matrix can be calculated using the methods disclosed herein.

In some embodiments, subpixel resolution, e.g., about 0.01, 0.02, 0.03, or 0.05 pixel, of the 2D shifts 601 can be achieved using various methods including interpolation, upsampling, etc. In some embodiments, subpixel resolution can be achieved by fitting the peak with a selected filter, e.g., a 3×3 or 5×5 Gaussian filter.

In some embodiments, the image transformation of a subtile can be represented by a transformation matrix. The transformation matrix can be determined as below:

$$( \begin{matrix}a 1 & a 2 & & an \\ b 1 & b 2 & … & bn \\ 1 & 1 & & 1\end{matrix} ) ≃ ( \begin{matrix}M 11 & M 12 & M 13 \\ M 21 & M 22 & M 23 \\ M 31 & M 32 & M 33\end{matrix} ) ( \begin{matrix}x 1 & x 2 & & xn \\ y 1 & y 2 & … & yn \\ 1 & 1 & & 1\end{matrix} ) \qquad ( 1 )$$

$$M = ( \begin{matrix}M 11 & M 12 & M 13 \\ M 21 & M 22 & M 23 \\ M 31 & M 32 & M 33\end{matrix} ) \qquad ( 2 )$$

where n is the number of subtiles, a1=x1+dx1, b1=y1+dy1, a2=x2+dx2, b2=y2+dy2, . . . an=xn+dxn, bn=yn+dyn, d1 . . . dn are 2D shifts corresponding to the subtiles, and where dxn and dyn are shift components of the 2D shift, dn, in the x and y axis, respectively, (a1, b1) . . . (an, bn) are coordinates after transformation, (x1, y1) . . . (xn, yn) are coordinates before transformation, and where M is the 3×3 transformation matrix of the subtile.

In some embodiments, the transformation matrix can be defined as the inverse matrix of M, i.e., M⁻¹, so that equation (1) can be expressed differently as

$${M}^{- 1} ( \begin{matrix}a 1 & a 2 & & an \\ b 1 & b 2 & … & bn \\ 1 & 1 & & 1\end{matrix} ) ≃ ( \begin{matrix}x 1 & x 2 & & xn \\ y 1 & y 2 & … & yn \\ 1 & 1 & & 1\end{matrix} ) \qquad ( 3 )$$

In some embodiments, the transformation matrix M is an estimation in equations (1) and (3) based on the 2D shifts. In some embodiments, the value of n may affect the accuracy of the estimation. In some embodiments, more than one region can be selected within a subtile for cross correlation calculation, and more than one 2D shift can be calculated for each subtile and used for estimating the transformation of the subtile. In these embodiments, n in equation (1) can be replaced by a larger number, e.g., 2*n when 2 regions are selected per subtile, and the transformation matrix M can be estimated using equations (1) and (2).

In some embodiments, (a1, b1) . . . (an, bn) in equations (1)-(3) are coordinates for selected region(s) (e.g., coordinates of a center pixel of the corresponding region(s)) after transformation, (x1, y1) . . . (xn, yn) are coordinates of the selected region(s) before transformation, e.g., coordinates of a center pixel. In some embodiments, n is a number that is no less than 3. The larger the n, the more information can be used to estimate the transformation matrix M. In some embodiments, n is not greater than 9.

In some embodiments, the transformation of one or more subtiles is linear. In some embodiments, the transformation of all subtiles is linear. In some embodiments, the transformation matrix is a matrix in which M31 and M32 is equal to 0, and M33 is 1. In some embodiments, one or more of the transformations per subtile is an affine transformation and the transformation matrix of the entire flow cell image is an affine matrix.

In some embodiments, the transformation matrix M is an estimation in equations (1) and (3) based on the size, position of each selected region, and number of the selected region(s). In some embodiments, the size of the selected region may affect the accuracy of the estimation. In some embodiments, the size of the select region can be about 128×128. In some embodiments, the size of the selected region can be about 32×32, 48×48, 64×64, 96×96, 160×160, 192×192, 256×256, or various different sizes. The transformations per subtile as disclosed herein can be calculated using a selected region within a subtile, the selected region can be equal to or smaller than the subtile. In either case, the transformation estimated using the region can be used to estimate the transformation of the entire subtile given the intrinsic characteristics of image transformation across sequencing cycles. The image transformation between cycles and/or between neighboring pixels can be relatively small, e.g., with less than about 8%, 5% or less than about 1% of scaling, rotation, and/or shearing. In some embodiments, the transformations disclosed herein can include an image translation with greater than about 5% difference between cycles and/or between neighboring pixels.

After the plurality of transformations are determined for individual subtiles, the transformation of the entire flow cell image can be accurately and reliably estimated by transforming individual subtiles using the plurality of transformations and combining the transformed subtiles into a transformed flow cell image. The techniques disclosed herein advantageously estimate the transformation of the flow cell image by determining a plurality of transformations of its individual subtiles. The plurality of transformations can be linear and yet accurately and reliably estimate the transformation of the flow cell image even if the transformation is non-linear. The techniques disclosed herein advantageously eliminate the need to calculate the transformation of the entire flow cell image which can be more computationally intensive, time-consuming, and prone to failures than estimating a plurality of transformations for the subtiles.

In some embodiments, the computer-implemented method 500 further includes an operation of saving the plurality of transformations by the processor disclosed herein. In some embodiments, the computer-implemented method 500 further includes an operation of communicating the plurality of transformations to a processing unit such as a CPU for subsequent operations.

In some embodiments, the computer-implemented method 500 further includes registering subtiles to the one or more template images using the plurality of transformations. This operation can be performed by the processing unit such as the CPU(s). In any given cycle different from the reference cycle, each subtile can be registered or transformed to the one or more template images by multiplying the subtile by the transformation matrix corresponding to the subtile.

In some embodiments, the computer-implemented method 500 may include an operation of performing one or more preprocessing steps on the flow cell images of the reference cycle and/or other cycles before registration of images from that cycle, e.g., operations 510 to 540.

In some embodiments, this operation of performing one or more preprocessing steps can be performed by the FPGA(s). In some embodiments, the data after the operation can be communicated by the FPGA(s) to the CPU(s) so that CPU(s) can perform subsequent operation(s) in method 500 using such data.

In some embodiments, the one or more preprocessing steps of flow cell images in the reference cycle can be performed before operation 510, 520 or after 520. In some embodiments, the one or more preprocessing steps of flow cell images in the reference cycle can be performed after the operation of receiving the flow cell images in the reference cycle from the optical system disclosed herein. In some embodiments, the one or more preprocessing steps of flow cell images in the reference cycle can be performed before the operation of obtaining image intensities, sizes, shapes, or their combinations of the polonies from the plurality of subtiles of the flow cell images in the reference cycle.

In some embodiments, the one or more preprocessing steps of flow cell images in cycles other than the reference cycle can be performed after operation 530 or 540. In some embodiments, the one or more preprocessing steps of flow cell images in cycles other than the reference cycle can be performed after the operation of registering the subtiles of flow cell image to the one or more template images. In some embodiments, the one or more preprocessing steps of flow cell images in cycles other than the reference cycle can be before the operation of extracting image intensities of a plurality of polonies from the subtiles of the flow cell image. In some embodiments, the one or more preprocessing steps of flow cell images in cycles other than the reference cycle can be before the operation of making base calls using image intensities of the subtiles of the flow cell image.

The one or more preprocessing steps can comprise background subtraction. The background subtraction is configured to remove at least some background signal that may interfere with the signal of interest, i.e., image intensities of the polonies. The background signal can be noise caused by multiple sources including the flow cell 112, the imager 115, the sequencer 114, and other sources. The background subtraction can be adjusted to avoid over subtraction.

The one or more preprocessing steps can include image sharpening so that image intensities of polonies can be optimized in consideration of their surroundings in the flow cell images. For example, a Laplacian of Gaussian (LoG) filter can be used for sharpening.

The one or more preprocessing steps can include intensity offset adjustment that can remove the offset in the intensity that has not been removed during background subtraction.

The one or more preprocessing steps can include color correction to remove interference of one channel from other channels or colors.

The one or more preprocessing steps can include phasing and prephasing correction which is configured to correct image intensities within a specific cycle by removing intensity biases caused by sequencing of DNA fragments that are out of synchronization from other fragments by either falling behind or getting ahead.

The one or more preprocessing steps can include intensity normalization so that the image intensity of polonies from different channels can be normalized to be within a predetermined range.

The one or more preprocessing steps can comprise: background subtraction; image sharpening; or a combination thereof.

In some embodiments, the computer-implemented method 500 further includes extracting image intensities of a plurality of polonies, from the subtiles registered to the template image(s). This operation can be performed by the processing unit such as the CPU(s) or FPGA(s). In some embodiments, polonies with their corresponding intensities are extracted from the flow cell image(s) into a different data format that is simpler and more efficient to handle. For example, each polony can have 4 different intensities, each intensity from a different channel. Such intensities can be extracted into a list, with each entry of the list corresponding to a polony. The list can be generated after image registration to reflect location information of the same polonies in different cycles. As such, image intensities of the same polony in different cycles can be located in different lists each corresponding to a cycle.

In some embodiments, the computer-implemented method 500 further includes making base calls using image intensities of the subtiles of the flow cell image after the registration so that base calling can be made accurately relative to the same polonies across different channels and in different cycles.

In some embodiments, the method 500 includes an operation 540 of determining a plurality of transformations of the flow cell image. The operation 540 can include determining each of the transformations without using any neighboring subtiles as disclosed herein. Instead, more than 2 regions can be selected within the subtile, and 2D shift can be determined for each of the regions. The transformation of the subtile can be determined using the 2D shifts obtained from regions within the same subtile using equations (1) and (2). The regions within a subtile can be smaller in size than the region 260 in neighboring subtiles. For example, the region 260 can be about 128×128, and the regions within a subtile can be 3, 4, 5, or even more regions, and each region includes a about 64×64 matrix. The other operations of method 500 can remain the same for image registration with or without using neighboring subtiles in generating the transformations.

### Example Image Registration

A sequence run is being performed on a sequencing system 110 with an in situ sample immobilized on a flow cell device. Flow cell images are being acquired. After the first sequencing cycle is over and the sequencing run is still in progress, the flow cell images from 4 different color channels are processed using image preprocessing steps. Each image has a matrix size of 5472×3648, there are a total of 424 flow cell images with 7 to 10 different z locations. Each flow cell image is separated into 54 subtiles in a 6×9 matrix, each subtile has 608×608 pixels. The first cycle is the reference cycle. A region of 128×128 at the same location in each subtile of each color image is selected as the region for determining the shift for the entire subtile after determining that the number of polonies in the region meets a predetermined threshold. The selected regions satisfy a predetermined threshold of 100 polonies therewithin. Candidate polony locations in the selected region of individual subtiles are determined and all the candidate polony spots are transformed into a reference coordinate system to obtain corresponding virtual coordinates. The transformation into the reference coordinate system is based on external fiducial markers. A template of 200 by 200 including all polony locations from 4 color channels in the first cycle is generated. Each flow cell image in a subsequent cycle is registered to the template by determining the best cross-correlations in the Fourier domain to the corresponding regions of the corresponding subtiles in the first cycle. In particular, 2D shifts that give the highest cross-correlations are determined and used to obtain affine matrix for each subtile using shifts from neighbor subtiles.

### Image Registration Rescue

In some embodiments, the sample immobilized on the support, e.g., flow cell, can be of low nucleotide diversity as disclosed herein. FIG. 21 shows example flow cell images from four different color channels in a flow cycle. One of the channels, e.g., channel 4 at bottom right, has fewer signal spots (i.e., polonies or clusters) than images from other channels due to lack of nucleotide diversity in the particular flow cycle. The polonies that emit optical signal in channel 4 may be less than 10% of the total number of polonies that emit signal among all 4 different channels. In some embodiments, image registration of flow cell image from channel 4, e.g., to a reference coordinate system, may be less reliable than image registration of images from other channels with better nucleotide diversity. In some embodiments, methods and systems for image registration rescue may be utilized to improve image registration accuracy and/or reliability of such channels in flow cycles of low nucleotide diversity.

The methods and systems for image registration rescue can be advantageous where sequencing data comprises unbalanced or low nucleotide diversity in one or more flow cycles. The methods and systems for image registration rescue can be advantageous especially for sequence runs in which index reads are sequenced before any insert reads and the index reads may be of low nucleotide diversity in one or more flow cycles. The methods and systems for image registration rescue can advantageously improve index assignment and/or matching in low diversity data so that the sequencing results can be more accurately and reliably demultiplexed to the different samples. The methods and systems for image registration rescue can also improve base calling accuracy and reliability by improving image registration of samples with low nucleotide diversity in the insert sequence in at least some cycles(s). In some embodiments, the methods and systems for image registration rescue can be selectively turned on and off when a customized threshold is satisfied so that they do not cause unnecessary delay of flow cell image processing for base calling results.

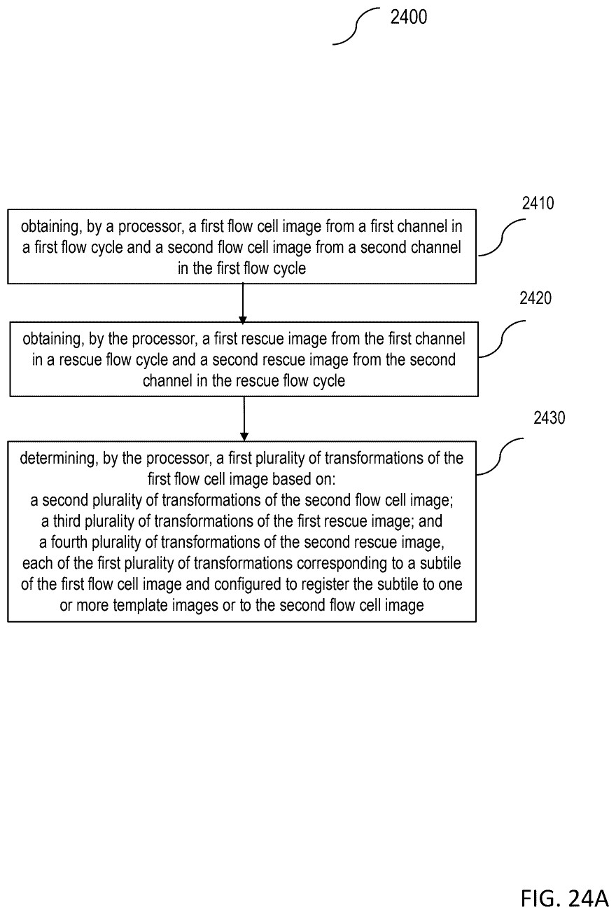

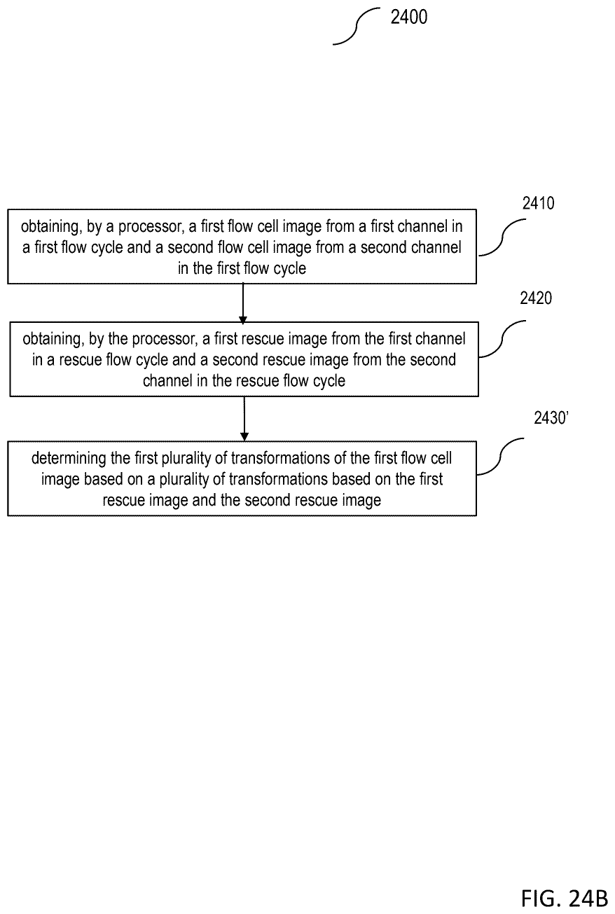

FIG. 24A-24B show flow charts of example embodiments of method 2400 for image registration rescue of flow cell images, especially flow cell images of low diversity data as disclosed herein. The method 2400 can include some or all of the operations disclosed herein. The operations may be performed in but are not limited to the order that is described herein.

The method 2400 can be performed by one or more processors disclosed herein. In some embodiments, the processor can include one or more of: a processing unit, an integrated circuit, or their combinations. For example, the processing unit can include a central processing unit (CPU) and/or a graphic processing unit (GPU). The integrated circuit can include a chip such as a field-programmable gate array (FPGA). In some embodiments, the processor can include the computing system 400.

In some embodiments, some or all operations in method 2400 can be performed by the FPGA(s). In embodiments when some operations are performed by FPGA(s), the data after an operation performed by the FPGA(s) can be communicated by the FPGA(s) s to the CPU(s) so that CPU(s) can perform subsequent operation(s) in method 2400 using such data. Similarly, data can also be communicated from the CPU(s) to the FPGA(s) for processing by the FPGA(s). In some embodiments, all the operations in method 2400 can be performed by CPU(s). Alternatively, the operations performed by CPU(s) can be performed by other processors such as the dedicated processors, or GPU(s). In some embodiments, all the operations in method 2400 can be performed by FPGA(s).

In some embodiments, the method 2400 is configured to align or register flow cell images across different sequencing cycles and/or from different channels to a common coordinate system. The common coordinate system can be the reference coordinate system disclosed herein. The common coordinate system can be the coordinate system of flow cell images from a channel, e.g., the channel with more than 15% of polonies of the total polonies. The common coordinate system can be predetermined.

The flow cell images can be acquired using the imager 116 disclosed herein, from one of the 1, 2, 3, 4, or more channels. Each flow cell image can include one or more tiles (imaging areas), and each tile can be divided into multiple subtiles. Each subtile can include multiple polonies. Each subtile can include multiple regions with each region including a number of polonies. For example, the polonies can be extracted from corresponding regions of flow cell images from 4 different channels in a certain cycle. As another example, the polonies can be extracted from flow cell images from a single channel. The flow cell image as disclosed herein can be an image of at least part of a flow cell 112 as shown in FIG. 1.

In some embodiments, the method 2400 is performed during a cycle N that is different from a reference cycle. In some embodiments, the method 2400 is performed during a cycle N while sequencing and image acquisition in subsequent cycles, e.g., cycle N+1, is being performed or yet to be performed. In some embodiments, the method 2400 is performed in parallel with the sequencing run to advantageously reduce the total time for sequencing and primary analysis. In some embodiments, the method 2400 can be performed after the sequencing run is completed. A template image can be generated in the reference cycle(s) and polonies from one or more channels within the reference cycle(s) can be included in the template image in a reference coordinate system, while base calling of cycle N is yet to be performed. In some embodiments, cycle N is the current cycle. N can be any non-zero integer. For example, for short read sequencing, N can be any integer from 1 to 150.

In some embodiments, the image registration rescue of images from cycles with low diversity data can be based on fiducial markers. The fiducial markers can be external to the flow cell. In some embodiments, the fiducial markers are distributed in a predetermined pattern so that the size of markers, distance between markers, and intensity of markers are predetermined. In some embodiments, the fiducial markers can be distributed randomly on the flow cell, e.g., as a coating. Flow cell images can be acquired from different channels with the identical fiducial markers but without any polonies, e.g., flow cell images of the test target. In some embodiments, the fiducial markers may include intensity levels that are comparable to those of the polonies to simulate the presence of polonies. Such images of fiducial markers can be additional to the flow cell images acquired during a sequencing run and can be used for registration and registration rescue of flow cell images and/or calibration of the imager 116. In some embodiments, such images of fiducial markers can be used to register offset or otherwise transformations across different channels within a flow cycle, and such offset and transformations may remain consistent in different flow cycles, e.g., several cycles that are continuous with each other in a sequence run. For example, the offset and transformation between channel 1 and channel 2 may be considered as identical in immediately adjacent cycles such as cycles 50 to 55.

When the selected regions are of low diversity data, the image registration rescue operations in method 2400 can be performed. The image registration rescue of images from cycles with low diversity data can be based on the fiducial markers.

In some embodiments, the fiducial markers are only used in generating additional images in the cycle(s) for registering images across different channels, e.g., within the reference cycle(s) or within the first 1-5 cycles. In embodiments where the fiducial markers appear in flow cell images of one or more cycles together with the polonies and clusters and can be differentiated from the polonies or clusters. In some embodiments, when registration or registration rescue across channels are not needed in certain cycles, images with only the fiducial markers but not the polonies are not acquired in such cycles. In some embodiments, when registration or registration rescue across channels are not needed in certain cycles, fiducial markers may still appear in flow cell images with the polonies and clusters. In some embodiments, images with the fiducial markers, e.g., the test target or the beaded flow cell are acquired in one or more cycles that are not the reference cycle(s). In some embodiments, images with the fiducial markers are acquired in one or more cycles before any cycle of a sequencing run. In some embodiments, images with the fiducial markers, e.g., the test target or the beaded flow cell are acquired in one or more cycles where the data is of low diversity.

In some embodiments, instead of using the fiducial markers for registration between channels, image registration information from a previous cycle or any rescue cycle can be used instead to register images from the channel(s) with low diversity data, e.g., the channel(s) with less than 10% of the total polonies in all channels. Comparing with acquiring additional images with fiducial markers in every cycle, imaging fiducial markers in reference cycles, in low diversity cycles, or in a regular pattern every several cycles, using image registration information from a previous cycle can reduce total imaging time and data to be processed while still achieve accurate and reliable image registration results using the methods herein.

The image registration of images across channels can be in 2D and can include translation, scaling, rotation, and/or shearing of flow cell images across different channels. Various methods can be used for registering flow cell images from multiple channels based on such external fiducial markers so that a marker with image intensity I with its center at location (x1, y1) can be positioned at location (xr, yr) with intensity I in the reference coordinate system, where (xr, yr)≅Mr*(x1, y1), and Mr is the transformation matrix. Similarly, the inverse transformation matrix Mr⁻¹ can be determined such that (x1, y1)≅Mr⁻¹*(xr, yr). In some embodiments, multiple fiducial markers can be used in determining the transformation matrix Mr, similar as equations (1)-(3). In some embodiments, multiple fiducial markers need to be at least 3 markers.

In some embodiments, image registration rescue may be performed based on a beaded flow cell or otherwise flow cell with external fiducial marker. For example, flow cell image from channel 4 in FIG. 21 may be acquired with additional fiducial markers of certain shape, size, or pattern. Registration of images with low signal level or a low number of polonies, less than 10%, than the total number of polonies across channel or to a reference coordinate system, can be directly rescued using registration of the identical external fiducial markers from different channels, e.g., by the image registration method 500. When the flow cell images are acquired in the absence of any fiducial markers, image registration rescue can be performed using method 2400.

In some embodiments, the method 2400 can include an operation 2410 of obtaining a first flow cell image from a first channel in a first flow cycle and a second flow cell image from a second channel in the first flow cycle. In some embodiments, the flow cell images, e.g., the first and second flow cell images, are obtained from the imager 116 of the sequencing system 110. In some embodiments, the first flow cell image is acquired in cycle N. In some embodiments, the number of polonies in the first flow cell image can be less than 1%, 2%, 5%, 10%, or 15% of a total number of polonies in flow cell images acquired among all channels in the first flow cycle. As such, the sample at the first flow cycle, e.g., cycle N, is of low nucleotide diversity. For example, the first flow cell image from the first channel may correspond to nucleotide A, and the total number of A is less than 10% of the total number of A, T, C, and G in cycle N. The second flow cell image may have a number of polonies that is more than 1%, 2%, 5%, 10%, or 15% of a total number of polonies in the flow cell images acquired among all the channels in the first flow cycle. For example, the second flow cell image may correspond to nucleotide T, and the total number of T in this cycle is greater than 20% of the total number of A, T, C, and G, i.e., total number of polonies, in cycle N. The first flow cell image may have a lower polony number or signal level than one or more flow cell images from other channels in the same flow cycle. Direct image registration using traditional methods of the first flow cell image to the one or more template images or to another image, e.g., the second flow cell image, may not be accurate and reliable due to the lower polony number and lower signal level in the first flow cell image.

In some embodiments, the flow cell images, e.g., the first and second flow cell images herein are of a sample comprising nucleotide acid template molecules. The sample may be immobilized on a solid support disclosed herein, e.g., a flow cell or a beaded flow cell. The first flow cycle may be among cycle 1 to cycle 30 of a sequencing run. The first flow cycle may be among cycle 2 to cycle 200 of a sequencing run. The first flow cycle may be among cycle 2 to a last cycle of a sequencing rune, e.g., cycle 400.

In some embodiments, the support can be part of a flow cell as disclosed herein, and the sample can be immobilized on the flow cell. In some embodiments, the support can be part of a beaded flow cell. The beaded flow cell may comprise a surface coated with fluorescent beads that are chemically immobilized to the surface. In some embodiments, the fluorescent beads are randomly distributed on the surface. In some embodiments, the fluorescent beads are distributed in a repeated pattern on the surface. Similar as the test target disclosed herein, the fluorescent beads may provide fiducial markers that enable image registration of images across different channels in the same flow cycle. In some embodiments, the fluorescent beads may provide fiducial markers that enable image registration of images across different channels. In some embodiments, the fluorescent beads comprise one, two, three, four, five or six different types of beads that emit different colors in response to a light excitement. In some embodiments, the fluorescent beads emit fluorescent light of one or more wavelengths in response to the light excitement. The fluorescent beads emit fluorescent light of multiple wavelengths in response to the light excitement, each of the multiple wavelengths corresponding to a different channel of the all the channels.

In some embodiments, the operation 2410 may include an operation of providing nucleic acid template molecules immobilized on the support. In some embodiments, each nucleic acid template molecule can include at least a first insert sequence and a first sample index sequence. The first sample index sequence can include a first universal sample index sequence, and the first universal sample index can identify a sample source of the insert sequence.

In some embodiments, the operation 2410 may include an operation of conducting one or more flow cycles of sequencing reactions. Such sequencing reactions may be performed by a sequencing system, e.g., 100 in FIG. 1. The sequencing reactions may be of the first sample index sequence before conducting one or more cycles of the sequencing reactions of the insert sequence to generate flow cell images comprising the first flow cell image and the second flow cell image in the first flow cycle. The sequencing reactions may be of the insert sequence before conducting one or more cycles of the sequencing reactions of the index sequence to generate flow cell images comprising the first flow cell image and the second flow cell image in the first flow cycle. In some embodiments, the first flow cycle may be of the first sample index sequence of each nucleic acid template molecule. In some embodiments, the first flow cycle may be of the first insert sequence of each nucleic acid template molecule.

In some embodiments, the operation 2410 may comprise an operation of generating the flow cell images comprising the first flow cell image, the second flow cell image, or bobth, by conducting one or more cycles of sequencing reactions of the plurality of nucleic acid template molecules immobilized on the support. Conducting the one or more cycles of the sequencing reactions may comprise: contacting the plurality of nucleotide acid template molecules using a plurality of nucleotide reagents comprising a mixture of different types of nucleotide bases A, G, C and T/U. Individual nucleotide reagent may comprise a different detectable color label that corresponds with each different type of nucleotide base. In some embodiments, conducting the one or more cycles of the sequencing reactions may comprise: contacting the plurality of nucleotide acid template molecules with a plurality of sequencing primers, a plurality of polymerases and a mixture of different types of avidites. An individual avidite in the mixture may comprise a core attached with multiple nucleotide arms and each arm of the individual avidite comprises the same type of nucleotide base. In some embodiments, conducting the one or more cycles of the sequencing reactions comprises: in each of the one or more cycles, imaging optical color signals emitted from nucleotide reagents that are bound to the plurality of template molecules. Imaging the optical signals may be performed by an optical system, e.g., the imager 116, disclosed herein. In some embodiments conducting the one or more cycles of the sequencing reactions may comprise: in each of the one or more cycles, acquiring the flow cell images comprising optical color signals emitted from nucleotide reagents that are bound to the plurality of template molecules.

In some embodiments, the flow cell images comprises optical signals emitted from nucleotide reagents bound to a unbalanced diversity of nucleotide bases of A, G, C and T/U among the plurality of nucleic acid template molecules immobilized on the support in the one or more cycles. In some embodiments, the plurality of polonies comprise a unbalanced diversity of nucleotide bases of A, G, C and T/U, and wherein the unbalanced diversity comprises a percentage of: (1) a number of one or more types of nucleotide bases to (2) a total number of nucleotide bases, and the percentage is less than 20%, 15%, 10%, or 5% in the cycle N. The plurality of polonies corresponds to the plurality of nucleotide acid template molecules.

In some embodiments, the operation 2410 may comprise providing a cellular sample having a plurality of concatemer molecules immobilized on a support, wherein each concatemer molecule corresponds to a target RNA of a cellular sample.

In some embodiments, the operation 2410 may comprise generating, by a sequencing system, flow cell images (e.g., comprising the first flow cell image, the second flow cell image, or both) by conducting one or more cycles of sequencing reactions of the plurality of concatemer molecules immobilized on the support. Conducting the one or more cycles of the sequencing reactions may comprise: contacting the plurality of concatemer molecules using a plurality of nucleotide reagents comprising a mixture of different types of nucleotide bases A, G, C and T/U. Conducting the one or more cycles of the sequencing reactions may comprise: contacting the plurality of concatemer molecules with a plurality of sequencing primers, a plurality of polymerases, and a mixture of different types of avidites.

The individual avidite in the mixture comprises a core attached with multiple nucleotide arms and each arm of the individual avidite comprises the same type of nucleotide base. Conducting the one or more cycles of the sequencing reactions may comprise: in each of the one or more cycles, imaging, by the optical system, optical color signals emitted from nucleotide reagents that are bound to the plurality of concatemer molecules. In some embodiments, conducting the one or more cycles of the sequencing reactions may comprise: in each of the one or more cycles, acquiring, by an optical system, the flow cell images comprising optical color signals emitted from nucleotide reagents that are bound to the plurality of concatemer molecules.

In some embodiments, the method 2400 may comprise an operation 2420 of obtaining a first rescue image from the first channel in a rescue flow cycle and a second rescue image from the second channel in the rescue flow cycle.

Each of the first and second rescue images may have a number of polonies that is more than 1%, 2%, 5%, 10%, or 15% of the total number of polonies in flow cell images acquired among all channels in the rescue flow cycle. In other words, the first and second rescue images are acquired in channels corresponding to nucleotides with high nucleotide portion. For example, the first and second rescue images correspond to A and T, respectively, and each rescue image may have a number of A or T that is more than 15%, 18%, or 20% of the total number of polonies among all different channels.

The first flow cycle may be different from the rescue flow cycle. In some embodiments, the rescue flow cycle is a cycle completed before the first flow cycle. In some embodiments, the rescue flow cycle is completed immediately before the first flow cycle so that the image registration across different channels are substantially identical in the first flow cycle and the rescue cycle. In some embodiments, the first and second flow cell images are of a sample immobilized on the support, and the first and second rescue images are of the same sample immobilized on the support.

In some embodiments, the rescue cycle may be before cycle 1 of a sequencing run and the first and second rescue images are of a test target that is external to the sample on the support. In some embodiments, the first and second rescue images are of the test target in the absence of the sample immobilized on the support. The test target may comprise fiducial markers. The fiducial markers may emit fluorescent signals detectable in all channels in the rescue flow cycle.

The test target may comprise a coating of predetermined geometric shapes or patterns that are spatially repeated. The predetermined geometric patterns or shapes may be repeated in one or two dimensions. In some embodiments, the test target lacks a flow cell and a liquid. In some embodiments, the test target comprises one or more substrates with a predetermined refractive index. The test target may include a top substrate having a predetermined refractive index. In some embodiments, the test target may comprise a bottom substrate. At least a portion of the first or second substrates comprises the coating with the predetermined geometric patterns or shapes. In some embodiments, the thickness of the top or bottom substrate is configured to simulate presence of a first hypothetical flow cell. In some embodiments, the thickness of the top substrate is configured to permit imaging of the bottom surface of the first channel of the hypothetical first flow cell. The coating the predetermined geometric shapes or patterns may comprise optically opaque portions and transparent portions.

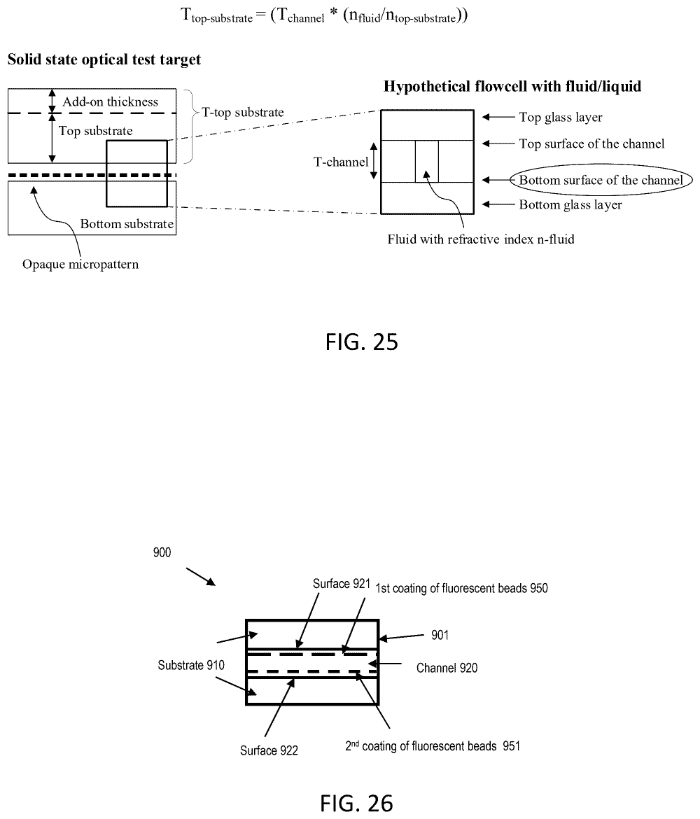

FIG. 25 shows a nonlimiting example of the test target here. The Left schematic shows an example solid state test target having a first substrate (top) and second substrate (bottom) with an opaque layer between the first and second substrate. The opaque layer can be coated on the bottom surface of the first substrate or the top surface of the second substrate. The opaque layer forms a micropattern. The first substrate is transparent which permits light transmission from its bottom surface and a view of the micropattern. The test target lacks a flow cell and liquid. The thickness of the first substrate is adjusted to simulate the presence of a hypothetical flow cell which contains a fluid/liquid, where the hypothetical flow cell could be located between the first and second substrates. For example, the first substrate is thicker, having an add-on thickness. The Right schematic shows a hypothetical flow cell which includes a channel having a thickness [T-channel] and the channel contains a fluid/liquid having a refractive index [n-fluid]. The test target can be positioned on a sequencing system for performing or facilitating sequencing analysis, e.g., image registration or image registration rescue, by obtaining and analyzing images of the fluorescent beads.

In some embodiments, a flow cell disclosed herein can comprise a support disclosed herein. The support can be solid. At least part of the support can be transparent. The support can comprise one or more substrates. At least part of the one or more substrates can be transparent. FIG. 26 shows an example embodiment of the flow cell 900. The flow cell 900 includes a support 901 and other elements such as coatings. The support can comprise a top substrate 910 and a bottom substrate 910. Each substrate 910 can have a predetermined thickness, and different substrate can have different thickness. The substrate can define one or more channels 920 of the device 900. The channels can allow fluid flow therethrough, e.g., liquid or air. The flow cell can include one or more inlet 920 and one or more outlets 930 in the one or more substrates 910. FIG. 26 shows example device 900 with two substrates forming two channels, and each channel having an inlet and an outlet. However, the number of substrates, channels, inlets and outlets in other embodiments can be different. In some embodiments, the number of substrates, channels, inlets and outlets can be any integer number that is greater than 0. FIG. 26 shows example device 900 with two planar substrates without curvature in the surface(s) of the substrate. However, the substrate does not have to be planar.

In some embodiments, the one or more channels 920 can run from the inlet 930 to the outlet 940 so that fluid can flow from the inlet 930 via the one or more channels 920 to the outlet 940. As an example, sequencing reagents can be introduced to the flow cell via the inlet, flow through the channels, and then exit from the outlet. The channel(s) 920 can comprise a top interior surface 921 and a bottom interior surface 922. One or more of the surfaces can be coated with fiducial markers, e.g., fluorescent beads.

The fiducial markers, e.g., fluorescent beads, can be immobilized to the surface. The fluorescent beads can be covalently or chemically immobilized to the surface. The fluorescent beads can be immobilized or fixedly attached to the surface 921, 922 by forming a coating 950, 951 thereon, so that the fluorescent beads remain fixed or immobilized relative to the surface 921, 922. The coating 950, 951 can be applied directly to and in contact with the interior surface 921, 922. Alternatively, the coating 950, 951 can be applied indirectly to or not in direct contact with the interior surface 921, 922. In some embodiments, the coating 950, 951 can be applied with some compounds in between the surface 921, 922 and the coating 950, 951. For example, the coating 950, 951 can be applied on top of another coating that is directly applied to and in contact with the surface 921, 922. In some embodiments, the surface is passivated with another coating (not shown). Such another coating can immobilize surface capture primers, nucleic acid template molecules, or both for capturing polynucleotides on the surface 921, 922. In some embodiments, the surface 921, 922 comprises polynucleotides captured thereon.

In some embodiments, the coating 951, 952 that attaches the fluorescent beads can be mixed with one or more other coatings so that the mixed coating can be applied directly to and in contact with the interior surface 921, 922. The mixed coating can immobilize fluorescent beads on the surface. Further, the mixed coating may also immobilize surface capture primers, nucleic acid template molecules, or both for capturing polynucleotides on the surface 921, 922. In some embodiments, the fixed coating may capture polynucleotides on the surface 921, 922, and administration of sequencing reagents can facilitate sequencing of the polynucleotides as disclosed herein using various sequencing methods, for example, sequencing-via-avidite.

In some embodiments, the flow cell 900 can be used on a sequencing system for DNA sequencing. The flow cell 900 may receive various sequencing reagents before a sequencing cycle via the inlet 930 and allow the reagent(s) to flow through the one or more channels 920 and exit via the outlet 940. In some embodiments, the fluorescent beads remain immobilized relative to the surface 921, 922 during or after administration of sequencing reagents to the flow cell 900.

In some embodiments, the fluorescent beads are chemically immobilized to the surface. In some embodiments, the fluorescent beads are covalently immobilized to the surface. In some embodiments, the fluorescent beads are pre-activated to enable chemical attachment to the surface. In some embodiments, the fluorescent beads are pre-activated to enable covalent attachment to the surface.

In some embodiments, the clusters or polonies of polynucleotides captured thereon and the fluorescent beads are imaged simultaneously in one or more sequencing cycles using a sequencing system 110. In some embodiments, a flow cell image acquired of the flow cell 900 can include signals from the fluorescent beads and signals from clusters or polonies of polynucleotides. Since the fluorescent beads are immobilized to the surface, their positions relative to the surface remain fixed, while the polynucleotides may move relative to the surface, even if they are captured on the surface. The movement of the polynucleotides in different flow cell images may cause errors in base calling, thereby requiring image registration before base calling. The immobilized fluorescent beads can be used as fiducial markers for registering or aligning clusters or polonies across different cycles and/or different channels and eliminate the need of using additional fiducial markers that is external to the flow cell device, such as the optical test targets disclosed herein. In some embodiments, the positions of same fluorescent beads in two different images across cycles and/or channels can be used to determine a transformation between the two different flow cell images, and the transformation can be applied to the positions of the clusters or polonies to perform image registration of the clusters or polonies. The transformation can include one or more transformation matrices for some area or the entire flow cell images. In embodiments where at least some of the clusters or polonies move across cycles and/or channels, the flow cell disclosed herein can advantageously facilitate image registration of flow cell images and allow more accurate and reliable base calling after image registration.

In some embodiments, the clusters or polonies and the fluorescent beads can be imaged in different cycles. For example, the cluster or polonies can be imaged during bright cycles while the fluorescent beads can be imaged in a dark cycle.

In some embodiments, the clusters or polonies and the fluorescent beads can be imaged in the same cycle(s). For example, the clusters or polonies and the fluorescent beads can be imaged simultaneously in a first cycle and a Nth cycle, where the number N can be any integer greater than 1. Since the fluorescent beads remain fixed to the surface, the change in positions of the fluorescent beads between cycles can be used to determine movements that can be attributed to sources in the sequencing system and external to the flow cell device, such as movement of the stage, an optical element, etc. The positions of the clusters or polonies relative to the fluorescent beads can be used to determine movements attributed to motion of the clusters or polonies on the surface, so that the clusters or polonies in the first and the nth cycle can be aligned/registered independent of movement attributable to cause(s) external to the flow cell devices.

In some embodiments, the clusters or polonies and the fluorescent beads can be imaged in the same channel(s) of identical or different cycles so that image transformation caused by difference in elements of the sequencing system or otherwise variances across cycles are determined in aligning/registering the clusters or polonies in different flow cell images. In some embodiments, the clusters or polonies and the fluorescent beads can be imaged in different channels of identical or different cycles so that image transformation can take into consideration transformation across channels, alone or in combination with transformation across cycles.

In some embodiments, the flow cell 900 with fluorescent beads can be used for image registration alone or in combination with the test target disclosed herein. For example, the test target can be used for registering images from different channels within a same cycle and the fluorescent beads can be used for registering images from different cycles but identical channel(s). As another example, the solid state optical test target can be used for registering images from a reference cycle to a template coordinate system, and fluorescent beads can be used for registering images acquired from all channels in a cycle that is not a reference cycle to the temple coordinate system.

In some embodiments, the method 2400 comprises an operation 2430 of determining, a first plurality of transformations of the first flow cell image. Each of the first plurality of transformations may correspond to a subtile of the first flow cell image and may be configured to register or align the corresponding subtile to a predetermined coordinate system, e.g., a reference coordinate system, or a coordinate system of another flow image from a different channel.

The operation 2430 can be performed by a processor disclosed herein. The determination of the first plurality of transformation can be based on one or more of: a second plurality of transformations of the second flow cell image; a third plurality of transformations of the first rescue image; and a fourth plurality of transformations of the second rescue image.

In some embodiments, the operation 2430 may include determining each transformation corresponding to one or more selected regions in a subtile of the first flow cell image.

The one or more regions may be selected from a subtile of the flow cell image. Each of the one or more selected regions may have various sizes that are not bigger than the corresponding subtile, for example, each selected region can be 128×128, 96×96, 64×64, or other various sizes. For example, the region can be selected as enclosing center pixel(s) of the subtile. For images from cellular samples or other various samples that distributed heterogeneously over the FOV, the region for each subtile may be selected to be at various locations in the subtile. In some embodiments, the region is selected to ensure that at least a threshold number of cells or polonies are within the selected region. For example, the operation 510 may comprise an operation of determining the number of cells and/or polonies within the region. The region including center pixels, e.g., 128 by 128, may be a default selection. In response to determining that the center region does not include cells and/or polonies meeting a predetermined threshold, the method 500 may include an operation of moving the selected region until a region meeting the predetermined threshold is found. The selected region may be at the same location across different color channels and/or cycles. The predetermined number of polonies or clusters can be 20, 40, 60, 80 or more. The predetermined number of cells can be 1, 2, 5, 8, 10, or more.

The region for each subtile may be selected to be at various locations in the subtile. In some embodiments, the region is selected based on various standards such as largest signal variance, highest average signal intensity, or largest standard deviation of signal intensity, etc., within the selected region among multiple candidate regions within the same subtile. The region selected with the various standards, e.g., larger signal variance, may be more likely to contain stronger signals of polonies and/or cells than other regions with lower signal variances and may facilitate image registration than other regions. In some embodiments, some or all of the possible options of selecting the region within the subtile are included as candidate regions. For example, for a 100 by 100 region size, sliding the window through all rows and columns of the subtile may provide all possible options of selecting the 100 by 100 region. In some embodiments, the selected region can be at different locations for different subtiles. The selected region may remain identical for the same subtile at different cycles or across different color channels. In some embodiments, each subtile may include one or more selected regions. Two different subtiles may include a different number of selected regions. The size of the selected regions may be identical or different. For example, subtile 1 may have a single selected region including its center pixels, subtile 2 may have 3 selected regions and none of them include any center pixels, and the 3 selected regions can be different in size. Such selection based on the predetermined threshold may also be used for 2D samples with sparse polony or cluster distribution within the subtiles, e.g., less than 100 polonies in 128 by 128 region or dim signals within the subtiles, e.g., less than 10%, 20% or other percentages of average signal intensity than another region.

The operation of selecting the region(s) within each subtile may help to ensure that the Fourier transform of the selected region contains at least some signal from the polonies but not just background and/or noises.

The region may be various two-dimensional shapes, e.g., rectangle, circle, or square. As a nonlimiting example, the selected region can include one or more center pixels of the subtile. A nonlimiting example of the selected region 230 is shown in FIG. 2. The region 230 can include multiple polonies 232 in FIG. 2. The size of the region can be determined to balance the trade-off between different factors including but not limited to computational complexity, time consumption and accuracy of image registration. For example, selecting a 64×64 region can be computationally simpler than selecting a 128×128 region but may not be as accurate. The polonies can be included in a tile or subtile of a flow cell image. In some embodiments, the polonies can be from one or more selected regions of the subtile in the first flow cell image.

Once the region(s) is selected in the first flow cell image, corresponding region(s) can be determined in the second flow cell image, the first and second rescue images. corresponding region(s) can be determined in the second flow cell image, the first and second rescue images may be at same coordinates of the corresponding image. The selected regions can be used to represent its corresponding subtile but with a smaller size to reduce computational time and cost in image registration and image registration rescue while still achieving accurate and reliable registration and/or registration rescue. In some embodiments, the one or more selected regions can be selected to over the entire subtile with a tradeoff of increased computation time and cost.

In some embodiments, the operation 2430 may include an operation of determining a corresponding shift, d2(i,j), d3(i,j), or d4(i,j), of each subtile of the second flow cell image, the first rescue image, and the second rescue image, respectively. The coordinates (i, j) may indicate the shift d2(i,j) is at the subtile at the ith row and jth column of the flow cell image, wherein i may be any number from 1 to the total number of rows, and j may be any number from 1 to the total number of columns, and where d2, d3, or d4, each collectively represent all the possible shift d2(i,j), d3(i,j), or d4(i,j), respectively. The corresponding shift may be with a subpixel resolution, e.g., 0.05 or 0.1 pixel resolution. The corresponding shift, d2(i,j), d3(i,j), or d4(i,j), may be 2D or 3D. The corresponding shift, d2 d2(i,j), d3(i,j), or d4(i,j), d3, d4 may be determined based on the corresponding region(s) in the second flow cell image, the first and second rescue images.

Various methods can be used to determine the spatial shift(s) of an image to a reference, or more specifically, a same group of polonies in one or more selected regions in the second flow cell image, the first and second rescue image, to a corresponding template image or a reference coordinate system. For example, the method 2400 may comprise an operation of determining a corresponding cross correlation of the one or more selected regions of the corresponding subtile of the second flow cell image, the first rescue image, and the second rescue image with the template image(s). The one or more template images are disclosed herein in relation to methods 500. For example, the one or more template images are 2D and may comprise a size that is about identical to the size of the corresponding subtile. An example flow cell can have 54 template images, each corresponding to a subtile with a size that is identical to the corresponding subtile. The one or more template images can include polonies from all the channels so that at least some of the same polonies in the selected regions of the second flow cell image, the first rescue image, and the second rescue image are included in the template image(s) for alignment and registration. Each 2D shift that optimizes, e.g., maximizes, the cross correlation between the corresponding subtiles containing at least some identical polonies can be determined as the 2D shift of the corresponding subtiles. Each subtile can have its corresponding 2D shift. The example flow cell can have 54 shifts, e.g., each of d2, d3, and d4 is a matrix with 54 entries.

As another example, the method 2400 may comprise an operation of determining the spatial shift(s), e.g., 2D shift(s), by generating Fourier Transformed Images (FTIs) of the second flow cell image and the one or more template images, and determine the 2D shift of the corresponding subtile in the frequency domain based on the FTIs.

In some embodiments, the operation 2430 may include determining the second plurality of transformations of the second flow cell image, each transformation corresponding to a subtile of the second flow cell image. The individual transformation can be based on corresponding shifts, d2, of one or more neighboring subtiles thereof. Similarly, the operation 2430 may include determining the third plurality of transformations of the first rescue image based on corresponding shifts, d3, of one or more neighboring subtiles thereof; and determining the fourth plurality of transformations of the second rescue image based on corresponding shifts, d4, of one or more neighboring subtiles thereof.

Details of determining a transformation of a subtile or any region of an image based on shifts of neighboring subtiles or regions are disclosed herein in relation to method 500, using equations (1) to (3).

In some embodiments, the operation 2430 may include determining the first plurality of transformations, e.g., d, based on the second, third, and fourth plurality of transformations, e.g., d2, d3, and d4.

In some embodiments, each plurality of transformations, e.g., the first, second, third, or fourth plurality of transformations, disclosed herein comprise one or more non-linear transformations. In some embodiments, each plurality of transformations comprises one or more linear transformations. In some embodiments, each plurality of transformations comprises one or more affine transformations. In some embodiments, each transformation disclosed herein is an affine transformation.

In some embodiments, the operation 2430 can include determining each transformation of the first plurality of transformations, T1_i, based on the corresponding transformation of the second, third, and fourth plurality of the transformations, T2_i, T3_i, and T4_i, as:

$${( T1\_i )}^{- 1} = {( T2\_i )}^{- 1} \cdot T4\_i \cdot {( T3\_i )}^{- 1}$$

wherein i is from 1 to the total number of subtiles, and wherein T1_i, T2_i, T3_i, and T4_i are n by n transformation matrix, where n is an integer. For example, n=3.

The method 2400 can be used to determine transformations, i.e., T1_i, indirectly when such transformations may not be determined directly, e.g., using its corresponding shifts using equations (1)-(3), with accuracy and reliability. For example, the first flow cell image may be of fewer signal spots, i.e., less than 10% of the total polonies, so that direct determination of the transformations may include errors. Instead, the transformations can be determined indirectly based on other images with more signal spots and its relationship with the other images. The transformations with high nucleotide portion, thus higher diversity, T2_i, T3_i, and T4_i, may be determined in a similar fashion as disclosed herein in relation to methods 500, e.g., using the equations (1)-(3). In other words, when the sample nucleotide acid molecules are of low diversity in a flow cycle, some channels may fail traditional image registration due to a low level of polonies/signal caused by the low diversity data. The failed image registration of the first flow cell image can be rescued by deriving the transformations indirectly from other images with sufficient level of signal to generate reliable image registration. The image registration herein can be with respect to any commonly shared coordinate system or image, e.g., the template images. The methods 2400 may be used to rescue image registration that may fail for various regions, and is not limited to rescue of registration of low diversity data.

In some embodiments, the method 2400 may comprise one or more operations during one or more reference cycles. In some embodiments, such operations can include acquiring, by the imager 116, reference flow cell images in the one or more reference flow cycles. Such operations may further include determining coordinates of polonies in a reference coordinate system, wherein the polonies are obtained from the reference flow cell images in one or more reference flow cycles. In some embodiments, method 2400 may include an operation of generating one or more template images in the reference coordinate system by registering the polonies to the one or more template images using the coordinates thereof. The one or more template images can be used in subsequent operations, e.g., 2430, for determining the transformations of the image with low polony/signal level, e.g., the first flow cell image.

In some embodiment, the operation 2430 may include determining coordinates of polonies within one or more of: the first flow cell image, the second flow cell image, the first rescue image, and the second rescue image. Instead of determining the shifts using images or regions of the images, the shifts may also be determined using lists of coordinates of polonies. The coordinates of the polonies may be within a reference coordinate system or otherwise a commonly shared coordinate system among the first flow cell image, the second flow cell image, the first rescue image, the second rescue image, or a combination thereof. The coordinates of the polonies may be in two dimensions (2D) or three dimensions (3D). The coordinates of the polonies can be used to determine spatial shift(s), e.g., 2D shift(s), between two images in which the same polonies appear in both images and optionally at different coordinates due to the shifts between both images.

In some embodiments, the method 2400 may include an operation of communicating, the first plurality of transformations to a processing unit. For example, the first plurality of transformations may be determined by FPGAs to improve the calculation speed over generic CPUs, and the transformations, e.g., the affine matrices, may be transferred back to a processing unit for subsequent processing steps. In some embodiments, the processing unit is a central processing unit (CPU). In some embodiments, the method 2400 may include an operation of extracting image intensities of polonies, from the first flow cell image based on the first plurality of transformations, e.g., by the CPU.

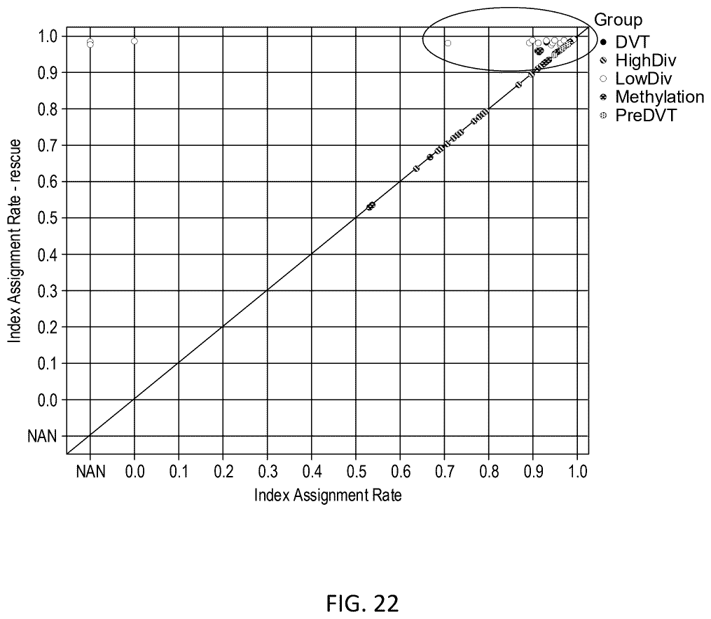

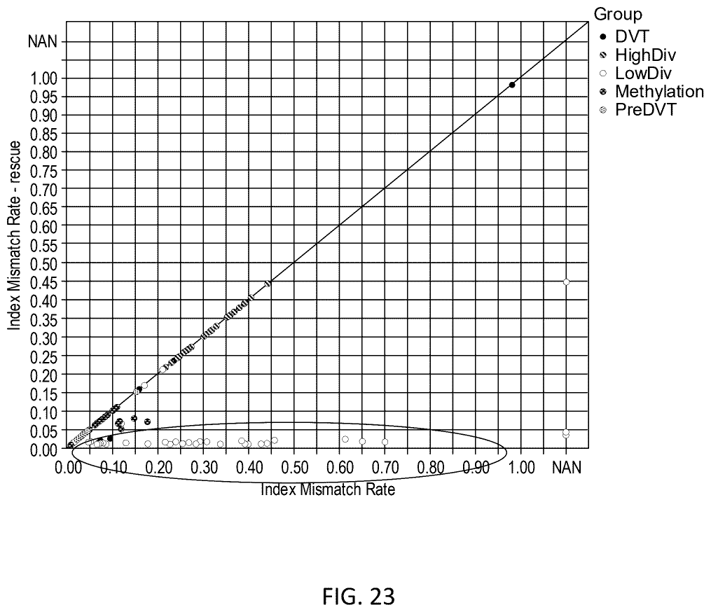

In some embodiments, the methods 2400 may include an operation of making base calls using the image intensities of the polonies of the first flow cell image based on the first plurality of transformations. The base calling may be performed after image registration rescue using the first plurality of transformations so that accuracy and reliability of base calling can be improved, especially with low nucleotide diversity data, than traditional methods. For example, index unassignment rate and mismatch rate can be improved after image registration rescue of low diversity data using the method disclosed herein. FIGS. 22-23 show improved index un unassignment rate and mismatch rate of low diversity using image registration rescue method 2400. In FIG. 22, dots above the diagonal line indicate improved index assignment rate. For low-diversity tiles (green dots), 24 out of 142 tiles (˜17%) are improved, and 9 of those 24 had erroneous outputs without registration rescue. Various high diversity tiles also have some improvements in comparison with assignment rate without image registration rescue. FIG. 23 shows green dots below the diagonal line that are with improved index mismatch rate. Image registration rescue 2400 has no negative interferences with high diversity data tiles in their index assignment or mismatch rate as shown as the dots on the diagonal lines.

The unassignment rate can be a fraction of polonies that does not match any of the mapping index sequences and/or a fraction of polonies that matches two mapping index sequences of two or more different samples. In other words, the fraction of polonies, relative to the total number of polonies, whose index sequences do not match the reference index sequences of a single sample within the error tolerance rate.

The assignment rate can be a fraction of polonies whose index sequence(s) matches the mapping index sequence(s) of a single sample. In other words, the fraction of polonies, relative to the total number of polonies, that matches the reference index sequences of the single sample within the error tolerance rate.

The mismatch rate can be a fraction of polonies, relative to the total number of polonies, matching (within the error tolerance rate) the reference index sequences of a single sample with some mismatched bases.

The match rate can be a fraction of polonies, relative to the total number of polonies, matching the reference index sequence(s) of a single sample with no errors.

In some embodiments, after the first plurality of transformations are determined in operation 2430, the method 2400 may include an operation of registering subtiles of the first flow cell image using the first plurality of transformations. In some embodiments, registering the subtiles of the first flow cell image include an operation of registering each subtile of the first flow cell image using a corresponding transformation of the first plurality of transformations to a coordinate system, e.g., a reference coordinate system. Such registration is equivalent to registering the first flow cell image to other image(s) in a predetermined coordinate system, e.g., one or more template images, the second flow cell image, or a polony map.

In some embodiments, the method 2400 comprises an operation of determining whether the number of polonies in the first flow cell image satisfies a predetermined threshold or not. In response to determining that the predetermined threshold is satisfied, image registration rescue can be turned on. The image registration rescue result(s) may replace any preexisting image registration result of the first flow cell image. In some embodiments, the predetermined threshold may be customized for various sequencing runs. For example, the predetermined threshold can be a range for the number of polonies within the flow cell image in a specified area such as less than 100, 200, 400, 500, 600, or 800 polonies in a 128 pixel by 128 pixel region of a 5472 pixel by 3648 pixel flow cell image. In some embodiments, the predetermined threshold may be an unassignment rate and/or a mismatch rate of polonies in the flow cycle. In some embodiments, the predetermined threshold can be a certain number or range of image quality, such as signal to noise ratio or contrast to noise ratio.

In some embodiments, the processor herein includes one or more processing units; one or more integrated circuits; or their combinations. In some embodiments, the processor includes: one or more central processing units (CPUs); one or more field-programmable gate arrays (FPGAs); or their combinations.

In some embodiments, the method 2400 comprises an operation of performing, by the processor, one or more preprocessing steps on the flow cell images, e.g., first flow cell image, the second flow cell image, the first rescue image, the second rescue image, or a combination thereof.

In some embodiments, this operation of performing one or more preprocessing steps can be performed by the FPGA(s). In some embodiments, the data after the operation can be communicated by the FPGA(s) to the CPU(s) so that CPU(s) can perform subsequent operation(s) in method 500 using such data.

In some embodiments, the one or more preprocessing steps of flow cell images in the reference cycle can be performed before operation 2430. In some embodiments, the one or more preprocessing steps of flow cell images in the reference cycle can be performed after the operation 2410 of obtaining the flow cell images. In some embodiments, the one or more preprocessing steps of flow cell images in the reference cycle can be performed before an operation of obtaining image intensities, sizes, shapes, or their combinations of the polonies from the plurality of subtiles of the flow cell images in the reference cycle.

The one or more preprocessing steps can comprise background subtraction. The background subtraction is configured to remove at least some background signal that may interfere with the signal of interest, i.e., image intensities of the polonies. The background signal can be noise caused by multiple sources including the flow cell 112, the imager 115, the sequencer 114, and other sources. The background subtraction can be adjusted to avoid over subtraction.

The one or more preprocessing steps can include image sharpening so that image intensities of polonies can be optimized in consideration of their surroundings in the flow cell images. For example, a Laplacian of Gaussian (LoG) filter can be used for sharpening.

The one or more preprocessing steps can include intensity offset adjustment that can remove the offset in the intensity that has not been removed during background subtraction.

The one or more preprocessing steps can include color correction to remove interference of one channel from other channels or colors.

The one or more preprocessing steps can include phasing and prephasing correction which is configured to correct image intensities within a specific cycle by removing intensity biases caused by sequencing of DNA fragments that are out of synchronization from other fragments by either falling behind or getting ahead.

The one or more preprocessing steps can include intensity normalization so that the image intensity of polonies from different channels can be normalized to be within a predetermined range.

The one or more preprocessing steps can comprise: background subtraction; image sharpening; or a combination thereof.

In some embodiments, the method 2400 may be utilized for image registration rescue without the need of any template images. The method 2400 may determine the transformations between two images in a high diversity flow cycle, e.g., the first and second rescue images in the rescue flow cycle, and utilize such transformations to indirectly determine the transformations of the image in a low diversity flow cycle, e.g. the first flow cell image in the flow cycle, to another image in the same flow cycle, e.g., the second flow cell image in the flow cycle. Eliminating the need of any template image may advantageously save computation time, storage space, and reduce delay in image registration rescue of low diversity images.

In such embodiments, the method 2400 may include operations 2410 and 2420 are disclosed above. As shown in FIG. 24B, the method 2400 may include an operation 2430′ instead of 2430 for determining the transformations for image registration rescue. The operation 2430′ can be determining the first plurality of transformations of the first flow cell image based on a plurality of transformations based on the first rescue image and the second rescue image. The plurality of transformations may be between the first rescue image and the second rescue image, without using any template images. Each of the first plurality of transformations may correspond to a subtile of the first flow cell image and may be configured to register the subtile to one or more template images or to the second flow cell image. In some embodiments, the first and second rescue image may include signal/polonies that appear in both images so that shift between the two rescue images can be determined using the commonly appearing signal/polonies.

In some embodiments, the operation 2430′ of determining the first plurality of transformations may comprise, for each pair of corresponding subtiles in the first rescue image and the second rescue image, determining a shift, d34, between the pair of subtiles. The shift, d34, can be determined, using similar operations for determining other shifts d, d2, d3, and d4. The shift, d34, can be a 2D shift, as other shifts, d2, d3, etc. The shift, d34, may be determined by calculating cross correlation of the selected region(s) of the corresponding subtile of the first rescue image with that of the second rescue image. Similarly as disclosed herein for d2, d3, d4, The shift, d34, may be determined by using FTIs of the selected region(s) of the corresponding subtile of the first rescue image with that of the second rescue image. For a flow cell with 54 subtiles, it may have 54 different shifts, d34, corresponding to each of the subtiles.

In some embodiments, the operation 2430′ may include determining a transformation of the pair of corresponding subtiles of the first rescue image and the second rescue image based on the corresponding shift, d34, and other shifts of one or more neighboring subtiles thereof. Such determination can be repeated for each pair of corresponding subtiles of the first and second rescue image, thereby generating a plurality of transformations, T34_i, where i is in the range from 1 to the total number of subtiles, and where the transformation, T34, is from the first to the second rescue image. The transformation, T43, can be from the second to the first rescue image. The operation 2430′ can further include determining the first plurality of transformations based on the plurality of transformations. In some embodiments, the operation 2430′ can include determining each transformation of the first plurality of transformations, T12_i, based on the corresponding transformation of the plurality of the transformations, T34_i as: T12_i=T34_i or (T12_i)⁻¹=T43_i, where i is in the range from 1 to the total number of subtiles.

In some embodiments, the plurality of transformations such as T3_i, T4_i, T34_i of the rescue cycle, and shifts like d3, d4, d34, can be pre-calculated and saved after the rescue cycle has been determined and the flow cell images have been acquired so that they can be retrieved for determining T1_i, or T12_i whenever needed to increase efficiency of image registration rescue.

### Parameter Estimation Robustness

In some embodiments, the one or more preprocessing steps or other image processing steps, e.g., involving image intensities, in primary analysis may be affected by low diversity data. In some embodiments, when some flow cell images in a specific flow cycle are of low signal level or of low number of polonies, e.g., less than 5% or 10% of the total number of polonies, the one or more preprocessing steps or other image processing steps on such flow cell images may not be accurate or reliable. As a result, image processing can be erroneous, e.g., color correction, intensity normalization, background subtraction, intensity offset correction, and eventually leads to errors in base calling using the processed images.

The parameter estimation methods herein can be used to improve or remove such image processing steps that generate erroneous results. In some embodiments, such image processing problems can be indirectly solved by obtaining the same image processing results, e.g., processing parameters, using images from different channels that are of higher signal level. In some embodiments, such image processing problems can be indirectly solved using images of the same channel(s) but in a different cycle. The different cycle can be predetermined based on customized threshold. For example, the different cycle can be the rescue cycle. The different cycle can include more than one cycle in which data are of high nucleotide diversity. The different cycle can include one or more cycles that are (1) close to the cycle of inaccurate or unreliable image processing results and (2) of high nucleotide diversity data. For example, if cycle 60 has a failed color correction. Color correction parameters from cycle 59, 58, or 57 can be used as its replacements. Among them, we can randomly pick one cycle that does not fail the color correction or select the closest cycle 59 if it does not fail color correction.

In some embodiments, the parameter estimation methods herein includes an operation of receiving one or more thresholds for image processing results. The thresholds can be different for different image processing results. The threshold can be customized based on various factors including but not limited to: sequencing chemistry, characteristics of the sample(s) being sequenced, and parameters of the optical system. In some embodiments, the parameter estimation methods herein includes an operation of determining whether one or more flow cell images in a first channel of a first flow cycle have satisfied the one or more thresholds or not. In response to determining that at least one of the threshold(s) is not satisfied, the parameter estimation methods herein can initiate an operation of indirectly determining the image processing results of the one or more flow cell images using images from channel(s) different from the first channel in the first flow cycle. Alternatively, in response to determining that at least one of the threshold(s) is not satisfied, the parameter estimation methods herein can initiate an operation of indirectly determining the image processing results of the one or more flow cell images using images from the first channel in one or more rescue cycles. In some embodiments, the parameter estimation methods herein can initiate an operation of indirectly determining the image processing results of the one or more flow cell images using images from all the channels in one or more rescue cycles. The image processing results can be various results that can be derived from processing of the flow cell images. For example, the image processing result can be offsets for image intensities, color correction parameter for different images, normalization parameter for image intensities.

In some embodiments, the parameter estimation methods can be turned on and/or off for different cycles or different channels. For example, it may be turned on only for cycles that include low diversity data without introducing unnecessary delay in determining the image processing results in other cycles with higher diversity data.

In some embodiments, the parameter estimation methods can be performed immediately after the image processing results of the current cycle is generated, e.g., cycle N, while image acquisition and/or image processing of the next cycle is being performed or yet to be performed so that the total sequencing time and primary analysis time can be reduced.

In some embodiments, the parameter estimation methods can be performed using any computer systems or processors disclosed herein, including CPUs and FPGAs.

### Computer Systems

Various embodiments of the methods 500, 2400 may be implemented, for example, using one or more computer systems, such as computer system 400 shown in FIG. 4. One or more computer systems 400 may be used, for example, to implement any of the embodiments discussed herein, as well as combinations and sub-combinations thereof.

Computer system 400 may include one or more hardware processors 404. The hardware processor 404 can be central processing unit (CPU), graphic processing units (GPU), or their combination. Processor 404 may be connected to a bus or communication infrastructure 406.

Computer system 400 may also include user input/output device(s) 403, such as monitors, keyboards, pointing devices, etc., which may communicate with communication infrastructure 406 through user input/output interface(s) 402. The user input/output devices 403 may be coupled to the user interface 124 in FIG. 1.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, vector processing, array processing, etc., as well as cryptography (including brute-force cracking), generating cryptographic hashes or hash sequences, solving partial hash-inversion problems, and/or producing results of other proof-of-work computations for some blockchain-based applications, for example. With capabilities of general-purpose computing on graphics processing units (GPGPU), the GPU may be particularly useful in at least the image recognition and machine learning embodiments described herein.

Additionally, one or more of processors 404 may include a coprocessor or other implementation of logic for accelerating cryptographic calculations or other specialized mathematical functions, including hardware-accelerated cryptographic coprocessors. Such accelerated processors may further include instruction set(s) for acceleration using coprocessors and/or other logic to facilitate such acceleration.

Computer system 400 may also include a data storage device such as a main or primary memory 408, e.g., random access memory (RAM). Main memory 408 may include one or more levels of cache. Main memory 408 may have stored therein control logic (i.e., computer software) and/or data.

Computer system 400 may also include one or more secondary data storage devices or secondary memory 410. Secondary memory 410 may include, for example, a main storage drive 412 and/or a removable storage device or drive 414. Main storage drive 412 may be a hard disk drive or solid-state drive, for example. Removable storage drive 414 may be a floppy disk drive, a magnetic tape drive, a compact disk drive, an optical storage device, tape backup device, and/or any other storage device/drive.

Removable storage drive 414 may interact with a removable storage unit 418.

Removable storage unit 418 may include a computer usable or readable storage device having stored thereon computer software and/or data. The software can include control logic. The software may include instructions executable by the hardware processor(s) 404. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communication path 426, which may be wired and/or wireless (or a combination thereof), and which may include any combination of LANs, WANs, the Internet, etc. Control logic and/or data may be transmitted to and from computer system 400 via communication path 426. In some embodiments, communication path 426 is the connection to the cloud 130, as depicted in FIG. 1. The external devices, etc. referred to by reference number 428 may be devices, networks, entities, etc. in the cloud 130.

Computer system 400 may also be any of a personal digital assistant (PDA), desktop workstation, laptop or notebook computer, netbook, tablet, smart phone, smart watch or other wearable, appliance, part of the Internet of Things (IoT), and/or embedded system, to name a few non-limiting examples, or any combination thereof.

It should be appreciated that the framework described herein may be implemented as a method, process, apparatus, system, or article of manufacture such as a non-transitory computer-readable medium or device. For illustration purposes, the present framework may be described in the context of distributed ledgers being publicly available, or at least available to untrusted third parties. One example as a modern use case is with blockchain-based systems. It should be appreciated, however, that the present framework may also be applied in other settings where sensitive or confidential information may need to pass by or through hands of untrusted third parties, and that this technology is in no way limited to distributed ledgers or blockchain uses.

Computer system 400 may be a client or server, accessing or hosting any applications and/or data through any delivery paradigm, including but not limited to remote or distributed cloud computing solutions; local or on-premises software (e.g., “on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), database as a service (DBaaS), etc.); and/or a hybrid model including any combination of the foregoing examples or other services or delivery paradigms.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

Any pertinent data, files, and/or databases may be stored, retrieved, accessed, and/or transmitted in human-readable formats such as numeric, textual, graphic, or multimedia formats, further including various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Scala, Clojure, Elixir, Swift, Go, Perl, PHP, Python, Ruby, JavaScript, WebAssembly, or virtually any other language, with any other libraries or schemas, in any kind of framework, runtime environment, virtual machine, interpreter, stack, engine, or similar mechanism, including but not limited to Node.js, V8, Knockout, jQuery, Dojo, Dijit, OpenUI5, AngularJS, Expressjs, Backbone.js, Ember.js, DHTMLX, Vue, React, Electron, and so on, among many other non-limiting examples.

In some embodiments, a tangible, non-transitory apparatus or article of manufacture comprising a tangible, non-transitory computer usable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments may operate with software, hardware, and/or operating system implementations other than those described herein.

### Optical Systems

The imager 116 in FIG. 1 can include one or more optical systems. Further disclosed herein are optical system design guidelines and high-performance fluorescence imaging methods and systems that provide improved optical resolution and image quality for fluorescence imaging-based genomics applications. The disclosed optical imaging system designs provide for larger fields-of-view, increased spatial resolution, improved modulation transfer, contrast-to-noise ratio, and image quality, higher spatial sampling frequency, faster transitions between image capture when repositioning the sample plane to capture a series of images (e.g., of different fields-of-view), and improved imaging system duty cycle, and thus enable higher throughput image acquisition and analysis.

In some instances, improvements in imaging performance, e.g., for dual-side (flow cell) imaging applications, may be achieved by using an electro-optical phase plate in combination with an objective lens to compensate for the optical aberrations induced by the layer of fluid separating the upper (near) and lower (far) interior surfaces of a flow cell. In some instances, this design approach may also compensate for vibrations introduced by, e.g., a motion-actuated compensator that is moved in or out of the optical path depending on which surface of the flow cell is being imaged.

In some instances, improvements in imaging performance, e.g., for dual-side (flow cell) imaging applications comprising the use of thick flow cell walls (e.g., wall (or coverslip) thickness >700 μm) and fluid channels (e.g., fluid channel height or thickness of 50-200 μm) may be achieved even when using commercially-available, off-the-shelf objectives by using a tube lens design that corrects for the optical aberrations induced by the thick flow cell walls and/or intervening fluid layer in combination with the objective.

In some instances, improvements in imaging performance, e.g., for multichannel (e.g., two-color or four-color) imaging applications, may be achieved by using multiple tube lenses, one for each imaging channel, where each tube lens design has been optimized for the specific wavelength range used in that imaging channel.

Example embodiments disclosed herein may comprise fluorescence imaging systems, said systems comprising: a) at least one light source configured to provide excitation light within one or more specified wavelength ranges; b) an objective lens configured to collect fluorescence arising from within a specified field-of-view of a sample plane upon exposure of the sample plane to the excitation light, wherein a numerical aperture of the objective lens is at least 0.1, at least 0.2, at least 0.3, at least 0.4, at least 0.5, at least 0.6, at least 0.7, at least 0.8, or at least 0.9 or a numerical aperture value falling within a range defined by any two of the foregoing; wherein a working distance of the objective lens is at least 400 um, at least 500 um, at least 600 um, at least 700 um, at least 800 um, at least 900 um, at least 1000 um, or a working distance falling within a range defined by any two of the foregoing; and wherein the field-of-view has an area of at least 0.1 mm², at least 0.2 mm², at least 0.5 mm², at least 0.7 mm², at least 1 mm², at least 2 mm², at least 3 mm², at least 5 mm², or at least 10 mm², or a field of view falling within a range defined by any two of the foregoing; and c) at least one image sensor, wherein the fluorescence collected by the objective lens is imaged onto the image sensor, and wherein a pixel dimension for the image sensor is chosen such that a spatial sampling frequency for the fluorescence imaging system is at least twice an optical resolution of the fluorescence imaging system.

In some embodiments, the numerical aperture may be at least 0.75. In some embodiments, the numerical aperture is at least 1.0. In some embodiments, the working distance is at least 850 um. In some embodiments, the working distance is at least 1,000 μm. In some embodiments, the field-of-view may have an area of at least 2.5 mm². In some embodiments, the field-of-view may have an area of at least 3 mm². In some embodiments, the spatial sampling frequency may be at least 2.5 times the optical resolution of the fluorescence imaging system. In some embodiments, the spatial sampling frequency may be at least 3 times the optical resolution of the fluorescence imaging system. In some embodiments, the system may further comprise an X—Y—Z translation stage such that the system is configured to acquire a series of two or more fluorescence images in an automated fashion, wherein each image of the series is or can be acquired for a different field-of-view. In some embodiments, a position of the sample plane may be simultaneously adjusted in an X direction, a Y direction, and a Z direction to match the position of an objective lens focal plane in between acquiring images for different fields-of-view. In some embodiments, the time required for the simultaneous adjustments in the X direction, Y direction, and Z direction may be less than 0.3 seconds, less than 0.4 seconds, less than 0.5 seconds, less than 0.7 seconds, or less than 1 second, or a time falling within a range defined by any two of the foregoing. In some embodiments, the system further comprises an autofocus mechanism configured to adjust the focal plane position prior to acquiring an image of a different field-of-view if an error signal indicates that a difference in the position of the focal plane and the sample plane in the Z direction is greater than a specified error threshold. In some embodiments, the specified error threshold is 100 nm or greater. In some embodiments, the specified error threshold is 50 nm or less. In some embodiments, the system comprises three or more image sensors, and wherein the system is configured to image fluorescence in each of three or more wavelength ranges onto a different image sensor. In some embodiments, a difference in the position of a focal plane for each of the three or more image sensors and the sample plane is less than 100 nm. In some embodiments, a difference in the position of a focal plane for each of the three or more image sensors and the sample plane is less than 50 nm. In some embodiments, the total time required to reposition the sample plane, adjust focus if necessary, and acquire an image is less than 0.4 seconds per field-of-view. In some embodiments, the total time required to reposition the sample plane, adjust focus if necessary, and acquire an image is less than 0.3 seconds per field-of-view.

Also discloser herein are fluorescence imaging systems for dual-side imaging of a flow cell comprising: a) an objective lens configured to collect fluorescence arising from within a specified field-of-view of a sample plane within the flow cell; b) at least one tube lens positioned between the objective lens and at least one image sensor, wherein the at least one tube lens is configured to correct an imaging performance metric for a combination of the objective lens, the at least one tube lens, and the at least one image sensor when imaging an interior surface of the flow cell, and wherein the flow cell has a wall thickness of at least 700 μm and a gap between an upper interior surface and a lower interior surface of at least 50 μm; wherein the imaging performance metric is substantially the same for imaging the upper interior surface or the lower interior surface of the flow cell without moving an optical compensator into or out of an optical path between the flow cell and the at least one image sensor, without moving one or more optical elements of the tube lens along the optical path, and without moving one or more optical elements of the tube lens into or out of the optical path.

In some embodiments, the objective lens may be a commercially-available microscope objective. In some embodiments, the commercially-available microscope objective may have a numerical aperture of at least 0.3. In some embodiments, the objective lens may have a working distance of at least 700 μm. In some embodiments, the objective lens may be corrected to compensate for a cover slip thickness (or flow cell wall thickness) of 0.17 mm or of greater or lesser thickness than 0.17 mm. In some embodiments, the optical system may be corrected to compensate for cover slip thickness, flow cell thickness, or distance between desired focal planes. In some embodiments, said correction may be made by inserting a corrective optic, such as a lens or optical assembly into the light path of the optical system. In some embodiments, said correction may be made without inserting a corrective optic, such as a lens or optical assembly into the light path of the optical system. In some embodiments, the fluorescence imaging system may further comprise an electro-optical phase plate positioned adjacent to the objective lens and between the objective lens and the tube lens, wherein the electro-optical phase plate may provide correction for optical aberrations caused by a fluid filling the gap between the upper interior surface and the lower interior surface of the flow cell. In some embodiments, the at least one tube lens may be a compound lens comprising three or more optical components. In some embodiments, the at least one tube lens is a compound lens comprising four optical components, which may comprise one or more of a first asymmetric convex-convex lens, a second convex-plano lens, a third asymmetric concave-concave lens, and a fourth asymmetric convex-concave lens which may be present in the order as listed above, or in any alternate order. In some embodiments, the at least one tube lens is configured to correct an imaging performance metric for a combination of the objective lens, the at least one tube lens, and the at least one image sensor when imaging an interior surface of a flow cell having a wall thickness of at least 1 mm. In some embodiments, the at least one tube lens is configured to correct an imaging performance metric for a combination of the objective lens, the at least one tube lens, and the at least one image sensor when imaging an interior surface of a flow cell having a gap of at least 100 μm. In some embodiments, the at least one tube lens is configured to correct an imaging performance metric for a combination of the objective lens, the at least one tube lens, and the at least one image sensor when imaging an interior surface of a flow cell having a gap of at least 200 μm. In some embodiments, the system comprises a single objective lens, two tube lenses, and two image sensors, and each of the two tube lenses is designed to provide optimal imaging performance at a different fluorescence wavelength. In some embodiments, the system comprises a single objective lens, three tube lenses, and three image sensors, and each of the three tube lenses is designed to provide optimal imaging performance at a different fluorescence wavelength. In some embodiments, the system comprises a single objective lens, four tube lenses, and four image sensors, and each of the four tube lenses is designed to provide optimal imaging performance at a different fluorescence wavelength. In some embodiments, the design of the objective lens or the at least one tube lens is configured to optimize the modulation transfer function in the mid to high spatial frequency range. In some embodiments, the imaging performance metric comprises a measurement of modulation transfer function (MTF) at one or more specified spatial frequencies, defocus, spherical aberration, chromatic aberration, coma, astigmatism, field curvature, image distortion, contrast-to-noise ratio (CNR), or any combination thereof. In some embodiments, the difference in the imaging performance metric for imaging the upper interior surface and the lower interior surface of the flow cell is less than 10%. In some embodiments, the difference in imaging performance metric for imaging the upper interior surface and the lower interior surface of the flow cell is less than 5%. In some embodiments, the use of the at least one tube lens provides for an at least equivalent or better improvement in the imaging performance metric for dual-side imaging compared to that for a conventional system comprising an objective lens, a motion-actuated compensator, and an image sensor. In some embodiments, the use of the at least one tube lens provides for an at least 10% improvement in the imaging performance metric for dual-side imaging compared to that for a conventional system comprising an objective lens, a motion-actuated compensator, and an image sensor.

Disclosed herein are illumination systems for use in imaging-based solid-phase genotyping and sequencing applications, the illumination system comprising: a) a light source; and b) a liquid light-guide configured to collect light emitted by the light source and deliver it to a specified field-of-illumination on a support surface comprising tethered biological macromolecules.

In some embodiments, the illumination system further comprises a condenser lens. In some embodiments, the specified field-of-illumination has an area of at least 2 mm². In some embodiments, the light delivered to the specified field-of-illumination is of uniform intensity across a specified field-of-view for an imaging system used to acquire images of the support surface. In some embodiments, the specified field-of-view has an area of at least 2 mm². In some embodiments, the light delivered to the specified field-of-illumination is of uniform intensity across the specified field-of-view when a coefficient of variation (CV) for light intensity is less than 10%. In some embodiments, the light delivered to the specified field-of-illumination is of uniform intensity across the specified field-of-view when a coefficient of variation (CV) for light intensity is less than 5%. In some embodiments, the light delivered to the specified field-of-illumination has a speckle contrast value of less than 0.1. In some embodiments, the light delivered to the specified field-of-illumination has a speckle contrast value of less than 0.05.

Imaging modules and systems: It will be understood by those of skill in the art that the disclosed optical systems, imaging systems, or modules may, in some instances, be stand-alone optical systems designed for imaging a sample or substrate surface. In some instances, they may comprise one or more processors or computers. In some instances, they may comprise one or more software packages that provide instrument control functionality and/or image processing functionality. In some instances, in addition to optical components such as light sources (e.g., solid-state lasers, dye lasers, diode lasers, arc lamps, tungsten-halogen lamps, etc.), lenses, prisms, mirrors, dichroic reflectors, optical filters, optical bandpass filters, apertures, and image sensors (e.g., complementary metal oxide semiconductor (CMOS) image sensors and cameras, charge-coupled device (CCD) image sensors and cameras, etc.), they may also include mechanical and/or optomechanical components, such as an X—Y translation stage, an X—Y—Z translation stage, a piezoelectic focusing mechanism, and the like. In some instances, they may function as modules, components, sub-assemblies, or sub-systems of larger systems designed for genomics applications (e.g., genetic testing and/or nucleic acid sequencing applications). For example, in some instances, they may function as modules, components, sub-assemblies, or sub-systems of larger systems that further comprise light-tight and/or other environmental control housings, temperature control modules, fluidics control modules, fluid dispensing robotics, pick-and-place robotics, one or more processors or computers, one or more local and/or cloud-based software packages (e.g., instrument/system control software packages, image processing software packages, data analysis software packages), data storage modules, data communication modules (e.g., Bluetooth, WiFi, intranet, or internet communication hardware and associated software), display modules, or any combination thereof.

### Methods for Sequencing

The present disclosure provides methods for sequencing immobilized or non-immobilized template molecules. The methods can be operated in system 100, for example, in sequencer 114. In some embodiments, the immobilized template molecules comprise a plurality of nucleic acid template molecules having one copy of a target sequence of interest. In some embodiments, nucleic acid template molecules having one copy of a target sequence of interest can be generated by conducting bridge amplification using linear library molecules. In some embodiments, the immobilized template molecules comprise a plurality of nucleic acid template molecules each having two or more tandem copies of a target sequence of interest (e.g., concatemers). In some embodiments, nucleic acid template molecules comprising concatemer molecules can be generated by conducting rolling circle amplification of circularized linear library molecules. In some embodiments, the non-immobilized template molecules comprise circular molecules. In some embodiments, methods for sequencing employ soluble (e.g., non-immobilized) sequencing polymerases or sequencing polymerases that are immobilized to a support.

In some embodiments, the sequencing reactions employ detectably labeled nucleotide analogs. In some embodiments, the sequencing reactions employ a two-stage sequencing reaction comprising binding detectably labeled multivalent molecules, and incorporating nucleotide analogs. In some embodiments, the sequencing reactions employ non-labeled nucleotide analogs. In some embodiments, the sequencing reactions employ phosphate chain labeled nucleotides.

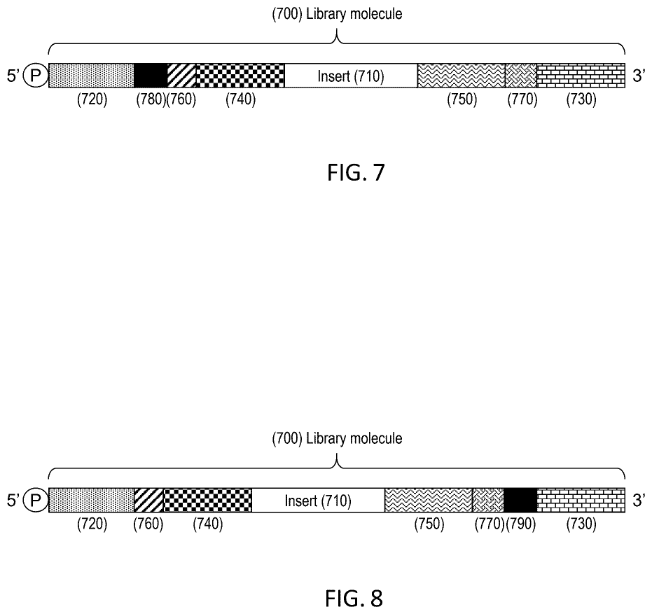

In some embodiments, the immobilized concatemers each comprise tandem repeat units of the sequence-of-interest (e.g., insert region) and any adaptor sequences. For example, the tandem repeat unit comprises: (i) a left universal adaptor sequence having a binding sequence for a first surface primer (720) (e.g., surface pinning primer), (ii) a left universal adaptor sequence having a binding sequence for a first sequencing primer (740) (e.g., forward sequencing primer), (iii) a sequence-of-interest (710), (iv) a right universal adaptor sequence having a binding sequence for a second sequencing primer (750) (e.g., reverse sequencing primer), (v) a right universal adaptor sequence having a binding sequence for a second surface primer (730) (e.g., surface capture primer), and (vii) a left sample index sequence (760) and/or a right sample index sequence (770). In some embodiments, the tandem repeat unit further comprises a left unique identification sequence (780) and/or a right unique identification sequence (790). In some embodiments, the tandem repeat unit further comprises at least one binding sequence for a compaction oligonucleotide. In some embodiments, FIGS. 7 and 8 show linear library molecules or a unit of a concatemer molecule.

Specifically, FIG. 7 is a schematic showing an example linear single stranded library molecule, according to some embodiments. The linear library molecule may a surface pinning primer binding site (720); an optional left unique identification sequence (780); a left index sequence (760); a forward sequencing primer binding site (740); an insert region having a sequence of interest (710); reverse sequencing primer binding site (750); a right index sequence (770); and a surface capture primer binding site (730).

FIG. 8 is a schematic showing an example linear single stranded library molecule, according to some embodiments. The linear library molecule may comprise: a surface pinning primer binding site (720); a left index sequence (760); a forward sequencing primer binding site (740); an insert region having a sequence of interest (710); a reverse sequencing primer binding site (750); a right index sequence (770); an optional right unique identification sequence (790); and a surface capture primer binding site (730).

The immobilized concatemer can self-collapse into a compact nucleic acid nanoball. Inclusion of one or more compaction oligonucleotides during the RCA reaction can further compact the size and/or shape of the nanoball. An increase in the number of tandem repeat units in a given concatemer increases the number of sites along the concatemer for hybridizing to multiple sequencing primers (e.g., sequencing primers having a universal sequence) which serve as multiple initiation sites for polymerase-catalyzed sequencing reactions. When the sequencing reaction employs detectably labeled nucleotides and/or detectably labeled multivalent molecules (e.g., having nucleotide units), the signals emitted by the nucleotides or nucleotide units that participate in the parallel sequencing reactions along the concatemer yields an increased signal intensity for each concatemer. Multiple portions of a given concatemer can be simultaneously sequenced. Furthermore, a plurality of binding complexes can form along a particular concatemer molecule, each binding complex comprising a sequencing polymerase bound to a template/primer duplex and bound to a multivalent molecule, wherein the plurality of binding complexes remain stable without dissociation resulting in increased persistence time which increases signal intensity and reduces imaging time.

### Methods for Sequencing Using Nucleotide Analogs

Embodiments of the present disclosure provide methods for sequencing any of the immobilized template molecules described herein, the methods comprising step (a): contacting a sequencing polymerase to (i) a nucleic acid template molecule and (ii) a nucleic acid sequencing primer, wherein the contacting is conducted under a condition suitable to bind the sequencing polymerase to the nucleic acid template molecule which is hybridized to the nucleic acid primer, wherein the nucleic acid template molecule hybridized to the nucleic acid primer forms the nucleic acid duplex. In some embodiments, the sequencing polymerase comprises a recombinant mutant sequencing polymerase that can bind and incorporate nucleotide analogs.

In some embodiments, in the methods for sequencing template molecules, the sequencing primer comprises a 3′ extendible end or a 3′ non-extendible end. In some embodiments, the plurality of nucleic acid template molecules comprise amplified template molecules (e.g., clonally amplified template molecules). In some embodiments, the plurality of nucleic acid template molecules comprise one copy of a target sequence of interest. In some embodiments, the plurality of nucleic acid molecules comprise two or more tandem copies of a target sequence of interest (e.g., concatemers). In some embodiments, the plurality of nucleic acid template molecules comprise the same target sequence of interest or different target sequences of interest. In some embodiments, the plurality of nucleic acid primers are in solution or are immobilized to a support. In some embodiments, when the plurality of nucleic acid template molecules and/or the plurality of nucleic acid primers are immobilized to a support, the binding with the first sequencing polymerase generates a plurality of immobilized first complexed polymerases. In some embodiments, the plurality of nucleic acid template molecules and/or nucleic acid primers are immobilized to 10²-10¹⁵ different sites on a support. In some embodiments, the binding of the plurality of template molecules and nucleic acid primers with the plurality of first sequencing polymerases generates a plurality of first complexed polymerases immobilized to 10²-10¹⁵ different sites on the support. In some embodiments, the plurality of immobilized first complexed polymerases on the support are immobilized to pre-determined or to random sites on the support. In some embodiments, the plurality of immobilized first complexed polymerases are in fluid communication with each other to permit flowing a solution of reagents (e.g., enzymes including sequencing polymerases, multivalent molecules, nucleotides, and/or divalent cations) onto the support so that the plurality of immobilized complexed polymerases on the support are reacted with the solution of reagents in a massively parallel manner.

In some embodiments, the methods for sequencing further comprise step (b): contacting the sequencing polymerase with a plurality of nucleotides under a condition suitable for binding at least one nucleotide to the sequencing polymerase which is bound to the nucleic acid duplex and suitable for polymerase-catalyzed nucleotide incorporation which extends the sequencing primer by one nucleotide. In some embodiments, the sequencing polymerase is contacted with the plurality of nucleotides in the presence of at least one catalytic cation comprising magnesium and/or manganese. In some embodiments, the plurality of nucleotides comprises at least one nucleotide analog having a chain terminating moiety at the sugar 2′ or 3′ position. In some embodiments, the chain terminating moiety is removable from the sugar 2′ or 3′ position to convert the chain terminating moiety to an OH or H group. In some embodiments, the plurality of nucleotides comprises at least one nucleotide that lacks a chain terminating moiety. In some embodiments, at least one nucleotide is labeled with a detectable reporter moiety (e.g., fluorophore) that emits a detectable signal. The detectable reporter moiety comprises a fluorophore. In some embodiments, the fluorophore is attached to the nucleo-base. In some embodiments, the fluorophore is attached to the nucleo-base with a linker which is cleavable/removable from the base. In some embodiments, at least one of the nucleotides in the plurality is not labeled with a detectable reporter moiety. In some embodiments, a particular detectable reporter moiety (e.g., fluorophore) that is attached to the nucleotide can correspond to the nucleotide base (e.g., dATP, dGTP, dCTP, dTTP or dUTP) to permit detection and identification of the nucleo-base. When the incorporated chain terminating nucleotide is detectably labeled, step (b) further comprises detecting the emitted signal from the incorporated chain terminating nucleotide. In some embodiments, step (b) further comprises identifying the nucleo-based of the incorporated chain terminating nucleotide.

In some embodiments, the methods for sequencing further comprise step (c): removing the chain terminating moiety from the incorporated chain terminating nucleotide to generate an extendible 3′OH group. In some embodiments, step (c) further comprises removing the detectable label from the incorporated chain terminating nucleotide. In some embodiments, the sequencing polymerase remains bound to the template molecule which is hybridized to the sequencing primer which is extended by one nucleo-base.

In some embodiments, the methods for sequencing further comprise step (d): repeating steps (b) and (c) at least once.

### Two-Stage Methods for Nucleic Acid Sequencing

Embodiments of the present disclosure provide a two-stage method for sequencing any of the immobilized template molecules described herein. In some embodiments, the first stage generally comprises binding multivalent molecules to complexed polymerases to form multivalent-complexed polymerases, and detecting the multivalent-complexed polymerases.

In some embodiments, the first stage comprises step (a): contacting a plurality of a first sequencing polymerase to (i) a plurality of nucleic acid template molecules and (ii) a plurality of nucleic acid sequencing primers, wherein the contacting is conducted under a condition suitable to bind the plurality of first sequencing polymerases to the plurality of nucleic acid template molecules and the plurality of nucleic acid primers thereby forming a plurality of first complexed polymerases each comprising a first sequencing polymerase bound to a nucleic acid duplex wherein the nucleic acid duplex comprises a nucleic acid template molecule hybridized to a nucleic acid primer. In some embodiments, the first polymerase comprises a recombinant mutant sequencing polymerase.

In some embodiments, in the methods for sequencing template molecules, the sequencing primer comprises an oligonucleotide having a 3′ extendible end or a 3′ non-extendible end. In some embodiments, the plurality of nucleic acid template molecules comprise amplified template molecules (e.g., clonally amplified template molecules). In some embodiments, the plurality of nucleic acid template molecules comprise one copy of a target sequence of interest. In some embodiments, the plurality of nucleic acid molecules comprise two or more tandem copies of a target sequence of interest (e.g., concatemers). In some embodiments, the nucleic acid template molecules in the plurality of nucleic acid template molecules comprise the same target sequence of interest or different target sequences of interest. In some embodiments, the plurality of nucleic acid template molecules and/or the plurality of nucleic acid primers are in solution or are immobilized to a support. In some embodiments, when the plurality of nucleic acid template molecules and/or the plurality of nucleic acid primers are immobilized to a support, the binding with the first sequencing polymerase generates a plurality of immobilized first complexed polymerases. In some embodiments, the plurality of nucleic acid template molecules and/or nucleic acid primers are immobilized to 10²-10¹⁵ different sites on a support. In some embodiments, the binding of the plurality of template molecules and nucleic acid primers with the plurality of first sequencing polymerases generates a plurality of first complexed polymerases immobilized to 10²-10¹⁵ different sites on the support. In some embodiments, the plurality of immobilized first complexed polymerases on the support are immobilized to pre-determined or to random sites on the support. In some embodiments, the plurality of immobilized first complexed polymerases are in fluid communication with each other to permit flowing a solution of reagents (e.g., enzymes including sequencing polymerases, multivalent molecules, nucleotides, and/or divalent cations) onto the support so that the plurality of immobilized complexed polymerases on the support are reacted with the solution of reagents in a massively parallel manner.

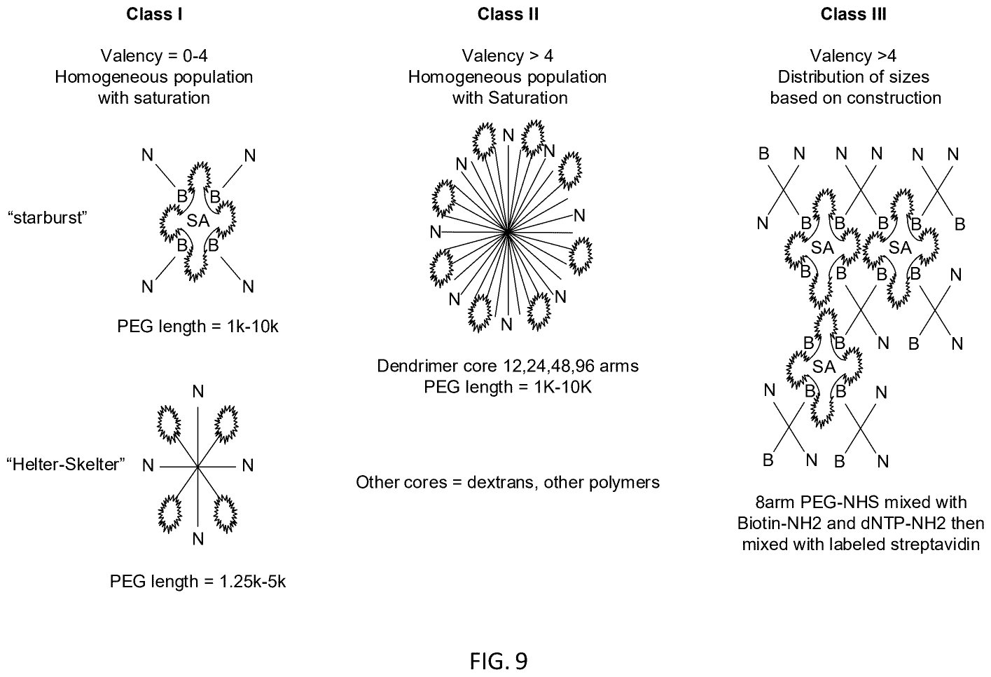

In some embodiments, the methods for sequencing further comprise step (b): contacting the plurality of first complexed polymerases with a plurality of multivalent molecules to form a plurality of multivalent-complexed polymerases (e.g., binding complexes). In some embodiments, individual multivalent molecules in the plurality of multivalent molecules comprise a core attached to multiple nucleotide arms and each nucleotide arm is attached to a nucleotide (e.g., nucleotide unit) (e.g., FIGS. 9-13). In some embodiments, the contacting of step (b) is conducted under a condition suitable for binding complementary nucleotide units of the multivalent molecules to at least two of the plurality of first complexed polymerases thereby forming a plurality of multivalent-complexed polymerases. In some embodiments, the condition is suitable for inhibiting polymerase-catalyzed incorporation of the complementary nucleotide units into the primers of the plurality of multivalent-complexed polymerases. In some embodiments, the plurality of multivalent molecules comprise at least one multivalent molecule having multiple nucleotide arms (e.g., FIGS. 9-12) each attached with a nucleotide analog (e.g., nucleotide analog unit), where the nucleotide analog includes a chain terminating moiety at the sugar 2′ and/or 3′ position. In some embodiments, the plurality of multivalent molecules comprises at least one multivalent molecule comprising multiple nucleotide arms each attached with a nucleotide unit that lacks a chain terminating moiety. In some embodiments, at least one of the multivalent molecules in the plurality of multivalent molecules is labeled with a detectable reporter moiety that emits a signal. In some embodiments, the detectable reporter moiety comprises a fluorophore. In some embodiments, the contacting of step (b) is conducted in the presence of at least one non-catalytic cation comprising strontium, barium and/or calcium.

In some embodiments, the methods for sequencing further comprise step (c): detecting the plurality of multivalent-complexed polymerases. In some embodiments, the detecting includes detecting the signals emitted by the multivalent molecules that are bound to the complexed polymerases, where the complementary nucleotide units of the multivalent molecules are bound to the primers but incorporation of the complementary nucleotide units is inhibited. In some embodiments, the multivalent molecules are labeled with a detectable reporter moiety to permit detection. In some embodiments, the labeled multivalent molecules comprise a fluorophore attached to the core, linker and/or nucleotide unit of the multivalent molecules.

In some embodiments, the methods for sequencing further comprise step (d): identifying the nucleo-base of the complementary nucleotide units that are bound to the plurality of first complexed polymerases, thereby determining the sequence of the template molecule. In some embodiments, the multivalent molecules are labeled with a detectable reporter moiety that corresponds to the particular nucleotide units attached to the nucleotide arms to permit identification of the complementary nucleotide units (e.g., nucleotide base adenine, guanine, cytosine, thymine or uracil) that are bound to the plurality of first complexed polymerases.

In some embodiments, the methods for sequencing further comprise step (e): dissociating the plurality of multivalent-complexed polymerases and removing the plurality of first sequencing polymerases and their bound multivalent molecules, and retaining the plurality of nucleic acid duplexes.

In some embodiments, the second stage of the two-stage sequencing method generally comprises nucleotide incorporation. In some embodiments, the methods for sequencing further comprises step (f): contacting the plurality of the retained nucleic acid duplexes of step (e) with a plurality of second sequencing polymerases, wherein the contacting is conducted under a condition suitable for binding the plurality of second sequencing polymerases to the plurality of the retained nucleic acid duplexes, thereby forming a plurality of second complexed polymerases each comprising a second sequencing polymerase bound to a nucleic acid duplex. In some embodiments, the second sequencing polymerase comprises a recombinant mutant sequencing polymerase.

In some embodiments, the plurality of first sequencing polymerases of step (a) have an amino acid sequence that is 100% identical to the amino acid sequence as the plurality of the second sequencing polymerases of step (f). In some embodiments, the plurality of first sequencing polymerases of step (a) have an amino acid sequence that differs from the amino acid sequence of the plurality of the second sequencing polymerases of step (f).

In some embodiments, the methods for sequencing further comprise step (g): contacting the plurality of second complexed polymerases with a plurality of nucleotides, wherein the contacting is conducted under a condition suitable for binding complementary nucleotides from the plurality of nucleotides to at least two of the second complexed polymerases thereby forming a plurality of nucleotide-complexed polymerases. In some embodiments, the contacting of step (g) is conducted under a condition that is suitable for promoting polymerase-catalyzed incorporation of the bound complementary nucleotides into the primers of the nucleotide-complexed polymerases thereby extending the sequencing primer by one nucleo-base. In some embodiments, the incorporating the nucleotide into the 3′ end of the sequencing primer in step (g) comprises a primer extension reaction. In some embodiments, the contacting of step (g) is conducted in the presence of at least one catalytic cation comprising magnesium and/or manganese. In some embodiments, the plurality of nucleotides comprise native nucleotides (e.g., non-analog nucleotides) or nucleotide analogs. In some embodiments, the plurality of nucleotides comprise a 2′ and/or 3′ chain terminating moiety which is removable or is not removable. In some embodiments, at least one of the nucleotides in the plurality is not labeled with a detectable reporter moiety. In some embodiments, the plurality of nucleotides are non-labeled. In some embodiments, the plurality of nucleotides comprises a plurality of nucleotides labeled with detectable reporter moiety. The detectable reporter moiety comprises a fluorophore. In some embodiments, the fluorophore is attached to the nucleotide base. In some embodiments, the fluorophore is attached to the nucleotide base with a linker which is cleavable/removable from the base or is not removable from the base. In some embodiments, a particular detectable reporter moiety (e.g., fluorophore) that is attached to the nucleotide can correspond to the nucleotide base (e.g., dATP, dGTP, dCTP, dTTP or dUTP) to permit detection and identification of the nucleotide base.

In some embodiments, when the plurality of nucleotides in step (g) are detectably labeled, the methods for sequencing further comprise step (h): detecting the complementary nucleotides which are incorporated into the primers of the nucleotide-complexed polymerases. In some embodiments, the plurality of nucleotides are labeled with a detectable reporter moiety to permit detection. In some embodiments, when the plurality of nucleotides in step (g) are non-labeled, the detecting of step (h) is omitted.

In some embodiments, when the plurality of nucleotides in step (g) are detectably labeled, the methods for sequencing further comprise step (i): identifying the bases of the complementary nucleotides which are incorporated into the primers of the nucleotide-complexed polymerases. In some embodiments, the identification of the incorporated complementary nucleotides in step (i) can be used to confirm the identity of the complementary nucleotides of the multivalent molecules that are bound to the plurality of first complexed polymerases in step (d). In some embodiments, the identifying of step (i) can be used to determine the sequence of the nucleic acid template molecules. In some embodiments, when the plurality of nucleotides in step (g) are non-labeled, the identifying of step (i) is omitted.

In some embodiments, the methods for sequencing further comprise step (j): removing the chain terminating moiety from the incorporated nucleotide when step (g) is conducted by contacting the plurality of second complexed polymerases with a plurality of nucleotides that comprise at least one nucleotide having a 2′ and/or 3′ chain terminating moiety.

In some embodiments, the methods for sequencing further comprise step (k): repeating steps (a)-(j) at least once. In some embodiments, the sequence of the nucleic acid template molecules can be determined by detecting and identifying the multivalent molecules that bind the sequencing polymerases but do not incorporate into the 3′ end of the primer at steps (c) and (d). In some embodiments, the sequence of the nucleic acid template molecule can be determined (or confirmed) by detecting and identifying the nucleotide that incorporates into the 3′ end of the primer at steps (h) and (i).

In some embodiments, in any of the methods for sequencing nucleic acid molecules, the binding of the plurality of first complexed polymerases with the plurality of multivalent molecules forms at least one avidity complex, the method comprising the steps: (a) binding a first nucleic acid primer, a first sequencing polymerase, and a first multivalent molecule to a first portion of a concatemer template molecule thereby forming a first binding complex, wherein a first nucleotide unit of the first multivalent molecule binds to the first sequencing polymerase; and (b) binding a second nucleic acid primer, a second sequencing polymerase, and the first multivalent molecule to a second portion of the same concatemer template molecule thereby forming a second binding complex, wherein a second nucleotide unit of the first multivalent molecule binds to the second sequencing polymerase, wherein the first and second binding complexes which include the same multivalent molecule forms an avidity complex. In some embodiments, the first sequencing polymerase comprises any wild type or mutant polymerase described herein. In some embodiments, the second sequencing polymerase comprises any wild type or mutant polymerase described herein. The concatemer template molecule comprises tandem repeat sequences of a sequence of interest and at least one universal sequencing primer binding site. The first and second nucleic acid primers can bind to a sequencing primer binding site along the concatemer template molecule. Example multivalent molecules are shown in FIGS. 9-12.

In some embodiments, in any of the methods for sequencing nucleic acid molecules, wherein the method includes binding the plurality of first complexed polymerases with the plurality of multivalent molecules to form at least one avidity complex, the method comprising the steps: (a) contacting the plurality of sequencing polymerases and the plurality of nucleic acid primers with different portions of a concatemer nucleic acid concatemer molecule to form at least first and second complexed polymerases on the same concatemer template molecule; (b) contacting a plurality of multivalent molecules to the at least first and second complexed polymerases on the same concatemer template molecule, under conditions suitable to bind a single multivalent molecule from the plurality to the first and second complexed polymerases, wherein at least a first nucleotide unit of the single multivalent molecule is bound to the first complexed polymerase which includes a first primer hybridized to a first portion of the concatemer template molecule thereby forming a first binding complex (e.g., first ternary complex), and wherein at least a second nucleotide unit of the single multivalent molecule is bound to the second complexed polymerase which includes a second primer hybridized to a second portion of the concatemer template molecule thereby forming a second binding complex (e.g., second ternary complex), wherein the contacting is conducted under a condition suitable to inhibit polymerase-catalyzed incorporation of the bound first and second nucleotide units in the first and second binding complexes, and wherein the first and second binding complexes which are bound to the same multivalent molecule forms an avidity complex; and (c) detecting the first and second binding complexes on the same concatemer template molecule, and (d) identifying the first nucleotide unit in the first binding complex thereby determining the sequence of the first portion of the concatemer template molecule, and identifying the second nucleotide unit in the second binding complex thereby determining the sequence of the second portion of the concatemer template molecule. In some embodiments, the plurality of sequencing polymerases comprise any wild type or mutant sequencing polymerase described herein. The concatemer template molecule comprises tandem repeat sequences of a sequence of interest and at least one universal sequencing primer binding site. The plurality of nucleic acid primers can bind to a sequencing primer binding site along the concatemer template molecule. Example multivalent molecules are shown in FIGS. 9-12.

### Sequencing-by-Binding

Embodiments of the present disclosure provide methods for sequencing any of the immobilized template molecules described herein, wherein the sequencing methods comprise a sequencing-by-binding (SBB) procedure which employs non-labeled chain-terminating nucleotides. In some embodiments, the sequencing-by-binding (SBB) method comprises the steps of (a) sequentially contacting a primed template nucleic acid with at least two separate mixtures under ternary complex stabilizing conditions, wherein the at least two separate mixtures each include a polymerase and a nucleotide, whereby the sequentially contacting results in the primed template nucleic acid being contacted, under the ternary complex stabilizing conditions, with nucleotide cognates for first, second and third base type base types in the template; (b) examining the at least two separate mixtures to determine whether a ternary complex formed; and (c) identifying the next correct nucleotide for the primed template nucleic acid molecule, wherein the next correct nucleotide is identified as a cognate of the first, second or third base type if ternary complex is detected in step (b), and wherein the next correct nucleotide is imputed to be a nucleotide cognate of a fourth base type based on the absence of a ternary complex in step (b); (d) adding a next correct nucleotide to the primer of the primed template nucleic acid after step (b), thereby producing an extended primer; and (e) repeating steps (a) through (d) at least once on the primed template nucleic acid that comprises the extended primer. Example sequencing-by-binding methods are described in U.S. Pat. Nos. 10,246,744 and 10,731,141 (where the contents of both patents are hereby incorporated by reference in their entireties).

### Methods for Sequencing Using Phosphate-Chain Labeled Nucleotides

Embodiments of present disclosure provide methods for sequencing using immobilized sequencing polymerases which bind non-immobilized template molecules, wherein the sequencing reactions are conducted with phosphate-chain labeled nucleotides. In some embodiments, the sequencing methods comprise step (a): providing a support having a plurality of sequencing polymerases immobilized thereon. In some embodiments, the sequencing polymerase comprises a processive DNA polymerase. In some embodiments, the sequencing polymerase comprises a wild type or mutant DNA polymerase, including for example a Phi29 DNA polymerase. In some embodiments, the support comprise a plurality of separate compartments and a sequencing polymerase is immobilized to the bottom of a compartment. In some embodiments, the separate compartments comprise a silica bottom through which light can penetrate. In some embodiments, the separate compartments comprise a silica bottom configured with a nanophotonic confinement structure comprising a hole in a metal cladding film (e.g., aluminum cladding film). In some embodiments, the hole in the metal cladding has a small aperture, for example, approximately 70 nm. In some embodiments, the height of the nanophotonic confinement structure is approximately 100 nm. In some embodiments, the nanophotonic confinement structure comprises a zero mode waveguide (ZMW). In some embodiments, the nanophotonic confinement structure contains a liquid.

In some embodiments, the sequencing method further comprises step (b): contacting the plurality of immobilized sequencing polymerases with a plurality of single stranded circular nucleic acid template molecules and a plurality of oligonucleotide sequencing primers, under a condition suitable for individual immobilized sequencing polymerases to bind a single stranded circular template molecule, and suitable for individual sequencing primers to hybridize to individual single stranded circular template molecules, thereby generating a plurality of polymerase/template/primer complexes. In some embodiments, the individual sequencing primers hybridize to a universal sequencing primer binding site on the single stranded circular template molecule.

In some embodiments, the sequencing method further comprises step (c): contacting the plurality of polymerase/template/primer complexes with a plurality of phosphate chain labeled nucleotides each comprising an aromatic base, a five carbon sugar (e.g., ribose or deoxyribose), and phosphate chain comprising 3-20 phosphate groups, where the terminal phosphate group is linked to a detectable reporter moiety (e.g., a fluorophore). The first, second and third phosphate groups can be referred to as alpha, beta and gamma phosphate groups. In some embodiments, a particular detectable reporter moiety which is attached to the terminal phosphate group corresponds to the nucleotide base (e.g., dATP, dGTP, dCTP, dTTP or dUTP) to permit detection and identification of the nucleo-base. In some embodiments, the plurality of polymerase/template/primer complexes are contacted with the plurality of phosphate chain labeled nucleotides under a condition suitable for polymerase-catalyzed nucleotide incorporation. In some embodiments, the sequencing polymerases are capable of binding a complementary phosphate chain labeled nucleotide and incorporating the complementary nucleotide opposite a nucleotide in a template molecule. In some embodiment, the polymerase-catalyzed nucleotide incorporation reaction cleaves between the alpha and beta phosphate groups thereby releasing a multi-phosphate chain linked to a fluorophore.

In some embodiments, the sequencing method further comprises step (d): detecting the fluorescent signal emitted by the phosphate chain labeled nucleotide that is bound by the sequencing polymerase, and incorporated into the terminal end of the sequencing primer. In some embodiments, step (d) further comprises identifying the phosphate chain labeled nucleotide that is bound by the sequencing polymerase, and incorporated into the terminal end of the sequencing primer.

In some embodiments, the sequencing method further comprises step (d): repeating steps (c)-(d) at least once. In some embodiments, sequencing methods that employ phosphate chain labeled nucleotides can be conducted according to the methods described in U.S. Pat. Nos. 7,170,050; 7,302,146; and/or 7,405,281.

### Sequencing Polymerases

Embodiments of the present disclosure provide methods for sequencing nucleic acid molecules, where any of the sequencing methods described herein employ at least one type of sequencing polymerase and a plurality of nucleotides, or employ at least one type of sequencing polymerase and a plurality of nucleotides and a plurality of multivalent molecules. In some embodiments, the sequencing polymerase(s) is/are capable of incorporating a complementary nucleotide opposite a nucleotide in a template molecule. In some embodiments, the sequencing polymerase(s) is/are capable of binding a complementary nucleotide unit of a multivalent molecule opposite a nucleotide in a template molecule. In some embodiments, the plurality of sequencing polymerases comprise recombinant mutant polymerases.

Examples of suitable polymerases for use in sequencing with nucleotides and/or multivalent molecules include but are not limited to: Klenow DNA polymerase; Thermus aquaticus DNA polymerase I (Taq polymerase); KlenTaq polymerase; Candidatus altiarchaeales archaeon; Candidatus Hadarchaeum Yellowstonense; Hadesarchaea archaeon; Euryarchaeota archaeon; Thermoplasmata archaeon; Thermococcus polymerases such as Thermococcus litoralis, bacteriophage T7 DNA polymerase; human alpha, delta and epsilon DNA polymerases; bacteriophage polymerases such as T4, RB69 and phi29 bacteriophage DNA polymerases; Pyrococcus furiosus DNA polymerase (Pfu polymerase); Bacillus subtilis DNA polymerase III; E. coli DNA polymerase III alpha and epsilon; 9 degree N polymerase; reverse transcriptases such as HIV type M or O reverse transcriptases; avian myeloblastosis virus reverse transcriptase; Moloney Murine Leukemia Virus (MMLV) reverse transcriptase; or telomerase. Further non-limiting examples of DNA polymerases include those from various Archaea genera, such as, Aeropyrum, Archaeglobus, Desulfurococcus, Pyrobaculum, Pyrococcus, Pyrolobus, Pyrodictium, Staphylothermus, Stetteria, Sulfolobus, Thermococcus, and Vulcanisaeta and the like or variants thereof, including such polymerases as are known in the art such as 9 degrees N, VENT, DEEP VENT, THERMINATOR, Pfu, KOD, Pfx, Tgo and RB69 polymerases.

### Multivalent Molecules

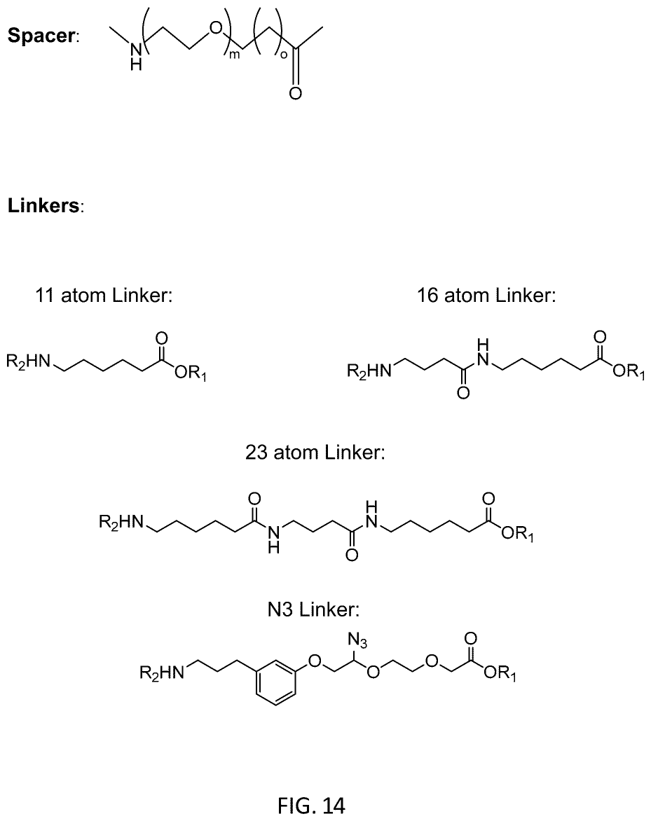

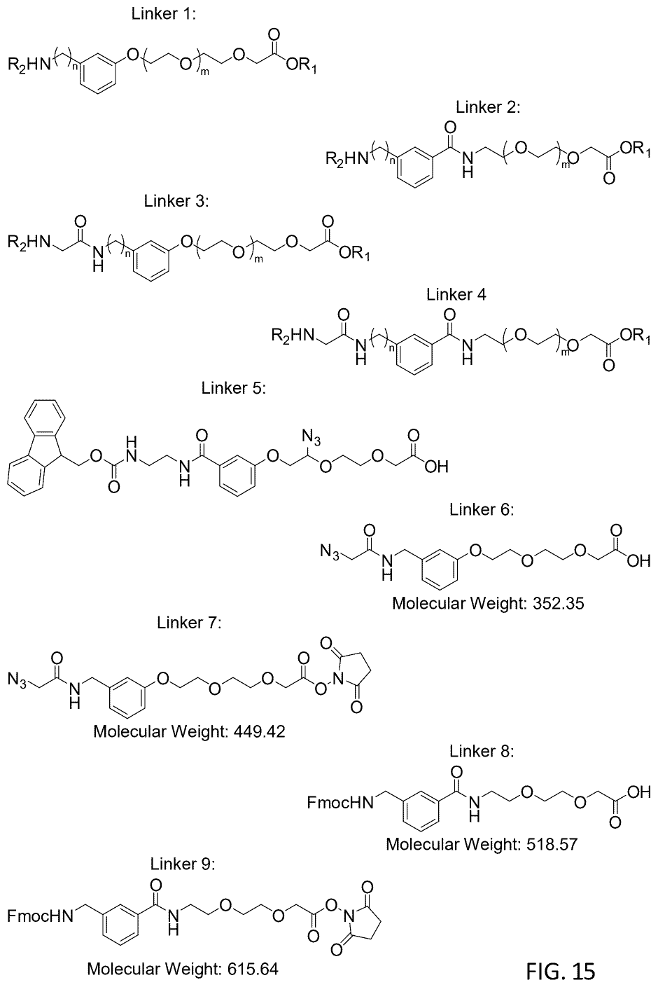

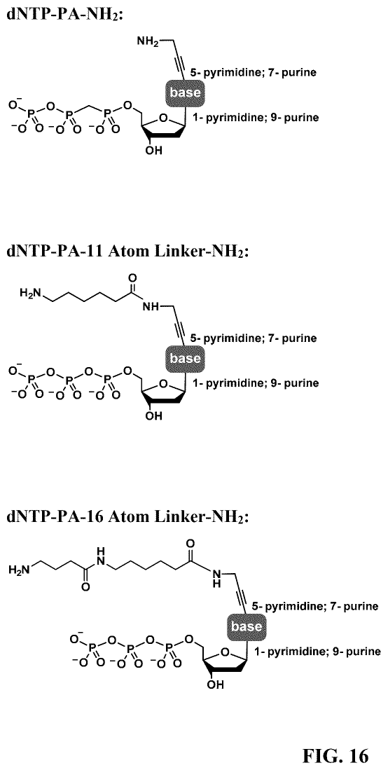

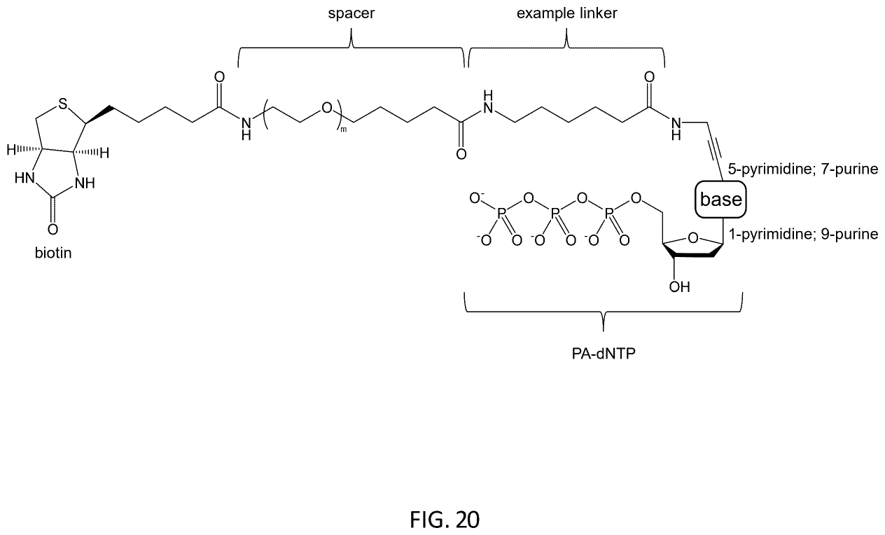

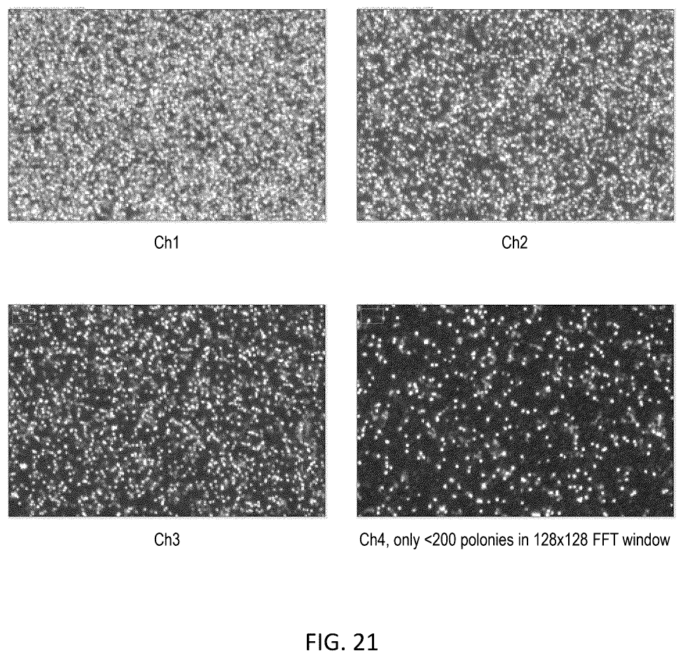

Embodiments of the present disclosure provide methods for sequencing nucleic acid molecules, where any of the sequencing methods described herein employ at least one multivalent molecule. In some embodiments, the multivalent molecule comprises a plurality of nucleotide arms attached to a core and having any configuration including a starburst, helter skelter, or bottle brush configuration (e.g., FIG. 9). The multivalent molecule comprises: (1) a core; and (2) a plurality of nucleotide arms which comprise (i) a core attachment moiety, (ii) a spacer comprising a PEG moiety, (iii) a linker, and (iv) a nucleotide unit, wherein the core is attached to the plurality of nucleotide arms, wherein the spacer is attached to the linker, wherein the linker is attached to the nucleotide unit. In some embodiments, the nucleotide unit comprises a base, sugar and at least one phosphate group, and the linker is attached to the nucleotide unit through the base. In some embodiments, the linker comprises an aliphatic chain or an oligo ethylene glycol chain where both linker chains having 2-6 subunits. In some embodiments, the linker also includes an aromatic moiety. An example nucleotide arm is shown in FIG. 13. Example multivalent molecules are shown in FIGS. 9-12 An example spacer is shown in FIG. 14 (top) and example linkers are shown in FIG. 14 (bottom) and FIG. 15. Example nucleotides attached to a linker are shown in FIGS. 16-19. An example biotinylated nucleotide arm is shown in FIG. 20.

In some embodiments, a multivalent molecule comprises a core attached to multiple nucleotide arms, and wherein the multiple nucleotide arms have the same type of nucleotide unit which is selected from a group consisting of dATP, dGTP, dCTP, dTTP and dUTP.

In some embodiments, a multivalent molecule comprises a core attached to multiple nucleotide arms, where each arm includes a nucleotide unit. The nucleotide unit comprises an aromatic base, a five carbon sugar (e.g., ribose or deoxyribose), and one or more phosphate groups (e.g., 1-10 phosphate groups). The plurality of multivalent molecules can comprise one type multivalent molecule having one type of nucleotide unit selected from a group consisting of dATP, dGTP, dCTP, dTTP and dUTP. The plurality of multivalent molecules can comprise at a mixture of any combination of two or more types of multivalent molecules, where individual multivalent molecules in the mixture comprise nucleotide units selected from a group consisting of dATP, dGTP, dCTP, dTTP and/or dUTP.

In some embodiments, the nucleotide unit comprises a chain of one, two or three phosphorus atoms where the chain is typically attached to the 5′ carbon of the sugar moiety via an ester or phosphoramide linkage. In some embodiments, at least one nucleotide unit is a nucleotide analog having a phosphorus chain in which the phosphorus atoms are linked together with intervening O, S, NH, methylene or ethylene. In some embodiments, the phosphorus atoms in the chain include substituted side groups including O, S or BH₃. In some embodiments, the chain includes phosphate groups substituted with analogs including phosphoramidate, phosphorothioate, phosphordithioate, and O-methylphosphoroamidite groups.

In some embodiments, the multivalent molecule comprises a core attached to multiple nucleotide arms, and wherein individual nucleotide arms comprise a nucleotide unit which is a nucleotide analog having a chain terminating moiety (e.g., blocking moiety) at the sugar 2′ position, at the sugar 3′ position, or at the sugar 2′ and 3′ position. In some embodiments, the nucleotide unit comprises a chain terminating moiety (e.g., blocking moiety) at the sugar 2′ position, at the sugar 3′ position, or at the sugar 2′ and 3′ position. In some embodiments, the chain terminating moiety can inhibit polymerase-catalyzed incorporation of a subsequent nucleotide unit or free nucleotide in a nascent strand during a primer extension reaction. In some embodiments, the chain terminating moiety is attached to 3′ sugar position where the sugar comprises a ribose or deoxyribose sugar moiety. In some embodiments, the chain terminating moiety is removable/cleavable from 3′ sugar position to generate a nucleotide having a 3′OH sugar group which is extendible with a subsequent nucleotide in a polymerase-catalyzed nucleotide incorporation reaction. In some embodiments, the chain terminating moiety comprises an alkyl group, alkenyl group, alkynyl group, allyl group, aryl group, benzyl group, azide group, amine group, amide group, keto group, isocyanate group, phosphate group, thio group, disulfide group, carbonate group, urea group, or silyl group. In some embodiments, the chain terminating moiety is cleavable/removable from the nucleotide unit, for example by reacting the chain terminating moiety with a chemical agent, pH change, light or heat. In some embodiments, the chain terminating moieties alkyl, alkenyl, alkynyl and allyl are cleavable with tetrakis(triphenylphosphine) palladium (0) (Pd(PPh₃)₄) with piperidine, or with 2,3-Dichloro-5,6-dicyano-1,4-benzo-quinone (DDQ). In some embodiments, the chain terminating moieties aryl and benzyl are cleavable with H2 Pd/C. In some embodiments, the chain terminating moieties amine, amide, keto, isocyanate, phosphate, thio, disulfide are cleavable with phosphine or with a thiol group including beta-mercaptoethanol or dithiothritol (DTT). In some embodiments, the chain terminating moiety carbonate is cleavable with potassium carbonate (K₂CO₃) in MeOH, with triethylamine in pyridine, or with Zn in acetic acid (AcOH). In some embodiments, the chain terminating moieties urea and silyl are cleavable with tetrabutylammonium fluoride, pyridine-HF, with ammonium fluoride, or with triethylamine trihydrofluoride.

In some embodiments, the nucleotide unit comprises a chain terminating moiety (e.g., blocking moiety) at the sugar 2′ position, at the sugar 3′ position, or at the sugar 2′ and 3′ position. In some embodiments, the chain terminating moiety comprises an azide, azido or azidomethyl group. In some embodiments, the chain terminating moiety comprises a 3′-O-azido or 3′-O-azidomethyl group. In some embodiments, the chain terminating moieties azide, azido and azidomethyl group are cleavable/removable with a phosphine compound. In some embodiments, the phosphine compound comprises a derivatized tri-alkyl phosphine moiety or a derivatized tri-aryl phosphine moiety. In some embodiments, the phosphine compound comprises Tris(2-carboxyethyl) phosphine (TCEP) or bis-sulfo triphenyl phosphine (BS-TPP) or Tri (hydroxyproyl)phosphine (THPP). In some embodiments, the cleaving agent comprises 4-dimethylaminopyridine (4-DMAP).

In some embodiments, the nucleotide unit comprising a chain terminating moiety which is selected from a group consisting of 3′-deoxy nucleotides, 2′,3′-dideoxynucleotides, 3′-methyl, 3′-azido, 3′-azidomethyl, 3′-O-azidoalkyl, 3′-O-ethynyl, 3′-O-aminoalkyl, 3′-O-fluoroalkyl, 3′-fluoromethyl, 3′-difluoromethyl, 3′-trifluoromethyl, 3′-sulfonyl, 3′-malonyl, 3′-amino, 3′-O-amino, 3′-sulfhydral, 3′-aminomethyl, 3′-ethyl, 3′butyl, 3′-tert butyl, 3′-Fluorenylmethyloxycarbonyl, 3′ tert-Butyloxycarbonyl, 3′-O-alkyl hydroxylamino group, 3′-phosphorothioate, and 3-O-benzyl, or derivatives thereof.

In some embodiments, the multivalent molecule comprises a core attached to multiple nucleotide arms, wherein the nucleotide arms comprise a spacer, linker and nucleotide unit, and wherein the core, linker and/or nucleotide unit is labeled with detectable reporter moiety. In some embodiments, the detectable reporter moiety comprises a fluorophore. In some embodiments, a particular detectable reporter moiety (e.g., fluorophore) that is attached to the multivalent molecule can correspond to the base (e.g., dATP, dGTP, dCTP, dTTP or dUTP) of the nucleotide unit to permit detection and identification of the nucleotide base.

In some embodiments, at least one nucleotide arm of a multivalent molecule has a nucleotide unit that is attached to a detectable reporter moiety. In some embodiments, the detectable reporter moiety is attached to the nucleotide base. In some embodiments, the detectable reporter moiety comprises a fluorophore. In some embodiments, a particular detectable reporter moiety (e.g., fluorophore) that is attached to the multivalent molecule can correspond to the base (e.g., dATP, dGTP, dCTP, dTTP or dUTP) of the nucleotide unit to permit detection and identification of the nucleotide base.

In some embodiments, the core of a multivalent molecule comprises an avidin-like or streptavidin-like moiety and the core attachment moiety comprises biotin. In some embodiments, the core comprises an streptavidin-type or avidin-type moiety which includes an avidin protein, as well as any derivatives, analogs and other non-native forms of avidin that can bind to at least one biotin moiety. Other forms of avidin moieties include native and recombinant avidin and streptavidin as well as derivatized molecules, e.g. non-glycosylated avidin and truncated streptavidins. For example, avidin moiety includes de-glycosylated forms of avidin, bacterial streptavidin produced by Streptomyces (e.g., Streptomyces avidinii), as well as derivatized forms, for example, N-acyl avidins, e.g., N-acetyl, N-phthalyl and N-succinyl avidin, and the commercially-available products EXTRAVIDIN, CAPTAVIDIN, NEUTRAVIDIN and NEUTRALITE AVIDIN.

In some embodiments, any of the methods for sequencing nucleic acid molecules described herein can include forming a binding complex, where the binding complex comprises (i) a polymerase, a nucleic acid template molecule duplexed with a primer, and a nucleotide, or the binding complex comprises (ii) a polymerase, a nucleic acid template molecule duplexed with a primer, and a nucleotide unit of a multivalent molecule. In some embodiments, the binding complex has a persistence time of greater than about 0.1, 0.2, 0.3, 0.4, 0.5, 0.6, 0.7, 0.8, 0.9 or 1 second. The binding complex has a persistence time of greater than about 0.1-0.25 seconds, or about 0.25-0.5 seconds, or about 0.5-0.75 seconds, or about 0.75-1 second, or about 1-2 seconds, or about 2-3 seconds, or about 3-4 second, or about 4-5 seconds, and/or wherein the method is or may be carried out at a temperature of at or above 15° C., at or above 20° C., at or above 25° C., at or above 35° C., at or above 37° C., at or above 42° C. at or above 55° C. at or above 60° C., or at or above 72° C., or at or above 80° C., or within a range defined by any of the foregoing. The binding complex (e.g., ternary complex) remains stable until subjected to a condition that causes dissociation of interactions between any of the polymerase, template molecule, primer and/or the nucleotide unit or the nucleotide. For example, a dissociating condition comprises contacting the binding complex with any one or any combination of a detergent, EDTA and/or water. In some embodiments, the present disclosure provides said method wherein the binding complex is deposited on, attached to, or hybridized to, a surface showing a contrast to noise ratio in the detecting step of greater than 20. In some embodiments, the present disclosure provides said method wherein the contacting is performed under a condition that stabilizes the binding complex when the nucleotide or nucleotide unit is complementary to a next base of the template nucleic acid, and destabilizes the binding complex when the nucleotide or nucleotide unit is not complementary to the next base of the template nucleic acid.

FIG. 9 shows schematics of multivalent molecules having a “starburst” or “helter-skelter” configuration (Left (Class I)); a schematic of a multivalent molecule having a dendrimer configuration (Center (Class II)); and a schematic of multiple multivalent molecules formed by reacting streptavidin with 4-arm or 8-arm PEG-NHS with biotin and dNTPs (Right (Class III)). Nucleotide units are designated ‘N’, biotin is designated ‘B’, and streptavidin is designated ‘SA’.

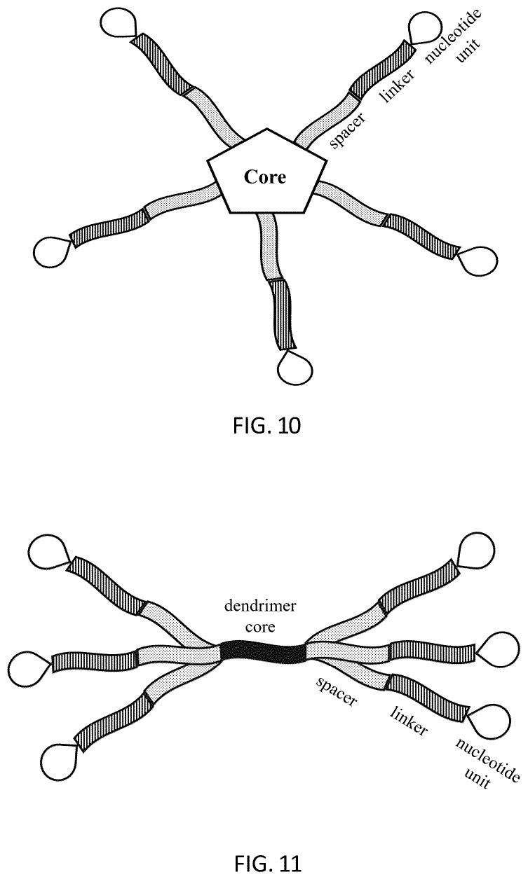

FIG. 10 is a schematic of an example multivalent molecule comprising a generic core attached to a plurality of nucleotide arms, according to some embodiments.

FIG. 11 is a schematic of an example multivalent molecule comprising a dendrimer core attached to a plurality of nucleotide arms, according to some embodiments.

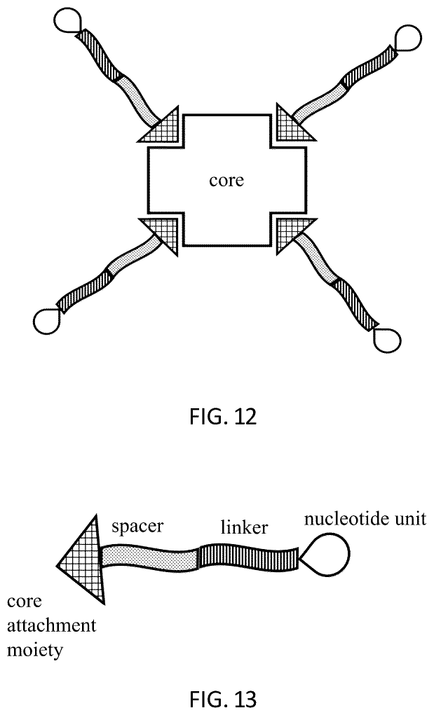

FIG. 12 shows a schematic of an example multivalent molecule comprising a core attached to a plurality of nucleotide arms, where the nucleotide arms comprise biotin, spacer, linker and a nucleotide unit, according to some embodiments.

FIG. 13 is a schematic of an example nucleotide arm comprising a core attachment moiety, spacer, linker and nucleotide unit, according to some embodiments.

FIG. 14 shows the chemical structure of an example spacer (top), and the chemical structures of various example linkers, including an 11-atom Linker, 16-atom Linker, 23-atom Linker and an N3 Linker (bottom), according to some embodiments.

FIG. 15 shows the chemical structures of various example linkers, including Linkers 1-9, according to some embodiments.

FIG. 16 shows the chemical structures of various example linkers joined/attached to nucleotide units, according to some embodiments.

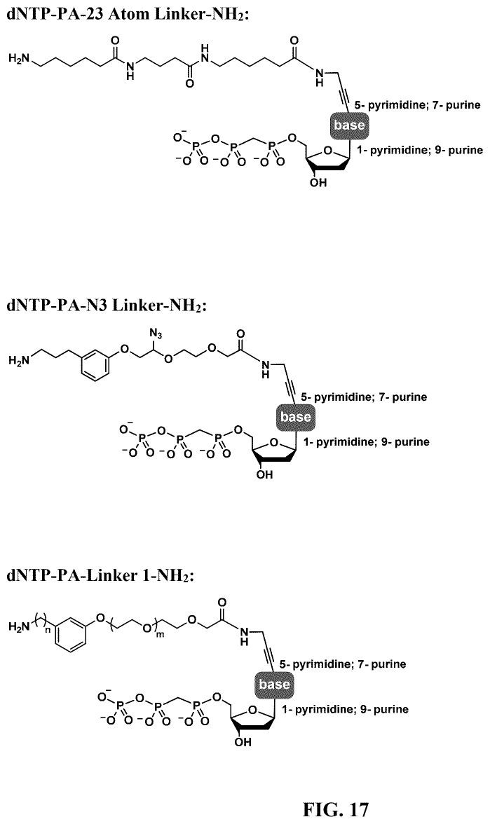

FIG. 17 shows the chemical structures of various example linkers joined/attached to nucleotide units, according to some embodiments.

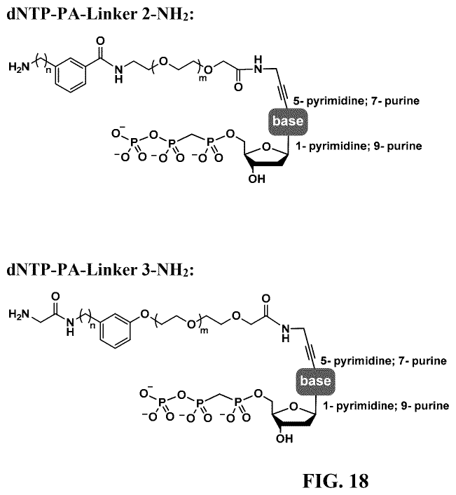

FIG. 18 shows the chemical structures of various example linkers joined/attached to nucleotide units, according to some embodiments.

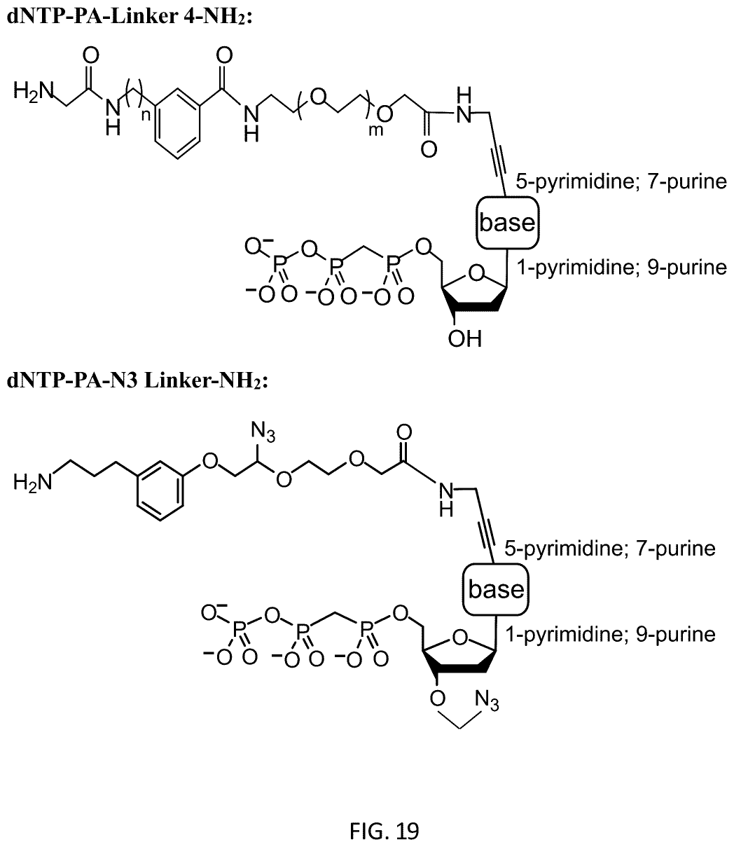

FIG. 19 shows the chemical structures of various example linkers joined/attached to nucleotide units, according to some embodiments.

FIG. 20 shows the chemical structure of an example biotinylated nucleotide-arm. In this example, the nucleotide unit is connected to the linker via a propargyl amine attachment at the 5 position of a pyrimidine base or the 7 position of a purine base, according to some embodiments.

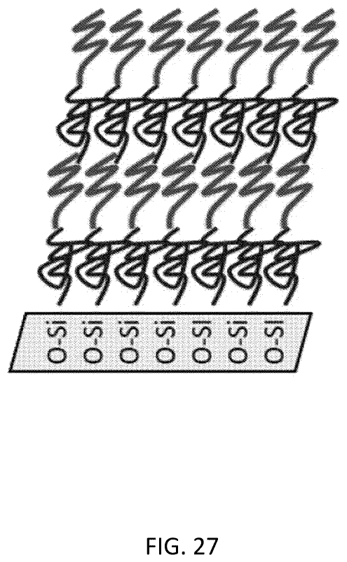

FIG. 27 shows a schematic illustration of one embodiment of the low binding solid supports of the present disclosure in which the support comprises a glass substrate and alternating layers of hydrophilic coatings which are covalently or non-covalently adhered to the glass, and which further comprises chemically-reactive functional groups that serve as attachment sites for oligonucleotide primers.

### Compaction Oligonucleotides

A compaction oligonucleotide comprises a single-stranded linear oligonucleotide having a 5′ region that can hybridize to a first portion of a concatemer molecule and the compaction oligonucleotide having a 3′ region that can hybridize to a second portion of the concatemer molecule (e.g., the same concatemer molecule). In some embodiments, hybridization of the compaction oligonucleotides to individual concatemer molecules causes the concatemer molecule to collapse or fold into a DNA nanoball which is more compact in shape and size compared to a non-collapsed DNA molecule. A spot image of a DNA nanoball can be represented as a Gaussian spot and the size can be measured as a full width half maximum (FWHM). A smaller spot size as indicated by a smaller FWHM typically correlates with an improved image of the spot. In some embodiments, the FWHM of a DNA nanoball spot can be about 10 um or smaller. The DNA nanoball can be a compact nucleic acid structure having a full width half maximum (FWHM) that is smaller compared to a concatemer that is not collapsed/folded into a DNA nanoball.

In some embodiments, compaction oligonucleotides comprise a single stranded oligonucleotides comprising DNA, RNA, or a combination of DNA and RNA. The compaction oligonucleotides can be any length, including 20-150 nucleotides, or 30-100 nucleotides, or 40-80 nucleotides in length.

In some embodiments, the compaction oligonucleotides comprises a 5′ region and a 3′ region, and optionally an intervening region between 5′ and 3′ regions. The intervening region can be any length, for example about 2-20 nucleotides in length. The intervening region comprises a homopolymer having consecutive identical bases (e.g., AAA, GGG, CCC, TTT or UUU). The intervening region comprises a non-homopolymer sequence.

The 5′ region of the compaction oligonucleotides can be wholly complementary or partially complementary along its length to a first portion of a concatemer molecule. The 3′ region of the compaction oligonucleotides can be wholly complementary or partially complementary along its length to a second portion of a concatemer molecule. The 5′ region of the compaction oligonucleotides can hybridize to a first universal sequence portion of a concatemer molecule. The 3′ region of the compaction oligonucleotides can hybridize to a second universal sequence portion of a concatemer molecule. The 5′ and 3′ regions of the compaction oligonucleotide can hybridize to the concatemer to pull together distal portions of the concatemer causing compaction of the concatemer to form a DNA nanoball.

The 5′ region of the compaction oligonucleotide can have the same sequence as the 3′ region. The 5′ region of the compaction oligonucleotide can have a sequence that is different from 3′ region. The 3′ region of the compaction oligonucleotide can have a sequence that is a reverse sequence of 5′ region.

In some embodiments sequence data may be derived through nanopore sequencing, which comprises sequencing of a nucleic acid by translocating said nucleic acid across a membrane, such as through a pore, and wherein sequence reads or base calls are made by measuring one or more signals during the translocation event, such as impedance, current, voltage, or capacitance. In some embodiments, the identity of a nucleotide may be determined by distinctive electrical signatures, such as the timing, duration, extent, or lineshape of a current block, impedance change, voltage change, or capacitance change. Sequencing of nucleic acids by translocation across a membrane and/or through a pore does not foreclose alternative detection methods, such as optical, chemical, biochemical, fluorescent, luminescent, magnetic, electromagnetic, acoustic, or electroacoustic detection.

### Supports and Low Non-Specific Coatings

In some embodiments, the flow cell 112 in FIG. 1 can include a support, e.g., a solid support as disclosed herein. Embodiments of the present disclosure provide pairwise sequencing compositions and methods which employ a support comprising a plurality of oligonucleotide surface primers immobilized thereon. In some embodiments, the support is passivated with a low non-specific binding coating. The surface coatings described herein exhibit very low non-specific binding to reagents typically used for nucleic acid capture, amplification and sequencing workflows, such as dyes, nucleotides, enzymes, and nucleic acid primers. The surface coatings exhibit low background fluorescence signals or high contrast-to-noise (CNR) ratios compared to conventional surface coatings.

The low non-specific binding coating comprises one layer or multiple layers (FIG. 27). In some embodiments, the plurality of surface primers are immobilized to the low non-specific binding coating. In some embodiments, at least one surface primer is embedded within the low non-specific binding coating. The low non-specific binding coating enables improved nucleic acid hybridization and amplification performance. In general, the supports comprise a substrate (or support structure), one or more layers of a covalently or non-covalently attached low-binding, chemical modification layers, e.g., silane layers, polymer films, and one or more covalently or non-covalently attached surface primers that can be used for tethering single-stranded nucleic acid library molecules to the support. In some embodiments, the formulation of the coating, e.g., the chemical composition of one or more layers, the coupling chemistry used to cross-link the one or more layers to the support and/or to each other, and the total number of layers, may be varied such that non-specific binding of proteins, nucleic acid molecules, and other hybridization and amplification reaction components to the coating is minimized or reduced relative to a comparable monolayer. The formulation of the coating described herein may be varied such that non-specific hybridization on the coating is minimized or reduced relative to a comparable monolayer. The formulation of the coating may be varied such that non-specific amplification on the coating is minimized or reduced relative to a comparable monolayer. The formulation of the coating may be varied such that specific amplification rates and/or yields on the coating are maximized. Amplification levels suitable for detection are achieved in no more than 2, 3, 4, 5, 6, 7, 8, 9, 10, 15, 20, 25, 30, or more than 30 amplification cycles in some cases disclosed herein.

The support structure that comprises the one or more chemically-modified layers, e.g., layers of a low non-specific binding polymer, may be independent or integrated into another structure or assembly. For example, in some embodiments, the support structure may comprise one or more surfaces within an integrated or assembled microfluidic flow cell. The support structure may comprise one or more surfaces within a microplate format, e.g., the bottom surface of the wells in a microplate. In some embodiments, the support structure comprises the interior surface (such as the lumen surface) of a capillary. In some embodiments, the support structure comprises the interior surface (such as the lumen surface) of a capillary etched into a planar chip.

The attachment chemistry used to graft a first chemically-modified layer to the surface of the support will generally be dependent on both the material from which the surface is fabricated and the chemical nature of the layer. In some embodiments, the first layer may be covalently attached to the surface. In some embodiments, the first layer may be non-covalently attached, e.g., adsorbed to the support through non-covalent interactions such as electrostatic interactions, hydrogen bonding, or van der Waals interactions between the support and the molecular components of the first layer. In either case, the support may be treated prior to attachment or deposition of the first layer. Any of a variety of surface preparation techniques known to those of skill in the art may be used to clean or treat the surface. For example, glass or silicon surfaces may be acid-washed using a Piranha solution (a mixture of sulfuric acid (H₂SO₄) and hydrogen peroxide (H₂O₂)), base treatment in KOH and NaOH, and/or cleaned using an oxygen plasma treatment method.

Silane chemistries constitute non-limiting approaches for covalently modifying the silanol groups on glass or silicon surfaces to attach more reactive functional groups (e.g., amines or carboxyl groups), which may then be used in coupling linker molecules (e.g., linear hydrocarbon molecules of various lengths, such as C6, C12, C18 hydrocarbons, or linear polyethylene glycol (PEG) molecules) or layer molecules (e.g., branched PEG molecules or other polymers) to the surface. Examples of suitable silanes that may be used in creating any of the disclosed low binding coatings include, but are not limited to, (3-Aminopropyl) trimethoxysilane (APTMS), (3-Aminopropyl)triethoxysilane (APTES), any of a variety of PEG-silanes (e.g., comprising molecular weights of 1K, 2K, 5K, 10K, 20K, etc.), amino-PEG silane (i.e., comprising a free amino functional group), maleimide-PEG silane, biotin-PEG silane, and the like.

Any of a variety of molecules known to those of skill in the art including, but not limited to, amino acids, peptides, nucleotides, oligonucleotides, other monomers or polymers, or combinations thereof may be used in creating the one or more chemically-modified layers on the support, where the choice of components used may be varied to alter one or more properties of the layers, e.g., the surface density of functional groups and/or tethered oligonucleotide primers, the hydrophilicity/hydrophobicity of the layers, or the three three-dimensional nature (i.e., “thickness”) of the layer. Examples of polymers that may be used to create one or more layers of low non-specific binding material in any of the disclosed coatings include, but are not limited to, polyethylene glycol (PEG) of various molecular weights and branching structures, streptavidin, polyacrylamide, polyester, dextran, poly-lysine, and poly-lysine copolymers, or any combination thereof. Examples of conjugation chemistries that may be used to graft one or more layers of material (e.g. polymer layers) to the surface and/or to cross-link the layers to each other include, but are not limited to, biotin-streptavidin interactions (or variations thereof), his tag-Ni/NTA conjugation chemistries, methoxy ether conjugation chemistries, carboxylate conjugation chemistries, amine conjugation chemistries, NHS esters, maleimides, thiol, epoxy, azide, hydrazide, alkyne, isocyanate, and silane.

The low non-specific binding surface coating may be applied uniformly across the support. Alternatively, the surface coating may be patterned, such that the chemical modification layers are confined to one or more discrete regions of the support. For example, the coating may be patterned using photolithographic techniques to create an ordered array or random pattern of chemically-modified regions on the support. Alternately or in combination, the coating may be patterned using, e.g., contact printing and/or ink-jet printing techniques. In some embodiments, an ordered array or random pattern of chemically-modified regions may comprise at least 1, 5, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10,000 or more discrete regions.

In some embodiments, the low nonspecific binding coatings comprise hydrophilic polymers that are non-specifically adsorbed or covalently grafted to the support. Typically, passivation is performed utilizing poly(ethylene glycol) (PEG, also known as polyethylene oxide (PEO) or polyoxyethylene) or other hydrophilic polymers with different molecular weights and end groups that are linked to a support using, for example, silane chemistry. The end groups distal from the surface can include, but are not limited to, biotin, methoxy ether, carboxylate, amine, NHS ester, maleimide, and bis-silane. In some embodiments, two or more layers of a hydrophilic polymer, e.g., a linear polymer, branched polymer, or multi-branched polymer, may be deposited on the surface. In some embodiments, two or more layers may be covalently coupled to each other or internally cross-linked to improve the stability of the resulting coating. In some embodiments, surface primers with different nucleotide sequences and/or base modifications (or other biomolecules, e.g., enzymes or antibodies) may be tethered to the resulting layer at various surface densities. In some embodiments, for example, both surface functional group density and surface primer concentration may be varied to attain a desired surface primer density range. Additionally, surface primer density can be controlled by diluting the surface primers with other molecules that carry the same functional group. For example, amine-labeled surface primers can be diluted with amine-labeled polyethylene glycol in a reaction with an NHS-ester coated surface to reduce the final primer density. Surface primers with different lengths of linker between the hybridization region and the surface attachment functional group can also be applied to control surface density. Example of suitable linkers include poly-T and poly-A strands at the 5′ end of the primer (e.g., 0 to 20 bases), PEG linkers (e.g., 3 to 20 monomer units), and carbon-chain (e.g., C6, C12, C18, etc.). To measure the primer density, fluorescently-labeled primers may be tethered to the surface and a fluorescence reading then compared with that for a dye solution of known concentration.

In some embodiments, the low nonspecific binding coatings comprise a functionalized polymer coating layer covalently bound at least to a portion of the support via a chemical group on the support, a primer grafted to the functionalized polymer coating, and a water-soluble protective coating on the primer and the functionalized polymer coating. In some embodiments, the functionalized polymer coating comprises a poly(N-(5-azidoacetamidylpentyl) acrylamide-co-acrylamide (PAZAM).

In order to scale primer surface density and add additional dimensionality to hydrophilic or amphoteric coatings, supports comprising multi-layer coatings of PEG and other hydrophilic polymers have been developed. By using hydrophilic and amphoteric surface layering approaches that include, but are not limited to, the polymer/co-polymer materials described below, it is possible to increase primer loading density on the support significantly. Traditional PEG coating approaches use monolayer primer deposition, which have been generally reported for single molecule applications, but do not yield high copy numbers for nucleic acid amplification applications. As described herein “layering” can be accomplished using traditional crosslinking approaches with any compatible polymer or monomer subunits such that a surface comprising two or more highly crosslinked layers can be built sequentially. Examples of suitable polymers include, but are not limited to, streptavidin, poly acrylamide, polyester, dextran, poly-lysine, and copolymers of poly-lysine and PEG. In some embodiments, the different layers may be attached to each other through any of a variety of conjugation reactions including, but not limited to, biotin-streptavidin binding, azide-alkyne click reaction, amine-NHS ester reaction, thiol-maleimide reaction, and ionic interactions between positively charged polymer and negatively charged polymer. In some embodiments, high primer density materials may be constructed in solution and subsequently layered onto the surface in multiple steps.

Examples of materials from which the support structure may be fabricated include, but are not limited to, glass, fused-silica, silicon, a polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET)), or any combination thereof. Various compositions of both glass and plastic support structures are contemplated.

The support structure may be rendered in any of a variety of geometries and dimensions known to those of skill in the art, and may comprise any of a variety of materials known to those of skill in the art. For example, the support structure may be locally planar (e.g., comprising a microscope slide or the surface of a microscope slide). Globally, the support structure may be cylindrical (e.g., comprising a capillary or the interior surface of a capillary), spherical (e.g., comprising the outer surface of a non-porous bead), or irregular (e.g., comprising the outer surface of an irregularly-shaped, non-porous bead or particle). In some embodiments, the surface of the support structure used for nucleic acid hybridization and amplification may be a solid, non-porous surface. In some embodiments, the surface of the support structure used for nucleic acid hybridization and amplification may be porous, such that the coatings described herein penetrate the porous surface, and nucleic acid hybridization and amplification reactions performed thereon may occur within the pores.

The support structure that comprises the one or more chemically-modified layers, e.g., layers of a low non-specific binding polymer, may be independent or integrated into another structure or assembly. For example, the support structure may comprise one or more surfaces within an integrated or assembled microfluidic flow cell. The support structure may comprise one or more surfaces within a microplate format, e.g., the bottom surface of the wells in a microplate. In some embodiments, the support structure comprises the interior surface (such as the lumen surface) of a capillary. In some embodiments the support structure comprises the interior surface (such as the lumen surface) of a capillary etched into a planar chip.

As noted, the low non-specific binding supports of the present disclosure exhibit reduced non-specific binding of proteins, nucleic acids, and other components of the hybridization and/or amplification formulation used for solid-phase nucleic acid amplification. The degree of non-specific binding exhibited by a given support surface may be assessed either qualitatively or quantitatively. For example, exposure of the surface to fluorescent dyes (e.g., cyanins such as Cy3, or Cy5, etc., fluoresceins, coumarins, rhodamines, etc. or other dyes disclosed herein), fluorescently-labeled nucleotides, fluorescently-labeled oligonucleotides, and/or fluorescently-labeled proteins (e.g. polymerases) under a standardized set of conditions, followed by a specified rinse protocol and fluorescence imaging may be used as a qualitative tool for comparison of non-specific binding on supports comprising different surface formulations. In some embodiments, exposure of the surface to fluorescent dyes, fluorescently-labeled nucleotides, fluorescently-labeled oligonucleotides, and/or fluorescently-labeled proteins (e.g. polymerases) under a standardized set of conditions, followed by a specified rinse protocol and fluorescence imaging may be used as a quantitative tool for comparison of non-specific binding on supports comprising different surface formulations-provided that care has been taken to ensure that the fluorescence imaging is performed under conditions where fluorescence signal is linearly related (or related in a predictable manner) to the number of fluorophores on the support surface (e.g., under conditions where signal saturation and/or self-quenching of the fluorophore is not an issue) and suitable calibration standards are used. In some embodiments, other techniques known to those of skill in the art, for example, radioisotope labeling and counting methods may be used for quantitative assessment of the degree to which non-specific binding is exhibited by the different support surface formulations of the present disclosure.

Some surfaces disclosed herein exhibit a ratio of specific to nonspecific binding of a fluorophore such as Cy3 of at least 2, 3, 4, 5, 6, 7, 8, 9, 10, 11, 12, 13, 14, 15, 16, 17, 18, 19, 20, 25, 30, 35, 40, 50, 75, 100, or greater than 100, or any intermediate value spanned by the range herein. Some surfaces disclosed herein exhibit a ratio of specific to nonspecific fluorescence of a fluorophore such as Cy3 of at least 2, 3, 4, 5, 6, 7, 8, 9, 10, 11, 12, 13, 14, 15, 16, 17, 18, 19, 20, 25, 30, 35, 40, 50, 75, 100, or greater than 100, or any intermediate value spanned by the range herein.

The degree of non-specific binding exhibited by the disclosed low-binding supports may be assessed using a standardized protocol for contacting the surface with a labeled protein (e.g., bovine serum albumin (BSA), streptavidin, a DNA polymerase, a reverse transcriptase, a helicase, a single-stranded binding protein (SSB), etc., or any combination thereof), a labeled nucleotide, a labeled oligonucleotide, etc., under a standardized set of incubation and rinse conditions, followed be detection of the amount of label remaining on the surface and comparison of the signal resulting therefrom to an appropriate calibration standard. In some embodiments, the label may comprise a fluorescent label. In some embodiments, the label may comprise a radioisotope. In some embodiments, the label may comprise any other detectable label known to one of skill in the art. In some embodiments, the degree of non-specific binding exhibited by a given support surface formulation may thus be assessed in terms of the number of non-specifically bound protein molecules (or nucleic acid molecules or other molecules) per unit area. In some embodiments, the low-binding supports of the present disclosure may exhibit non-specific protein binding (or non-specific binding of other specified molecules, (e.g., cyanins such as Cy3, or Cy5, etc., fluoresceins, coumarins, rhodamines, etc. or other dyes disclosed herein)) of less than 0.001 molecule per μm², less than 0.01 molecule per μm², less than 0.1 molecule per μm², less than 0.25 molecule per μm², less than 0.5 molecule per μm², less than 1 molecule per μm², less than 10 molecules per μm², less than 100 molecules per μm², or less than 1,000 molecules per μm². Those of skill in the art will realize that a given support surface of the present disclosure may exhibit non-specific binding falling anywhere within this range, for example, of less than 86 molecules per μm². For example, some modified surfaces disclosed herein exhibit nonspecific protein binding of less than 0.5 molecule/μm² following contact with a 1 μM solution of Cy3 labeled streptavidin (GE Amersham) in phosphate buffered saline (PBS) buffer for 15 minutes, followed by 3 rinses with deionized water. Some modified surfaces disclosed herein exhibit nonspecific binding of Cy3 dye molecules of less than 0.25 molecules per μm². In independent nonspecific binding assays, 1 μM labeled Cy3 SA (ThermoFisher), 1 μM Cy5 SA dye (ThermoFisher), 10 μM Aminoallyl-dUTP-ATTO-647N (Jena Biosciences), 10 μM Aminoallyl-dUTP-ATTO-Rhol 1 (Jena Biosciences), 10 μM Aminoallyl-dUTP-ATTO-Rhol 1 (Jena Biosciences), 10 μM 7-Propargylamino-7-deaza-dGTP-Cy5 (Jena Biosciences, and 10 μM 7-Propargylamino-7-deaza-dGTP-Cy3 (Jena Biosciences) were incubated on the low binding coated supports at 37° C. for 15 minutes in a 384 well plate format. Each well was rinsed 2-3× with 50 ul deionized RNase/DNase Free water and 2-3× with 25 mM ACES buffer pH 7.4. The 384 well plates were imaged on a GE Typhoon instrument using the Cy3, AF555, or Cy5 filter sets (according to dye test performed) as specified by the manufacturer at a PMT gain setting of 800 and resolution of 50-100 um. For higher resolution imaging, images were collected on an Olympus IX83 microscope (e.g., inverted fluorescence microscope) (Olympus Corp., Center Valley, Pa.) with a total internal reflectance fluorescence (TIRF) objective (100×, 1.5 NA, Olympus), a CCD camera (e.g., an Olympus EM-CCD monochrome camera, Olympus XM-10 monochrome camera, or an Olympus DP80 color and monochrome camera), an illumination source (e.g., an Olympus 100 W Hg lamp, an Olympus 75 W Xe lamp, or an Olympus U-HGLGPS fluorescence light source), and excitation wavelengths of 532 nm or 635 nm. Dichroic mirrors were purchased from Semrock (IDEX Health & Science, LLC, Rochester, N.Y.), e.g., 405, 488, 532, or 633 nm dichroic reflectors/beamsplitters, and band pass filters were chosen as 532 LP or 645 LP concordant with the appropriate excitation wavelength. Some modified surfaces disclosed herein exhibit nonspecific binding of dye molecules of less than 0.25 molecules per μm². In some embodiments, the coated support was immersed in a buffer (e.g., 25 mM ACES, pH 7.4) while the image was acquired.

In some embodiments, the surfaces disclosed herein exhibit a ratio of specific to nonspecific binding of a fluorophore such as Cy3 of at least 2, 3, 4, 5, 6, 7, 8, 9, 10, 11, 12, 13, 14, 15, 16, 17, 18, 19, 20, 25, 30, 35, 40, 50, 75, 100, or greater than 100, or any intermediate value spanned by the range herein. In some embodiments, the surfaces disclosed herein exhibit a ratio of specific to nonspecific fluorescence signals for a fluorophore such as Cy3 of at least 2, 3, 4, 5, 6, 7, 8, 9, 10, 11, 12, 13, 14, 15, 16, 17, 18, 19, 20, 25, 30, 35, 40, 50, 75, 100, or greater than 100, or any intermediate value spanned by the range herein.

The low-background surfaces consistent with the disclosure herein may exhibit specific dye attachment (e.g., Cy3 attachment) to non-specific dye adsorption (e.g., Cy3 dye adsorption) ratios of at least 4:1, 5:1, 6:1, 7:1, 8:1, 9:1, 10:1, 15:1, 20:1, 30:1, 40:1, 50:1, or more than 50 specific dye molecules attached per molecule nonspecifically adsorbed. Similarly, when subjected to an excitation energy, low-background surfaces consistent with the disclosure herein to which fluorophores, e.g., Cy3, have been attached may exhibit ratios of specific fluorescence signal (e.g., arising from Cy3-labeled oligonucleotides attached to the surface) to non-specific adsorbed dye fluorescence signals of at least 4:1, 5:1, 6:1, 7:1, 8:1, 9:1, 10:1, 15:1, 20:1, 30:1, 40:1, 50:1, or more than 50:1.

In some embodiments, the degree of hydrophilicity (or “wettability” with aqueous solutions) of the disclosed support surfaces may be assessed, for example, through the measurement of water contact angles in which a small droplet of water is placed on the surface and its angle of contact with the surface is measured using, e.g., an optical tensiometer. In some embodiments, a static contact angle may be determined. In some embodiments, an advancing or receding contact angle may be determined. In some embodiments, the water contact angle for the hydrophilic, low-binding support surfaced disclosed herein may range from about 0 degrees to about 30 degrees. In some embodiments, the water contact angle for the hydrophilic, low-binding support surfaced disclosed herein may no more than 50 degrees, 40 degrees, 30 degrees, 25 degrees, 20 degrees, 18 degrees, 16 degrees, 14 degrees, 12 degrees, 10 degrees, 8 degrees, 6 degrees, 4 degrees, 2 degrees, or 1 degree. In many cases the contact angle is no more than 40 degrees. Those of skill in the art will realize that a given hydrophilic, low-binding support surface of the present disclosure may exhibit a water contact angle having a value of anywhere within this range.

In some embodiments, the hydrophilic surfaces disclosed herein facilitate reduced wash times for bioassays, often due to reduced nonspecific binding of biomolecules to the low-binding surfaces. In some embodiments, adequate wash steps may be performed in less than 60, 50, 40, 30, 20, 15, 10, or less than 10 seconds. For example, adequate wash steps may be performed in less than 30 seconds.

Some low-binding surfaces of the present disclosure exhibit significant improvement in stability or durability to prolonged exposure to solvents and elevated temperatures, or to repeated cycles of solvent exposure or changes in temperature. For example, the stability of the disclosed surfaces may be tested by fluorescently labeling a functional group on the surface, or a tethered biomolecule (e.g., an oligonucleotide primer) on the surface, and monitoring fluorescence signal before, during, and after prolonged exposure to solvents and elevated temperatures, or to repeated cycles of solvent exposure or changes in temperature. In some embodiments, the degree of change in the fluorescence used to assess the quality of the surface may be less than 1%, 2%, 3%, 4%, 5%, 10%, 15%, 20%, or 25% over a time period of 1 minute, 2 minutes, 3 minutes, 4 minutes, 5 minutes, 10 minutes, 20 minutes, 30 minutes, 40 minutes, 50 minutes, 60 minutes, 2 hours, 3 hours, 4 hours, 5 hours, 6 hours, 7 hours, 8 hours, 9 hours, 10 hours, 15 hours, 20 hours, 25 hours, 30 hours, 35 hours, 40 hours, 45 hours, 50 hours, or 100 hours of exposure to solvents and/or elevated temperatures (or any combination of these percentages as measured over these time periods). In some embodiments, the degree of change in the fluorescence used to assess the quality of the surface may be less than 1%, 2%, 3%, 4%, 5%, 10%, 15%, 20%, or 25% over 5 cycles, 10 cycles, 20 cycles, 30 cycles, 40 cycles, 50 cycles, 60 cycles, 70 cycles, 80 cycles, 90 cycles, 100 cycles, 200 cycles, 300 cycles, 400 cycles, 500 cycles, 600 cycles, 700 cycles, 800 cycles, 900 cycles, or 1,000 cycles of repeated exposure to solvent changes and/or changes in temperature (or any combination of these percentages as measured over this range of cycles).

In some embodiments, the surfaces disclosed herein may exhibit a high ratio of specific signal to nonspecific signal or other background. For example, when used for nucleic acid amplification, some surfaces may exhibit an amplification signal that is at least 4, 5, 6, 7, 8, 9, 10, 15, 20, 30, 40, 50, 75, 100, or greater than 100 fold greater than a signal of an adjacent unpopulated region of the surface. Similarly, some surfaces exhibit an amplification signal that is at least 4, 5, 6, 7, 8, 9, 10, 15, 20, 30, 40, 50, 75, 100, or greater than 100 fold greater than a signal of an adjacent amplified nucleic acid population region of the surface.

In some embodiments, fluorescence images of the disclosed low background surfaces when used in nucleic acid hybridization or amplification applications to create polonies of hybridized or clonally-amplified nucleic acid molecules (e.g., that have been directly or indirectly labeled with a fluorophore) exhibit contrast-to-noise ratios (CNRs) of at least 10, 20, 30, 40, 50, 60, 70, 80, 90, 100, 110, 120, 130, 140, 150, 160, 170, 180, 190, 20, 210, 220, 230, 240, 250, or greater than 250.

One or more types of primer may be attached or tethered to the support surface. In some embodiments, the one or more types of adapters or primers may comprise spacer sequences, adapter sequences for hybridization to adapter-ligated target library nucleic acid sequences, forward amplification primers, reverse amplification primers, sequencing primers, and/or molecular barcoding sequences, or any combination thereof. In some embodiments, 1 primer or adapter sequence may be tethered to at least one layer of the surface. In some embodiments, at least 2, 3, 4, 5, 6, 7, 8, 9, 10, or more than 10 different primer or adapter sequences may be tethered to at least one layer of the surface.

In some embodiments, the tethered adapter and/or primer sequences may range in length from about 10 nucleotides to about 100 nucleotides. In some embodiments, the tethered adapter and/or primer sequences may be at least 10, at least 20, at least 30, at least 40, at least 50, at least 60, at least 70, at least 80, at least 90, or at least 100 nucleotides in length. In some embodiments, the tethered adapter and/or primer sequences may be at most 100, at most 90, at most 80, at most 70, at most 60, at most 50, at most 40, at most 30, at most 20, or at most 10 nucleotides in length. Any of the lower and upper values described in this paragraph may be combined to form a range included within the present disclosure, for example, in some embodiments the length of the tethered adapter and/or primer sequences may range from about 20 nucleotides to about 80 nucleotides. Those of skill in the art will recognize that the length of the tethered adapter and/or primer sequences may have any value within this range, e.g., about 24 nucleotides.

In some embodiments, the resultant surface density of primers (e.g., capture primers) on the low binding support surfaces of the present disclosure may range from about 100 primer molecules per μm² to about 100,000 primer molecules per μm². In some embodiments, the resultant surface density of primers on the low binding support surfaces of the present disclosure may range from about 1,000 primer molecules per μm² to about 1,000,000 primer molecules per μm². In some embodiments, the surface density of primers may be at least 1,000, at least 10,000, at least 100,000, or at least 1,000,000 molecules per μm². In some embodiments, the surface density of primers may be at most 1,000,000, at most 100,000, at most 10,000, or at most 1,000 molecules per μm². Any of the lower and upper values described in this paragraph may be combined to form a range included within the present disclosure, for example, in some embodiments the surface density of primers may range from about 10,000 molecules per μm² to about 100,000 molecules per μm². Those of skill in the art will recognize that the surface density of primer molecules may have any value within this range, e.g., about 455,000 molecules per μm². In some embodiments, the surface density of target library nucleic acid sequences initially hybridized to adapter or primer sequences on the support surface may be less than or equal to that indicated for the surface density of tethered primers. In some embodiments, the surface density of clonally-amplified target library nucleic acid sequences hybridized to adapter or primer sequences on the support surface may span the same range as that indicated for the surface density of tethered primers.

Local densities as listed above do not preclude variation in density across a surface, such that a surface may comprise a region having an oligo density of, for example, 500,000/μm², while also comprising at least a second region having a substantially different local density.

In some embodiments, the performance of nucleic acid hybridization and/or amplification reactions using the disclosed reaction formulations and low-binding supports may be assessed using fluorescence imaging techniques, where the contrast-to-noise ratio (CNR) of the images provides a key metric in assessing amplification specificity and non-specific binding on the support. CNR is commonly defined as: CNR=(Signal-Background)/Noise. The background term is commonly taken to be the signal measured for the interstitial regions surrounding a particular feature (diffraction limited spot, DLS) in a specified region of interest (ROI). While signal-to-noise ratio (SNR) is often considered to be a benchmark of overall signal quality, it can be shown that improved CNR can provide a significant advantage over SNR as a benchmark for signal quality in applications that require rapid image capture (e.g., sequencing applications for which cycle times must be minimized), as shown in the example below. At high CNR the imaging time required to reach accurate discrimination (and thus accurate base-calling in the case of sequencing applications) can be drastically reduced even with moderate improvements in CNR. Improved CNR in imaging data on the imaging integration time provides a method for more accurately detecting features such as clonally-amplified nucleic acid colonies on the support surface.

In most ensemble-based sequencing approaches, the background term is typically measured as the signal associated with ‘interstitial’ regions. In addition to “interstitial” background (Bᵢₙₜₑᵣ), “intrastitial” background (Bᵢₙₜᵣₐ) exists within the region occupied by an amplified DNA colony. The combination of these two background signals dictates the achievable CNR, and subsequently directly impacts the optical instrument requirements, architecture costs, reagent costs, run-times, cost/genome, and ultimately the accuracy and data quality for cyclic array-based sequencing applications. The Bᵢₙₜₑᵣ background signal arises from a variety of sources; a few examples include auto-fluorescence from consumable flow cells, non-specific adsorption of detection molecules that yield spurious fluorescence signals that may obscure the signal from the ROI, the presence of non-specific DNA amplification products (e.g., those arising from primer dimers). In typical next generation sequencing (NGS) applications, this background signal in the current field-of-view (FOV) is averaged over time and subtracted. The signal arising from individual DNA colonies (i.e., (Signal)-B(interstial) in the FOV) yields a discernable feature that can be classified. In some embodiments, the intrastitial background (B(intrastitial)) can contribute a confounding fluorescence signal that is not specific to the target of interest, but is present in the same ROI thus making it far more difficult to average and subtract.

Nucleic acid amplification on the low-binding coated supports described herein may decrease the B(interstitial) background signal by reducing non-specific binding, may lead to improvements in specific nucleic acid amplification, and may lead to a decrease in non-specific amplification that can impact the background signal arising from both the interstitial and intrastitial regions. In some embodiments, the disclosed low-binding coated supports, optionally used in combination with the disclosed hybridization and/or amplification reaction formulations, may lead to improvements in CNR by a factor of 2, 5, 10, 100, 250, 500 or 1000-fold over those achieved using conventional supports and hybridization, amplification, and/or sequencing protocols. Although described here in the context of using fluorescence imaging as the read-out or detection mode, the same principles apply to the use of the disclosed low-binding coated supports and nucleic acid hybridization and amplification formulations for other detection modes as well, including both optical and non-optical detection modes.

The headings provided herein are not limitations of the various embodiments of the disclosure, which embodiments can be understood by reference to the specification as a whole.

Unless defined otherwise, technical and scientific terms used herein have meanings that are commonly understood by those of ordinary skill in the art unless defined otherwise. Generally, terminologies pertaining to techniques of molecular biology, nucleic acid chemistry, protein chemistry, genetics, microbiology, transgenic cell production, and hybridization described herein are those well-known and commonly used in the art. Techniques and procedures described herein are generally performed according to conventional methods well known in the art and as described in various general and more specific references that are cited and discussed throughout the instant specification. For example, see Sambrook et al., Molecular Cloning: A Laboratory Manual (Third ed., Cold Spring Harbor Laboratory Press, Cold Spring Harbor, N.Y. 2000). See also Ausubel et al., Current Protocols in Molecular Biology, Greene Publishing Associates (1992). The nomenclatures utilized in connection with, and the laboratory procedures and techniques described herein are those well-known and commonly used in the art.

Unless otherwise required by context herein, singular terms shall include pluralities and plural terms shall include the singular. Singular forms “a”, “an” and “the”, and singular use of any word, include plural referents unless expressly and unequivocally limited on one referent.

It is understood the use of the alternative term (e.g., “or”) is taken to mean either one or both or any combination thereof of the alternatives.

The term “and/or” used herein is to be taken mean specific disclosure of each of the specified features or components with or without the other. For example, the term “and/or” as used in a phrase such as “A and/or B” herein is intended to include: “A and B”; “A or B”; “A” (A alone); and “B” (B alone). In a similar manner, the term “and/or” as used in a phrase such as “A, B, and/or C” is intended to encompass each of the following embodiments: “A, B, and C”; “A, B, or C”; “A or C”; “A or B”; “B or C”; “A and B”; “B and C”; “A and C”; “A” (A alone); “B” (B alone); and “C” (C alone).

As used herein and in the appended claims, terms “comprising”, “including”, “having” and “containing”, and their grammatical variants, as used herein are intended to be non-limiting so that one item or multiple items in a list do not exclude other items that can be substituted or added to the listed items. It is understood that wherever embodiments are described herein with the language “comprising,” otherwise analogous embodiments described in terms of “consisting of” and/or “consisting essentially of” are also provided.

As used herein, the terms “about,” “approximately,” and “substantially” refer to a value or composition that is within an acceptable error range for the particular value or composition as determined by one of ordinary skill in the art, which will depend in part on how the value or composition is measured or determined, i.e., the limitations of the measurement system. For example, “about,” “approximately,” or “substantially” can mean within one or more than one standard deviation per the practice in the art. Alternatively, “about” or “approximately” can mean a range of up to 10% (i.e., +10%) or more depending on the limitations of the measurement system. For example, about 5 mg can include any number between 4.5 mg and 5.5 mg. Furthermore, particularly with respect to biological systems or processes, the terms can mean up to an order of magnitude or up to 5-fold of a value. When particular values or compositions are provided in the instant disclosure, unless otherwise stated, the meaning of “about,” “approximately,” “substantially” should be assumed to be within an acceptable error range for that particular value or composition. Also, where ranges and/or subranges of values are provided, the ranges and/or subranges can include the endpoints of the ranges and/or subranges.

The term “polony” used herein refers to a nucleic acid library molecule can be clonally amplified in-solution or on-support to generate an amplicon that can serve as a template molecule for sequencing. In some embodiments, a linear library molecule can be circularized to generate a circularized library molecule, and the circularized library molecule can be clonally amplified in-solution or on-support to generate a concatemer. In some embodiments, the concatemer can serve as a nucleic acid template molecule which can be sequenced. The concatemer is sometimes referred to as a polony. In some embodiments, a polony includes nucleotide strands.

The terms “peptide”, “polypeptide” and “protein” and other related terms used herein are used interchangeably and refer to a polymer of amino acids and are not limited to any particular length. Polypeptides may comprise natural and non-natural amino acids. Polypeptides include recombinant or chemically-synthesized forms. Polypeptides also include precursor molecules that have not yet been subjected to post-translation modification such as proteolytic cleavage, cleavage due to ribosomal skipping, hydroxylation, methylation, lipidation, acetylation, SUMOylation, ubiquitination, glycosylation, phosphorylation and/or disulfide bond formation. These terms encompass native and artificial proteins, protein fragments and polypeptide analogs (such as muteins, variants, chimeric proteins and fusion proteins) of a protein sequence as well as post-translationally, or otherwise covalently or non-covalently, modified proteins.

The term “polymerase” and its variants, as used herein, comprises any enzyme that can catalyze polymerization of nucleotides (including analogs thereof) into a nucleic acid strand. Typically but not necessarily such nucleotide polymerization can occur in a template-dependent fashion. Typically, a polymerase comprises one or more active sites at which nucleotide binding and/or catalysis of nucleotide polymerization can occur. In some embodiments, a polymerase includes other enzymatic activities, such as for example, 3′ to 5′ exonuclease activity or 5′ to 3′ exonuclease activity. In some embodiments, a polymerase has strand displacing activity. A polymerase can include without limitation naturally occurring polymerases and any subunits and truncations thereof, mutant polymerases, variant polymerases, recombinant, fusion or otherwise engineered polymerases, chemically modified polymerases, synthetic molecules or assemblies, and any analogs, derivatives or fragments thereof that retain the ability to catalyze nucleotide polymerization (e.g., catalytically active fragment). In some embodiments, a polymerase can be isolated from a cell, or generated using recombinant DNA technology or chemical synthesis methods. In some embodiments, a polymerase can be expressed in prokaryote, eukaryote, viral, or phage organisms. In some embodiments, a polymerase can be post-translationally modified proteins or fragments thereof. A polymerase can be derived from a prokaryote, eukaryote, virus or phage. A polymerase comprises DNA-directed DNA polymerase and RNA-directed DNA polymerase.

As used herein, the term “fidelity” refers to the accuracy of DNA polymerization by template-dependent DNA polymerase. The fidelity of a DNA polymerase is typically measured by the error rate (the frequency of incorporating an inaccurate nucleotide, i.e., a nucleotide that is not complementary to the template nucleotide). The accuracy or fidelity of DNA polymerization is maintained by both the polymerase activity and 3′-5′ exonuclease activity of a DNA polymerase.

As used herein, the term “binding complex” refers to a complex formed by binding together a nucleic acid duplex, a polymerase, and a free nucleotide or a nucleotide unit of a multivalent molecule, where the nucleic acid duplex comprises a nucleic acid template molecule hybridized to a nucleic acid primer. In the binding complex, the free nucleotide or nucleotide unit may or may not be bound to the 3′ end of the nucleic acid primer at a position that is opposite a complementary nucleotide in the nucleic acid template molecule. A “ternary complex” is an example of a binding complex which is formed by binding together a nucleic acid duplex, a polymerase, and a free nucleotide or nucleotide unit of a multivalent molecule, where the free nucleotide or nucleotide unit is bound to the 3′ end of the nucleic acid primer (as part of the nucleic acid duplex) at a position that is opposite a complementary nucleotide in the nucleic acid template molecule.

The term “persistence time” and related terms refers to the length of time that a binding complex remains stable without dissociation of any of the components, where the components of the binding complex include a nucleic acid template and nucleic acid primer, a polymerase, a nucleotide unit of a multivalent molecule or a free (e.g., unconjugated) nucleotide. The nucleotide unit or the free nucleotide can be complementary or non-complementary to a nucleotide residue in the template molecule. The nucleotide unit or the free nucleotide can bind to the 3′ end of the nucleic acid primer at a position that is opposite a complementary nucleotide residue in the nucleic acid template molecule. The persistence time is indicative of the stability of the binding complex and strength of the binding interactions. Persistence time can be measured by observing the onset and/or duration of a binding complex, such as by observing a signal from a labeled component of the binding complex. For example, a labeled nucleotide or a labeled reagent comprising one or more nucleotides may be present in a binding complex, thus allowing the signal from the label to be detected during the persistence time of the binding complex. One example label is a fluorescent label. The binding complex (e.g., ternary complex) remains stable until subjected to a condition that causes dissociation of interactions between any of the polymerase, template molecule, primer and/or the nucleotide unit or the nucleotide. For example, a dissociating condition comprises contacting the binding complex with any one or any combination of a detergent, EDTA and/or water.

The terms “nucleic acid”, “polynucleotide” and “oligonucleotide” and other related terms used herein are used interchangeably and refer to polymers of nucleotides and are not limited to any particular length. Nucleic acids include recombinant and chemically-synthesized forms. Nucleic acids include DNA molecules (e.g., cDNA or genomic DNA), RNA molecules (e.g., mRNA), analogs of the DNA or RNA generated using nucleotide analogs (e.g., peptide nucleic acids and non-naturally occurring nucleotide analogs), and chimeric forms containing DNA and RNA. Nucleic acids can be single-stranded or double-stranded. Nucleic acids comprise polymers of nucleotides, where the nucleotides include natural or non-natural bases and/or sugars. Nucleic acids comprise naturally-occurring internucleosidic linkages, for example phosphdiester linkages. Nucleic acids comprise non-natural internucleoside linkages, including phosphorothioate, phosphorothiolate, or peptide nucleic acid (PNA) linkages. In some embodiments, nucleic acids comprise a one type of polynucleotides or a mixture of two or more different types of polynucleotides.

The term “primer” and related terms used herein refers to an oligonucleotide, either natural or synthetic, that is capable of hybridizing with a DNA and/or RNA polynucleotide template to form a duplex molecule. Primers may have any length, but typically range from 4-50 nucleotides. A typical primer comprises a 5′ end and 3′ end. The 3′ end of the primer can include a 3′ OH moiety which serves as a nucleotide polymerization initiation site in a polymerase-mediated primer extension reaction. Alternatively, 3′ end of the primer can lack a 3′ OH moiety, or can include a terminal 3′ blocking group that inhibits nucleotide polymerization in a polymerase-mediated reaction. Any one nucleotide, or more than one nucleotide, along the length of the primer can be labeled with a detectable reporter moiety. A primer can be in solution (e.g., a soluble primer) or can be immobilized to a support (e.g., a capture primer).

The term “template nucleic acid”, “template polynucleotide”, “target nucleic acid” “target polynucleotide”, “template strand” and other variations refer to a nucleic acid strand that serves as the basis nucleic acid molecule for generating a complementary nucleic acid strand. The template nucleic acid can be single-stranded or double-stranded, or the template nucleic acid can have single-stranded or double-stranded portions. The sequence of the template nucleic acid can be partially or wholly complementary to the sequence of the complementary strand. The template nucleic acid can be obtained from a naturally-occurring source, recombinant form, or chemically synthesized to include any type of nucleic acid analog. The template nucleic acid can be linear, circular, or other forms. The template nucleic acids can include an insert region having an insert sequence which is also known as a sequence of interest. The template nucleic acids can also include at least one adaptor sequence. The template nucleic acid can be a concatemer having two or tandem copies of a sequence of interest and at least one adaptor sequence. The insert region can be isolated in any form, including chromosomal, genomic, organellar (e.g., mitochondrial, chloroplast or ribosomal), recombinant molecules, cloned, amplified, cDNA, RNA such as precursor mRNA or mRNA, oligonucleotides, whole genomic DNA, obtained from fresh frozen paraffin embedded tissue, needle biopsies, cell free circulating DNA, or any type of nucleic acid library. The insert region can be isolated from any source including from organisms such as prokaryotes, eukaryotes (e.g., humans, plants and animals), fungus, viruses cells, tissues, normal or diseased cells or tissues, body fluids including blood, urine, serum, lymph, tumor, saliva, anal and vaginal secretions, amniotic samples, perspiration, semen, environmental samples, culture samples, or synthesized nucleic acid molecules prepared using recombinant molecular biology or chemical synthesis methods. The insert region can be isolated from any organ, including head, neck, brain, breast, ovary, cervix, colon, rectum, endometrium, gallbladder, intestines, bladder, prostate, testicles, liver, lung, kidney, esophagus, pancreas, thyroid, pituitary, thymus, skin, heart, larynx, or other organs. The template nucleic acid can be subjected to nucleic acid analysis, including sequencing and composition analysis.

When used in reference to nucleic acid molecules, the terms “hybridize” or “hybridizing” or “hybridization” or other related terms refers to hydrogen bonding between two different nucleic acids to form a duplex nucleic acid. Hybridization also includes hydrogen bonding between two different regions of a single nucleic acid molecule to form a self-hybridizing molecule having a duplex region. Hybridization can comprise Watson-Crick or Hoogstein binding to form a duplex double-stranded nucleic acid, or a double-stranded region within a nucleic acid molecule. The double-stranded nucleic acid, or the two different regions of a single nucleic acid, may be wholly complementary, or partially complementary. Complementary nucleic acid strands need not hybridize with each other across their entire length. The complementary base pairing can be the standard A-T or C-G base pairing, or can be other forms of base-pairing interactions. Duplex nucleic acids can include mismatched base-paired nucleotides.

The term “nucleotides” and related terms refers to a molecule comprising an aromatic base, a five carbon sugar (e.g., ribose or deoxyribose), and at least one phosphate group. Canonical or non-canonical nucleotides are consistent with use of the term. The phosphate in some embodiments comprises a monophosphate, diphosphate, or triphosphate, or corresponding phosphate analog. In some embodiments, the nucleotide comprises 1, 2, 3, 4, 5, 6, 7, 8, 9 or 10 phosphate groups. The term “nucleoside” refers to a molecule comprising an aromatic base and a sugar.

Nucleotides (and nucleosides) typically comprise a hetero cyclic base including substituted or unsubstituted nitrogen-containing parent heteroaromatic ring which are commonly found in nucleic acids, including naturally-occurring, substituted, modified, or engineered variants, or analogs of the same. The base of a nucleotide (or nucleoside) is capable of forming Watson-Crick and/or Hoogstein hydrogen bonds with an appropriate complementary base. Example bases include, but are not limited to, purines and pyrimidines such as: 2-aminopurine, 2,6-diaminopurine, adenine (A), ethenoadenine, N⁶-Δ²-isopentenyladenine (6iA), N⁶-Δ²-isopentenyl-2-methylthioadenine (2ms6iA), N6-methyladenine, guanine (G), isoguanine, N²-dimethylguanine (dmG), 7-methylguanine (7 mG), 2-thiopyrimidine, 6-thioguanine (6sG), hypoxanthine and O⁶-methylguanine; 7-deaza-purines such as 7-deazaadenine (7-deaza-A) and 7-deazaguanine (7-deaza-G); pyrimidines such as cytosine (C), 5-propynylcytosine, isocytosine, thymine (T), 4-thiothymine (4sT), 5,6-dihydrothymine, O⁴-methylthymine, uracil (U), 4-thiouracil (4sU) and 5,6-dihydrouracil (dihydrouracil; D); indoles such as nitroindole and 4-methylindole; pyrroles such as nitropyrrole; nebularine; inosines; hydroxymethylcytosines; 5-methycytosines; base (Y); as well as methylated, glycosylated, and acylated base moieties; and the like. Additional example bases can be found in Fasman, 1989, in “Practical Handbook of Biochemistry and Molecular Biology”, pp. 385-394, CRC Press, Boca Raton, Fla.

Nucleotides (and nucleosides) typically comprise a sugar moiety, such as carbocyclic moiety (Ferraro and Gotor 2000 Chem. Rev. 100:4319-48), acyclic moieties (Martinez, et al., 1999 Nucleic Acids Research 27:1271-1274; Martinez, et al., 1997 Bioorganic & Medicinal Chemistry Letters vol. 7:3013-3016), and other sugar moieties (Joeng, et al., 1993 J. Med. Chem. 36:2627-2638; Kim, et al., 1993 J. Med. Chem. 36:30-7; Eschenmosser 1999 Science 284:2118-2124; and U.S. Pat. No. 5,558,991). The sugar moiety comprises: ribosyl; 2′-deoxyribosyl; 3′-deoxyribosyl; 2′,3′-dideoxyribosyl; 2′,3′-didehydrodideoxyribosyl; 2′-alkoxyribosyl; 2′-azidoribosyl; 2′-aminoribosyl; 2′-fluororibosyl; 2′-mercaptoriboxyl; 2′-alkylthioribosyl; 3′-alkoxyribosyl; 3′-azidoribosyl; 3′-aminoribosyl; 3′-fluororibosyl; 3′-mercaptoriboxyl; 3′-alkylthioribosyl carbocyclic; acyclic or other modified sugars.

In some embodiments, nucleotides comprise a chain of one, two or three phosphorus atoms where the chain is typically attached to the 5′ carbon of the sugar moiety via an ester or phosphoramide linkage. In some embodiments, the nucleotide is an analog having a phosphorus chain in which the phosphorus atoms are linked together with intervening O, S, NH, methylene or ethylene. In some embodiments, the phosphorus atoms in the chain include substituted side groups including O, S or BH₃. In some embodiments, the chain includes phosphate groups substituted with analogs including phosphoramidate, phosphorothioate, phosphordithioate, and O-methylphosphoroamidite groups.

When used in reference to nucleic acids, the terms “extend”, “extending”, “extension” and other variants, refers to incorporation of one or more nucleotides into a nucleic acid molecule. Nucleotide incorporation comprises polymerization of one or more nucleotides into the terminal 3′ OH end of a nucleic acid strand, resulting in extension of the nucleic acid strand. Nucleotide incorporation can be conducted with natural nucleotides and/or nucleotide analogs. Typically, but not necessarily, nucleotide incorporation occurs in a template-dependent fashion. Any suitable method of extending a nucleic acid molecule may be used, including primer extension catalyzed by a DNA polymerase or RNA polymerase.

The term “reporter moiety”, “reporter moieties” or related terms refers to a compound that generates, or causes to generate, a detectable signal. A reporter moiety is sometimes called a “label”. Any suitable reporter moiety may be used, including luminescent, photoluminescent, electroluminescent, bioluminescent, chemiluminescent, fluorescent, phosphorescent, chromophore, radioisotope, electrochemical, mass spectrometry, Raman, hapten, affinity tag, atom, or an enzyme. A reporter moiety generates a detectable signal resulting from a chemical or physical change (e.g., heat, light, electrical, pH, salt concentration, enzymatic activity, or proximity events). A proximity event includes two reporter moieties approaching each other, or associating with each other, or binding each other. It is well known to one skilled in the art to select reporter moieties so that each absorbs excitation radiation and/or emits fluorescence at a wavelength distinguishable from the other reporter moieties to permit monitoring the presence of different reporter moieties in the same reaction or in different reactions. Two or more different reporter moieties can be selected having spectrally distinct emission profiles, or having minimal overlapping spectral emission profiles. Reporter moieties can be linked (e.g., operably linked) to nucleotides, nucleosides, nucleic acids, enzymes (e.g., polymerases or reverse transcriptases), or support (e.g., surfaces).

A reporter moiety (or label) comprises a fluorescent label or a fluorophore. Example fluorescent moieties which may serve as fluorescent labels or fluorophores include, but are not limited to fluorescein and fluorescein derivatives such as carboxyfluorescein, tetrachlorofluorescein, hexachlorofluorescein, carboxynapthofluorescein, fluorescein isothiocyanate, NHS-fluorescein, iodoacetamidofluorescein, fluorescein maleimide, SAMSA-fluorescein, fluorescein thiosemicarbazide, carbohydrazinomethylthioacetyl-amino fluorescein, rhodamine and rhodamine derivatives such as TRITC, TMR, lissamine rhodamine, Texas Red, rhodamine B, rhodamine 6G, rhodamine 10, NHS-rhodamine, TMR-iodoacetamide, lissamine rhodamine B sulfonyl chloride, lissamine rhodamine B sulfonyl hydrazine, Texas Red sulfonyl chloride, Texas Red hydrazide, coumarin and coumarin derivatives such as AMCA, AMCA-NHS, AMCA-sulfo-NHS, AMCA-HPDP, DCIA, AMCE-hydrazide, BODIPY and derivatives such as BODIPY FL C3-SE, BODIPY 530/550 C3, BODIPY 530/550 C3-SE, BODIPY 530/550 C3 hydrazide, BODIPY 493/503 C3 hydrazide, BODIPY FL C3 hydrazide, BODIPY FL IA, BODIPY 530/551 IA, Br-BODIPY 493/503, Cascade Blue and derivatives such as Cascade Blue acetyl azide, Cascade Blue cadaverine, Cascade Blue ethylenediamine, Cascade Blue hydrazide, Lucifer Yellow and derivatives such as Lucifer Yellow iodoacetamide, Lucifer Yellow CH, cyanine and derivatives such as indolium based cyanine dyes, benzo-indolium based cyanine dyes, pyridium based cyanine dyes, thiozolium based cyanine dyes, quinolinium based cyanine dyes, imidazolium based cyanine dyes, Cy 3, Cy5, lanthanide chelates and derivatives such as BCPDA, TBP, TMT, BHHCT, BCOT, Europium chelates, Terbium chelates, Alexa Fluor dyes, DyLight dyes, Atto dyes, LightCycler Red dyes, CAL Flour dyes, JOE and derivatives thereof, Oregon Green dyes, WellRED dyes, IRD dyes, phycoerythrin and phycobilin dyes, Malachite green, stilbene, DEG dyes, NR dyes, near-infrared dyes and others known in the art such as those described in Haugland, Molecular Probes Handbook, (Eugene, Oreg.) 6th Edition; Lakowicz, Principles of Fluorescence Spectroscopy, 2nd Ed., Plenum Press New York (1999), or Hermanson, Bioconjugate Techniques, 2nd Edition, or derivatives thereof, or any combination thereof. Cyanine dyes may exist in either sulfonated or non-sulfonated forms, and consist of two indolenin, benzo-indolium, pyridium, thiozolium, and/or quinolinium groups separated by a polymethine bridge between two nitrogen atoms. Commercially available cyanine fluorophores include, for example, Cy3, (which may comprise 1-[6-(2,5-dioxopyrrolidin-1-yloxy)-6-oxohexyl]-2-(3-{1-[6-(2,5-dioxopyrrolidin-1-yloxy)-6-oxohexyl]-3,3-dimethyl-1,3-dihydro-2H-indol-2-ylidene}prop-1-en-1-yl)-3,3-dimethyl-3H-indolium or 1-[6-(2,5-dioxopyrrolidin-1-yloxy)-6-oxohexyl]-2-(3-{1-[6-(2,5-dioxopyrrolidin-1-yloxy)-6-oxohexyl]-3,3-dimethyl-5-sulfo-1,3-dihydro-2H-indol-2-ylidene}prop-1-en-1-yl)-3,3-dimethyl-3H-indolium-5-sulfonate), Cy5 (which may comprise 1-(6-((2,5-dioxopyrrolidin-1-yl)oxy)-6-oxohexyl)-2-((1E,3E)-5-((E)-1-(6-((2,5-dioxopyrrolidin-1-yl)oxy)-6-oxohexyl)-3,3-dimethyl-5-indolin-2-ylidene) penta-1,3-dien-1-yl)-3,3-dimethyl-3H-indol-1-ium or 1-(6-((2,5-dioxopyrrolidin-1-yl)oxy)-6-oxohexyl)-2-((1E,3E)-5-((E)-1-(6-((2,5-dioxopyrrolidin-1-yl)oxy)-6-oxohexyl)-3,3-dimethyl-5-sulfoindolin-2-ylidene) penta-1,3-dien-1-yl)-3,3-dimethyl-3H-indol-1-ium-5-sulfonate), and Cy7 (which may comprise 1-(5-carboxypentyl)-2-[(1E,3E,5E,7Z)-7-(1-ethyl-1,3-dihydro-2H-indol-2-ylidene) hepta-1,3,5-trien-1-yl]-3H-indolium or 1-(5-carboxypentyl)-2-[(1E,3E,5E,7Z)-7-(1-ethyl-5-sulfo-1,3-dihydro-2H-indol-2-ylidene) hepta-1,3,5-trien-1-yl]-3H-indolium-5-sulfonate), where “Cy” stands for ‘cyanine’, and the first digit identifies the number of carbon atoms between two indolenine groups. Cy2 which is an oxazole derivative rather than indolenin, and the benzo-derivatized Cy3.5, Cy5.5 and Cy7.5 are exceptions to this rule.

In some embodiments, the reporter moiety can be a FRET pair, such that multiple classifications can be performed under a single excitation and imaging step. As used herein, FRET may comprise excitation exchange (Forster) transfers, or electron-exchange (Dexter) transfers.

The terms “linked”, “joined”, “attached”, and variants thereof comprise any type of fusion, bond, adherence or association between any combination of compounds or molecules that is of sufficient stability to withstand use in the particular procedure. The procedure can include but are not limited to: nucleotide transient-binding; nucleotide incorporation; de-blocking; washing; removing; flowing; detecting; imaging and/or identifying. Such linkage can comprise, for example, covalent, ionic, hydrogen, dipole-dipole, hydrophilic, hydrophobic, or affinity bonding, bonds or associations involving van der Waals forces, mechanical bonding, and the like. In some embodiments, such linkage occurs intramolecularly, for example linking together the ends of a single-stranded or double-stranded linear nucleic acid molecule to form a circular molecule. In some embodiments, such linkage can occur between a combination of different molecules, or between a molecule and a non-molecule, including but not limited to: linkage between a nucleic acid molecule and a solid surface; linkage between a protein and a detectable reporter moiety; linkage between a nucleotide and detectable reporter moiety; and the like. Some examples of linkages can be found, for example, in Hermanson, G., “Bioconjugate Techniques”, Second Edition (2008); Aslam, M., Dent, A., “Bioconjugation: Protein Coupling Techniques for the Biomedical Sciences”, London: Macmillan (1998); Aslam, M., Dent, A., “Bioconjugation: Protein Coupling Techniques for the Biomedical Sciences”, London: Macmillan (1998).

The term “operably linked” and “operably joined” or related terms as used herein refers to juxtaposition of components. The juxtapositioned components can be linked together covalently. For example, two nucleic acid components can be enzymatically ligated together where the linkage that joins together the two components comprises phosphodiester linkage. A first and second nucleic acid component can be linked together, where the first nucleic acid component can confer a function on a second nucleic acid component. For example, linkage between a primer binding sequence and a sequence of interest forms a nucleic acid library molecule having a portion that can bind to a primer. In another example, a transgene (e.g., a nucleic acid encoding a polypeptide or a nucleic acid sequence of interest) can be ligated to a vector where the linkage permits expression or functioning of the transgene sequence contained in the vector. In some embodiments, a transgene is operably linked to a host cell regulatory sequence (e.g., a promoter sequence) that affects expression of the transgene. In some embodiments, the vector comprises at least one host cell regulatory sequence, including a promoter sequence, enhancer, transcription and/or translation initiation sequence, transcription and/or translation termination sequence, polypeptide secretion signal sequences, and the like. In some embodiments, the host cell regulatory sequence controls expression of the level, timing and/or location of the transgene.

The term “adaptor” and related terms refers to oligonucleotides that can be operably linked (appended) to a target polynucleotide, where the adaptor confers a function to the co-joined adaptor-target molecule. Adaptors comprise DNA, RNA, chimeric DNA/RNA, or analogs thereof. Adaptors can include at least one ribonucleoside residue. Adaptors can be single-stranded, double-stranded, or have single-stranded and/or double-stranded portions. Adaptors can be configured to be linear, stem-looped, hairpin, or Y-shaped forms. Adaptors can be any length, including 4-100 nucleotides or longer. Adaptors can have blunt ends, overhang ends, or a combination of both. Overhang ends include 5′ overhang and 3′ overhang ends. The 5′ end of a single-stranded adaptor, or one strand of a double-stranded adaptor, can have a 5′ phosphate group or lack a 5′ phosphate group. Adaptors can include a 5′ tail that does not hybridize to a target polynucleotide (e.g., tailed adaptor), or adaptors can be non-tailed. An adaptor can include a sequence that is complementary to at least a portion of a primer, such as an amplification primer, a sequencing primer, or a capture primer (e.g., soluble or immobilized capture primers). Adaptors can include a random sequence or degenerate sequence. Adaptors can include at least one inosine residue. Adaptors can include at least one phosphorothioate, phosphorothiolate and/or phosphoramidate linkage. Adaptors can include a barcode sequence which can be used to distinguish polynucleotides (e.g., insert sequences) from different sample sources in a multiplex assay. Adaptors can include a unique identification sequence (e.g., unique molecular index, UMI; or a unique molecular tag) that can be used to uniquely identify a nucleic acid molecule to which the adaptor is appended. In some embodiments, a unique identification sequence can be used to increase error correction and accuracy, reduce the rate of false-positive variant calls and/or increase sensitivity of variant detection. Adaptors can include at least one restriction enzyme recognition sequence, including any one or any combination of two or more selected from a group consisting of type I, type II, type III, type IV, type Hs or type IIB.

The term “universal sequence”, “universal adaptor sequences” and related terms refers to a sequence in a nucleic acid molecule that is common among two or more polynucleotide molecules. For example, adaptors having the same universal sequence can be joined to a plurality of polynucleotides so that the population of co-joined molecules carry the same universal adaptor sequence. Examples of universal adaptor sequences include an amplification primer sequence, a sequencing primer sequence or a capture primer sequence (e.g., soluble or support-immobilized capture primers).

In some embodiments, the support is solid, semi-solid, or a combination of both. In some embodiments, the support is porous, semi-porous, non-porous, or any combination of porosity. In some embodiments, the support can be substantially planar, concave, convex, or any combination thereof. In some embodiments, the support can be cylindrical, for example comprising a capillary or interior surface of a capillary.

In some embodiments, the surface of the support can be substantially smooth. In some embodiments, the support can be regularly or irregularly textured, including bumps, etched, pores, three-dimensional scaffolds, or any combination thereof.

In some embodiments, the support comprises a bead having any shape, including spherical, hemi-spherical, cylindrical, barrel-shaped, toroidal, disc-shaped, rod-like, conical, triangular, cubical, polygonal, tubular or wire-like.

The support can be fabricated from any material, including but not limited to glass, fused-silica, silicon, a polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET)), or any combination thereof. Various compositions of both glass and plastic substrates are contemplated.

In some embodiments, the surface of the support is coated with one or more compounds to produce a passivated layer on the support. In some embodiments, the support comprises a low non-specific binding surface that enable improved nucleic acid hybridization and amplification performance on the support. In general, the support may comprise one or more layers of a covalently or non-covalently attached low-binding, chemical modification layers, e.g., silane layers, polymer films, and one or more covalently or non-covalently attached oligonucleotides that may be used for immobilizing a plurality of nucleic acid template molecules to the support.

In some embodiments, the degree of hydrophilicity (or “wettability” with aqueous solutions) of the surface coatings may be assessed, for example, through the measurement of water contact angles in which a small droplet of water is placed on the surface and its angle of contact with the surface is measured using, e.g., an optical tensiometer. In some embodiments, a static contact angle may be determined. In some embodiments, an advancing or receding contact angle may be determined. In some embodiments, the water contact angle for the hydrophilic, low-binding support surfaced disclosed herein may range from about 0 degrees to about 30 degrees. In some embodiments, the water contact angle for the hydrophilic, low-binding support surfaced disclosed herein may no more than 50 degrees, 40 degrees, 30 degrees, 25 degrees, 20 degrees, 18 degrees, 16 degrees, 14 degrees, 12 degrees, 10 degrees, 8 degrees, 6 degrees, 4 degrees, 2 degrees, or 1 degree. In many cases the contact angle is no more than 40 degrees. Those of skill in the art will realize that a given hydrophilic, low-binding support surface of the present disclosure may exhibit a water contact angle having a value of anywhere within this range.

The present disclosure provides a plurality (e.g., two or more) of nucleic acid templates immobilized to a support. In some embodiments, the immobilized plurality of nucleic acid templates have the same sequence or have different sequences. In some embodiments, individual nucleic acid template molecules in the plurality of nucleic acid templates are immobilized to a different site on the support. In some embodiments, two or more individual nucleic acid template molecules in the plurality of nucleic acid templates are immobilized to a site on the support. In some embodiments, the support comprises a plurality of sites arranged in an array. The term “array” refers to a support comprising a plurality of sites located at pre-determined locations on the support to form an array of sites. The sites can be discrete and separated by interstitial regions. In some embodiments, the pre-determined sites on the support can be arranged in one dimension in a row or a column, or arranged in two dimensions in rows and columns. In some embodiments, the plurality of pre-determined sites is arranged on the support in an organized fashion. In some embodiments, the plurality of pre-determined sites is arranged in any organized pattern, including rectilinear, hexagonal patterns, grid patterns, patterns having reflective symmetry, patterns having rotational symmetry, or the like. The pitch between different pairs of sites can be that same or can vary. In some embodiments, the support can have nucleic acid template molecules immobilized at a plurality of sites at a surface density of about 10²-10¹⁵ sites per mm², or more, to form a nucleic acid template array. In some embodiments, the support comprises at least 10² sites, at least 10³ sites, at least 10⁴ sites, at least 10⁵ sites, at least 10⁶ sites, at least 10⁷ sites, at least 10⁸ sites, at least 10⁹ sites, at least 10¹⁰ sites, at least 10¹¹ sites, at least 10¹² sites, at least 10¹³ sites, at least 10¹⁴ sites, at least 10¹⁵ sites, or more, where the sites are located at pre-determined locations on the support. In some embodiments, a plurality of pre-determined sites on the support (e.g., 10²-10¹⁵ sites or more) are immobilized with nucleic acid templates to form a nucleic acid template array. In some embodiments, the nucleic acid templates that are immobilized at a plurality of pre-determined sites by hybridization to immobilized surface capture primers, or the nucleic acid templates are covalently attached to the surface capture primers. In some embodiments, the nucleic acid templates that are immobilized at a plurality of pre-determined sites, for example immobilized at 10²-10¹⁵ sites or more. In some embodiments, the nucleic acid templates that are immobilized at a plurality of sites on the support comprise linear or circular nucleic acid template molecules or a mixture of both linear and circular molecules. In some embodiments, the immobilized nucleic acid templates are clonally-amplified to generate immobilized nucleic acid polonies at the plurality of pre-determined sites. In some embodiments, individual immobilized nucleic acid template molecules comprise one copy of a target sequence of interest, or comprise concatemers having two or more tandem copies of a target sequence of interest.

In some embodiments, a support comprising a plurality of sites located at random locations on the support is referred to herein as a support having randomly located sites thereon. The location of the randomly located sites on the support are not pre-determined. The plurality of randomly-located sites is arranged on the support in a disordered and/or unpredictable fashion. In some embodiments, the support comprises at least 10² sites, at least 10³ sites, at least 10⁴ sites, at least 10⁵ sites, at least 10⁶ sites, at least 10⁷ sites, at least 10⁸ sites, at least 10⁹ sites, at least 10¹⁰ sites, at least 10¹¹ sites, at least 10¹² sites, at least 10¹³ sites, at least 10¹⁴ sites, at least 10¹⁵ sites, or more, where the sites are randomly located on the support. In some embodiments, a plurality of randomly located sites on the support (e.g., 10²-10¹⁵ sites or more) are immobilized with nucleic acid templates to form a support immobilized with nucleic acid templates. In some embodiments, the nucleic acid templates that are immobilized at a plurality of randomly located sites by hybridization to immobilized surface capture primers, or the nucleic acid templates are covalently attached to the surface capture primer. In some embodiments, the nucleic acid templates that are immobilized at a plurality of randomly located sites, for example immobilized at 10²-10¹⁵ sites or more. In some embodiments, the nucleic acid templates that are immobilized at a plurality of sites on the support comprise linear or circular nucleic acid template molecules or a mixture of both linear and circular molecules. In some embodiments, the immobilized nucleic acid templates are clonally-amplified to generate immobilized nucleic acid polonies at the plurality of randomly located sites. In some embodiments, individual immobilized nucleic acid template molecules comprise one copy of a target sequence of interest, or comprise concatemers having two or more tandem copies of a target sequence of interest.

In some embodiments, with respect to nucleic acid template molecules immobilized to pre-determined or random sites on the support, the plurality of immobilized nucleic acid template molecules on the support are in fluid communication with each other to permit flowing a solution of reagents (e.g., enzymes including polymerases, multivalent molecules, nucleotides, divalent cations and/or buffers and the like) onto the support so that the plurality of immobilized nucleic acid template molecules on the support can be reacted with the reagents in a massively parallel manner. In some embodiments, the fluid communication of the plurality of immobilized nucleic acid template molecules can be used to conduct nucleotide binding assays and/or conduct nucleotide polymerization reactions (e.g., primer extension or sequencing) on the plurality of immobilized nucleic acid template molecules, and to conduct detection and imaging for massively parallel sequencing. In some embodiments, the term “immobilized” and related terms refer to nucleic acid molecules or enzymes (e.g., polymerases) that are attached to the support at pre-determined or random locations, where the nucleic acid molecules or enzymes are attached directly to a support through covalent bond or non-covalent interaction, or the nucleic acid molecules or enzymes are attached to a coating on the support.

When used in reference to a low binding surface coating, one or more layers of a multi-layered surface coating may comprise a branched polymer or may be linear. Examples of suitable branched polymers include, but are not limited to, branched PEG, branched poly(vinyl alcohol) (branched PVA), branched poly(vinyl pyridine), branched poly(vinyl pyrrolidone) (branched PVP), branched), poly(acrylic acid) (branched PAA), branched polyacrylamide, branched poly(N-isopropylacrylamide) (branched PNIPAM), branched poly(methyl methacrylate) (branched PMA), branched poly(2-hydroxylethyl methacrylate) (branched PHEMA), branched poly(oligo (ethylene glycol) methyl ether methacrylate) (branched POEGMA), branched polyglutamic acid (branched PGA), branched poly-lysine, branched poly-glucoside, and dextran.

In some embodiments, the branched polymers used to create one or more layers of any of the multi-layered surfaces disclosed herein may comprise at least 4 branches, at least 5 branches, at least 6 branches, at least 7 branches, at least 8 branches, at least 9 branches, at least 10 branches, at least 12 branches, at least 14 branches, at least 16 branches, at least 18 branches, at least 20 branches, at least 22 branches, at least 24 branches, at least 26 branches, at least 28 branches, at least 30 branches, at least 32 branches, at least 34 branches, at least 36 branches, at least 38 branches, or at least 40 branched.

Linear, branched, or multi-branched polymers used to create one or more layers of any of the multi-layered surfaces disclosed herein may have a molecular weight of at least 500, at least 1,000, at least 2,000, at least 3,000, at least 4,000, at least 5,000, at least 10,000, at least 15,000, at least 20,000, at least 25,000, at least 30,000, at least 35,000, at least 40,000, at least 45,000, or at least 50,000 daltons.

In some embodiments, e.g., wherein at least one layer of a multi-layered surface comprises a branched polymer, the number of covalent bonds between a branched polymer molecule of the layer being deposited and molecules of the previous layer may range from about one covalent linkage per molecule and about 32 covalent linkages per molecule. In some embodiments, the number of covalent bonds between a branched polymer molecule of the new layer and molecules of the previous layer may be at least 1, at least 2, at least 3, at least 4, at least 5, at least 6, at least 7, at least 8, at least 9, at least 10, at least 12, at least 14, at least 16, at least 18, at least 20, at least 22, at least 24, at least 26, at least 28, at least 30, or at least 32 covalent linkages per molecule.

Any reactive functional groups that remain following the coupling of a material layer to the surface may optionally be blocked by coupling a small, inert molecule using a high yield coupling chemistry. For example, in the case that amine coupling chemistry is used to attach a new material layer to the previous one, any residual amine groups may subsequently be acetylated or deactivated by coupling with a small amino acid such as glycine.

The number of layers of low non-specific binding material, e.g., a hydrophilic polymer material, deposited on the surface, may range from 1 to about 10. In some embodiments, the number of layers is at least 1, at least 2, at least 3, at least 4, at least 5, at least 6, at least 7, at least 8, at least 9, or at least 10. In some embodiments, the number of layers may be at most 10, at most 9, at most 8, at most 7, at most 6, at most 5, at most 4, at most 3, at most 2, or at most 1. Any of the lower and upper values described in this paragraph may be combined to form a range included within the present disclosure, for example, in some embodiments the number of layers may range from about 2 to about 4. In some embodiments, all of the layers may comprise the same material. In some embodiments, each layer may comprise a different material. In some embodiments, the plurality of layers may comprise a plurality of materials. In some embodiments at least one layer may comprise a branched polymer. In some embodiment, all of the layers may comprise a branched polymer.

One or more layers of low non-specific binding material may in some cases be deposited on and/or conjugated to the substrate surface using a polar protic solvent, a polar or polar aprotic solvent, a nonpolar solvent, or any combination thereof. In some embodiments the solvent used for layer deposition and/or coupling may comprise an alcohol (e.g., methanol, ethanol, propanol, etc.), another organic solvent (e.g., acetonitrile, dimethyl sulfoxide (DMSO), dimethyl formamide (DMF), etc.), water, an aqueous buffer solution (e.g., phosphate buffer, phosphate buffered saline, 3-(N-morpholino) propanesulfonic acid (MOPS), etc.), or any combination thereof. In some embodiments, an organic component of the solvent mixture used may comprise at least 1%, 5%, 10%, 15%, 20%, 25%, 30%, 35%, 40%, 45%, 50%, 55%, 60%, 70%, 75%, 80%, 85%, 90%, 95%, 98%, or 99% of the total, with the balance made up of water or an aqueous buffer solution. In some embodiments, an aqueous component of the solvent mixture used may comprise at least 1%, 5%, 10%, 15%, 20%, 25%, 30%, 35%, 40%, 45%, 50%, 55%, 60%, 70%, 75%, 80%, 85%, 90%, 95%, 98%, or 99% of the total, with the balance made up of an organic solvent. The pH of the solvent mixture used may be less than 6, about 6, 6.5, 7, 7.5, 8, 8.5, 9, or greater than pH 9.

The term “branched polymer” and related terms refers to a polymer having a plurality of functional groups that help conjugate a biologically active molecule such as a nucleotide, and the functional group can be either on the side chain of the polymer or directly attaches to a central core or central backbone of the polymer. The branched polymer can have linear backbone with one or more functional groups coming off the backbone for conjugation. The branched polymer can also be a polymer having one or more sidechains, wherein the side chain has a site suitable for conjugation. Examples of the functional group include but are limited to hydroxyl, ester, amine, carbonate, acetal, aldehyde, aldehyde hydrate, alkenyl, acrylate, methacrylate, acrylamide, active sulfone, hydrazide, thiol, alkanoic acid, acid halide, isocyanate, isothiocyanate, maleimide, vinylsulfone, dithiopyridine, vinylpyridine, iodoacetamide, epoxide, glyoxal, dione, mesylate, tosylate, and tresylate.

As used herein, the term “clonally amplified” and it variants refers to a nucleic acid template molecule that has been subjected to one or more amplification reactions either in-solution or on-support. In the case of in-solution amplified template molecules, the resulting amplicons are distributed onto the support. Prior to amplification, the template molecule comprises a sequence of interest and at least one universal adaptor sequence. In some embodiments, clonal amplification comprises the use of a polymerase chain reaction (PCR), multiple displacement amplification (MDA), transcription-mediated amplification (TMA), nucleic acid sequence-based amplification (NASBA), strand displacement amplification (SDA), real-time SDA, bridge amplification, isothermal bridge amplification, rolling circle amplification (RCA), circle-to-circle amplification, helicase-dependent amplification, recombinase-dependent amplification, single-stranded binding (SSB) protein-dependent amplification, or any combination thereof.

As used herein, the term “sequencing” and its variants comprise obtaining sequence information from a nucleic acid strand, typically by determining the identity of at least some nucleotides (including their nucleobase components) within the nucleic acid template molecule. While in some embodiments, “sequencing” a given region of a nucleic acid molecule includes identifying each and every nucleotide within the region that is sequenced, in some embodiments “sequencing” comprises methods whereby the identity of only some of the nucleotides in the region is determined, while the identity of some nucleotides remains undetermined or incorrectly determined. Any suitable method of sequencing may be used. In an example embodiment, sequencing can include label-free or ion based sequencing methods. In some embodiments, sequencing can include labeled or dye-containing nucleotide or fluorescent based nucleotide sequencing methods. In some embodiments, sequencing can include polony-based sequencing or bridge sequencing methods. In some embodiments, sequencing includes massively parallel sequencing platforms that employ sequence-by-synthesis, sequence-by-hybridization or sequence-by-binding procedures. Examples of massively parallel sequence-by-synthesis procedures include polony sequencing, pyrosequencing (e.g., from 454 Life Sciences; U.S. Pat. Nos. 7,211,390, 7,244,559 and 7,264,929), chain-terminator sequencing (e.g., from Illumina; U.S. Pat. No. 7,566,537; Bentley 2006 Current Opinion Genetics and Development 16:545-552; and Bentley, et al., 2008 Nature 456:53-59, ion-sensitive sequencing (e.g., from Ion Torrent), probe-anchor ligation sequencing (e.g., Complete Genomics), DNA nanoball sequencing, nanopore DNA sequencing. Examples of single molecule sequencing include Heliscope single molecule sequencing, and single molecule real time (SMRT) sequencing from Pacific Biosciences (Levene, et al., 2003 Science 299 (5607): 682-686; Eid, et al., 2009 Science 323 (5910): 133-138; U.S. Pat. Nos. 7,170,050; 7,302,146; and 7,405,281). An example of sequence-by-hybridization includes SOLiD sequencing (e.g., from Life Technologies; WO 2006/084132). An example of sequence-by-binding includes Omniome sequencing (e.g., U.S. Pat. No. 10,246,744).

### In Situ Sequencing

In some embodiments of the methods described herein, the flow cell images can be acquired or generated from 2D or 3D samples. In some embodiments with 3D cellular sample(s), the RNA is not extracted from the cellular sample and sequencing information does not need to be tracked and mapped back to an image of the cellular sample. Rather, RNA may be retained inside the cellular sample to permit direct imaging of the spatial location of target RNAs within the cells. Additionally, RNA within the cellular sample may not be fragmented and enrichment of target RNA is not necessary. Use of target-specific and/or random-sequence reverse transcription primers enables detection of both poly-A and non-poly-A RNAs in either uni-plex or multi-plex modes.

In some embodiments, the methods comprise repeatedly conducting a short number of sequencing cycles of the same region of the template molecules (e.g., concatemer molecules). By conducting reiterative short sequencing cycles, the RNA content of the cellular sample can be discovered. Compared to long read sequencing workflows, the reiterative short sequencing cycles described herein use a reduced amount of sequencing reagents which reduces cost and saves time. Methods for conducting reiterative short sequencing cycles has many uses including but not limited to detecting specific RNAs of interest, mutant RNA sequences, splice variants, and their abundance levels thereof.

The concatemers carry tandem repeat units of a cDNA-of-interest, the universal sequencing primer binding site, and the target barcode sequence. The concatemers are sequenced inside the cellular sample where a short number of sequencing cycles are conducted for each round and multiple rounds of short read sequencing is conducted. The full length of the target barcode and cDNA region are not sequenced. Instead, at least a portion of the target barcode region is reiteratively sequenced. In some embodiments, it is not necessary to sequence the cDNA region. In some embodiments, the target barcode and a portion of the cDNA region are reiteratively sequenced. It is not necessary to sequence the entire length of the cDNA region. It is not necessary to assemble the sequencing reads or to obtain a full length sequence of the cDNAs-of-interest. The redundant sequencing information obtained from the short sequencing reads obviates the need to sequence the complementary strand of the concatemer. Thus pairwise sequencing is not necessary.

Additionally, a short portion of the cDNA region in the concatemer is re-sequenced at least once (e.g., reiterative sequencing) from the same start position to generate overlapping sequencing reads that can be aligned to a reference sequence. For example, the same portion of the concatemer molecule can be sequenced at least two, three, four, five, or up to 50 times. The start sequencing site can be any location of the concatemer and is dictated by the sequencing primers which are designed to anneal to a selected position within the concatemer. The reiterative short sequencing reads increase the redundancy of sequencing information for individual bases in the cDNA region. Reiteratively sequencing one strand of the concatemer template molecule provides enough base coverage to reveal the presence of target RNAs in the cellular sample so that pairwise sequencing of the complementary strand is not necessary.

A concatemer template molecule includes multiple sequencing primer binding sites along the same concatemer molecule which can be used to generate multiple usable sequencing reads for increased sequencing depth. Together, reiteratively sequencing one strand of the concatemer templates increases sequencing base coverage and sequencing depth compared to sequencing a one-copy template molecule.

The methods of conducting sequencing reactions described herein can be conducted in uni-plex or multi-plex modes. Two or more different target RNAs can be detected and imaged simultaneously inside a cellular sample using different reverse transcription primers, different target-specific padlock probes, and universal sequencing primers. For example, the presence of a housekeeping RNA and at least one target RNA in a cellular sample can be simultaneously detected and imaged using any of the reiterative short read sequencing methods described herein.

Embodiments of the present disclosure provide methods for conducting sequencing reactions that detects in situ at least two different target RNA molecules in a cellular sample comprising step (a): providing a cellular sample harboring a plurality of RNA which comprises at least a first target RNA molecule and a second target RNA molecule. In some embodiments, the cellular sample is fixed and permeabilized. In some embodiments, the cellular sample harbors 2-25 different target RNA molecules, or harbors 25-50 different target RNA molecules, or harbors 50-75 different target RNA molecules, or harbors 75-100 different target RNA molecules. In some embodiments, the cellular sample harbors more than 100 different target RNA molecules, or more than 250 different target RNA molecules, or more than 500 different target molecules, or more than 1000 different target RNA molecules, or more. In some embodiments, the cellular sample harbors more than 10,000 different target RNA molecules. In some embodiments, the cellular sample comprises a whole cell, a plurality of whole cells, an intact tissue or an intact tumor. In some embodiments, the cellular sample comprises a fresh cellular sample, a freshly-frozen cellular sample, a sectioned cellular sample, an FFPE cellular sample, or a sectioned FFPE cellular sample. In some embodiments, the cellular sample is deposited onto a solid support. In some embodiments, the cellular sample is deposited onto a solid support which is passivated with a coating that promotes cell adhesion. In some embodiments, the cellular sample is deposited on a support that lacks immobilized capture oligonucleotides. In some embodiments, the cellular sample is cultured before or after depositing the cellular sample onto the solid support. In some embodiments, the cellular sample is cultured prior to conducting step (b) which is described below. In some embodiments, the cellular sample comprises an expanded cellular sample that has been cultured in a simple or complex cell culture media. In some embodiments, the cellular sample is not cultured or expanded prior to conducting step (b).

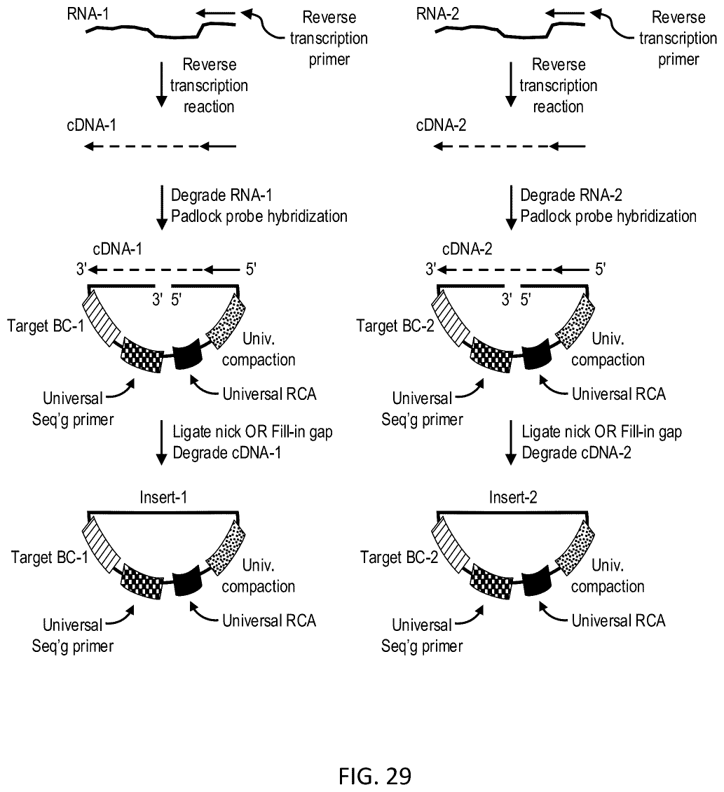

In some embodiments, methods for conducting sequencing reactions that detects in situ at least two different target RNA molecules in a cellular sample further comprise step (b): generating inside the cellular sample a plurality of cDNA molecules which include at least a first target cDNA molecule that corresponds to the first target RNA molecule, and the plurality of cDNA molecules includes a second target cDNA molecule that corresponds to the second target RNA molecule. In some embodiments, the method comprises generating at least 2-10,000 different target cDNA molecules that correspond to 2-10,000 different target RNA molecules. In some embodiments, the generating of step (b) comprises contacting the plurality of RNA inside the cellular sample with (i) a plurality of reverse transcription primers, (ii) a plurality of reverse transcriptase enzymes, and (iii) a plurality of nucleotides, under a condition suitable for conducting a reverse transcription reaction to generate a plurality of cDNA molecules (e.g., a plurality of first strand cDNA molecules) in the cellular sample (e.g., FIG. 29).

In some embodiments, the plurality of reverse transcription primers comprises a first sub-population of target-specific reverse transcription primers that hybridize selectively to the first target RNA, and comprises a second sub-population of target-specific reverse transcription primers that hybridize selectively to the second target RNA. In some embodiments, the first and second sub-population of target-specific reverse transcription primers have the same sequence or different sequences.

In some embodiments, the entire length of the first sub-population of target-specific reverse transcription primers hybridize to a first target RNA molecule. In some embodiments, the first sub-population of target-specific reverse transcription primers comprise tailed primers having a portion that hybridizes to a first target RNA molecule and a portion that does not hybridize to a first target RNA molecule. In some embodiments, the first sub-population of target-specific reverse transcription primers comprise at least a portion having a poly-T sequence. In some embodiments, the first sub-population of target-specific reverse transcription primers comprise at least a portion having a random sequence and/or at least a portion having a target-specific sequence.

In some embodiments, the entire length of the second sub-population of target-specific reverse transcription primers hybridize to a second target RNA molecule. In some embodiments, the second sub-population of target-specific reverse transcription primers comprise tailed primers having a portion that hybridizes to a second target RNA molecule and a portion that does not hybridize to a second target RNA molecule. In some embodiments, the second sub-population of target-specific reverse transcription primers comprise at least a portion having a poly-T sequence. In some embodiments, the second sub-population of target-specific reverse transcription primers comprise at least a portion having a random sequence and/or at least a portion having a target-specific sequence.

In some embodiments, a target RNA molecule that is hybridized to a cDNA molecule can be subjected to enzymatic degradation using a ribonuclease under a condition suitable for degrading RNA in an RNA/DNA duplex. In some embodiments, a target RNA molecule that is hybridized to a cDNA molecule is not subjected to enzymatic degradation.

In some embodiments, methods for conducting sequencing reactions that detects in situ at least two different target RNA molecules in a cellular sample further comprise step (c): contacting the plurality of cDNA molecules in the cellular sample with a plurality of target-specific padlock probes which includes at least a first plurality of target-specific padlock probes and a second plurality of target-specific padlock probes. In some embodiments, the method comprises contacting the plurality of cDNA molecule in the cellular sample with at least 2-10,000 different target-specific padlock probes.

In an alternative embodiment, cDNA is not generated from RNA inside the cellular sample. In some embodiments, methods for detecting at least two different target RNA molecules in a cellular sample further comprise contacting RNA inside the cell with a plurality of target-specific padlock probes and generating circularized padlock probes. In some embodiments, methods for detecting at least two different target RNA molecules in a cellular sample further comprise step (c): contacting the plurality of RNA molecules in the cellular sample with a plurality of target-specific padlock probes which includes at least a first plurality of target-specific padlock probes and a second plurality of target-specific padlock probes. In some embodiments, the method comprises contacting the plurality of cDNA molecule in the cellular sample with at least 2-10,000 different target-specific padlock probes. In some embodiments, a target RNA molecule can be subjected to enzymatic degradation using a ribonuclease. In some embodiments, a target RNA molecule is not subjected to enzymatic degradation.

In some embodiments, individual padlock probes in the plurality of first target-specific padlock probes comprise first and second terminal regions (e.g., first and second padlock binding arms), wherein the first terminal region selectively hybridizes to a first region of the first target cDNA molecule (or the first target RNA molecule), and the second terminal region selectively hybridizes to a second region of the first target cDNA molecule (or the first target RNA molecule). In some embodiments, the contacting of step (c) comprises: hybridizing the first and second terminal regions of the first target-specific padlock probes to proximal positions on the first target cDNA molecule (or the first target RNA molecule) to form a circularized first target-specific padlock probe having a nick or gap between the hybridized first and second terminal regions (e.g., FIG. 29, left). In some embodiments, the first target-specific padlock probe comprises a first target barcode sequence (target BC-1) that corresponds to and uniquely identifies the first target cDNA sequence (or the first target RNA sequence). In some embodiments, the first target-specific padlock probe comprises a first target barcode sequence that is located adjacent to one of the regions of the first target-specific padlock probe that selectively hybridizes to the first target cDNA molecule (or the first target RNA sequence). In some embodiments, the first target-specific padlock probe comprises at least one universal adaptor sequence, such as for example a universal sequencing primer binding site (or a complementary sequence thereof). In some embodiments, the first target-specific padlock probe comprises a universal primer binding site for a rolling circle amplification primer (or a complementary sequence thereof). In some embodiments, the first target-specific padlock probe comprises a universal compaction oligonucleotide binding site (or a complementary sequence thereof).

FIG. 29 is a schematic showing a workflow for generating inside a cell circularized padlock probes according to some embodiments, comprising generating first and second cDNAs from first and second target RNA molecules (respectively), hybridizing first and second padlock probes to the first and second cDNA molecules (respectively) to generate first and second circularized padlock probes (respectively). The first padlock probe comprises (i) a first target barcode sequence (target BC-1) that uniquely identifies the first target RNA or the first target cDNA, (ii) a first sequencing primer binding site (or a complementary sequence thereof), (iii) a universal binding site for an amplification primer (universal RCA) (or a complementary sequence thereof), and (iv) a universal binding site for a compaction oligonucleotide (or a complementary sequence thereof). The second padlock probe comprises (i) a second target barcode sequence (target BC-2) that uniquely identifies the second target RNA or the second target cDNA, (ii) a second sequencing primer binding site (or a complementary sequence thereof), (iii) a universal binding site for an amplification primer (universal RCA) (or a complementary sequence thereof), and (iv) a universal binding site for a compaction oligonucleotide (or a complementary sequence thereof).

In some embodiments, individual padlock probes in the plurality of second target-specific padlock probes comprise first and second terminal regions (e.g., first and second padlock binding arms), wherein the first terminal region selectively hybridizes to a first region of the second target cDNA molecule (or the second target RNA molecule), and the second terminal region selectively hybridizes to a second region of the second target cDNA molecule (or the second target RNA molecule). In some embodiments, the contacting of step (c) comprises: hybridizing the first and second terminal regions of the second target-specific padlock probes to proximal positions on the second target cDNA molecule (or the second target RNA molecule) to form a circularized second target-specific padlock probe having a nick or gap between the hybridized first and second terminal regions (e.g., FIG. 29, right). In some embodiments, the second target-specific padlock probe comprises a second target barcode sequence (target BC-2) that corresponds to and uniquely identifies the second target cDNA sequence (or the second target RNA sequence). In some embodiments, the second target-specific padlock probe comprises a second target barcode sequence that is located adjacent to one of the regions of the second target-specific padlock probe that selectively hybridizes to the second target cDNA molecule (or the second target RNA sequence). In some embodiments, the second target-specific padlock probe comprises at least one universal adaptor sequence, such as for example a universal sequencing primer binding site (or a complementary sequence thereof). In some embodiments, the second target-specific padlock probe comprises a universal primer binding site for a rolling circle amplification primer (or a complementary sequence thereof). In some embodiments, the second target-specific padlock probe comprises a universal compaction oligonucleotide binding site (or a complementary sequence thereof).

In some embodiments, the first target barcode sequence (target BC-1) and the second target barcode sequence (target BC-2) have different sequences and can be used to conduct multiplex RNA detection and sequencing. In some embodiments, the first target barcode sequence (target BC-1) and the second target barcode sequence (target BC-2) have the same sequence and can be used to conduct uni-plex RNA detection and sequencing.

In some embodiments, the first and second target-specific padlock probes comprise a universal sequencing primer binding site and a target barcode sequence that are adjacent to each other so that the target barcode region of the concatemer is sequenced first. The target barcode sequence can be any length, for example 3-15 bases, or 15-25 bases, or 25-40 bases, or longer.

In some embodiments, methods for conducting sequencing reactions that detects in situ at least two different target RNA molecules in a cellular sample further comprising step (d): closing the nick or gap in the at least first and second circularized target-specific padlock probes by conducting an enzymatic reaction, thereby generating at least a first covalently closed circular padlock probe and a second covalently closed circular padlock probe inside the cellular sample. In some embodiments, the closing the nick in the first and second circularized padlock probes comprises conducting an enzymatic ligation reaction. In some embodiments, closing the gap in the first and second circularized padlock probes comprises conducting a polymerase-catalyzed fill-in reaction using the first or second target cDNA molecule (or the first or second RNA molecule) as a template, and conducting an enzymatic ligation reaction. In some embodiments, the method comprises closing the nick or gap in at least 2-10,000 circularized target-specific padlock probes by conducting one or more enzymatic reactions, thereby generating at least 2-10,000 covalently closed circular padlock probes inside the cellular sample.

In some embodiments, methods for conducting sequencing reactions that detects in situ at least two different target RNA molecules in a cellular sample further comprising step (e): conducting a rolling circle amplification reaction inside the cellular sample using the first and second covalently closed circular padlock probes as template molecules, thereby generating a plurality of concatemer molecules including at least a first concatemer molecule that corresponds to a first target RNA molecule, and the plurality of concatemer molecules includes at least a second concatemer molecule that corresponds to a second target RNA molecule. In some embodiments, the first concatemer molecule comprises tandem repeat units, wherein a unit comprises a sequence that corresponds to the first target cDNA (or the first target RNA), the first target barcode sequence, and the universal sequencing primer binding site (or a complementary sequence thereof). In some embodiments, the second concatemer molecule comprises tandem repeat units, wherein a unit comprises a sequence that corresponds to the second target cDNA (or the second target RNA), the second target barcode sequence, and the universal sequencing primer binding site (or a complementary sequence thereof).

In some embodiments, the rolling circle amplification reaction of step (e) comprises contacting the covalently closed circularized padlock probes with an amplification primer (e.g., a universal rolling circle amplification primer), a strand-displacing DNA polymerase, and a plurality of nucleotides, under a condition suitable for hybridizing individual amplification primers to a covalently closed padlock probe, and under a condition suitable for conducting primer extension using the covalently closed padlock probe as a template molecule to generate a nucleic acid concatemer. In some embodiments, the method comprises conducting a rolling circle amplification reaction inside the cellular sample using the at least 2-10,000 covalently closed circular padlock probes as template molecules, thereby generating at least 2-10,000 concatemer molecules that correspond to at least 2-10,000 target RNA molecules. In some embodiments, the plurality of concatemers that are generated inside the cellular sample collapse into a DNA nanoball having a shape and size that is more compact compared to a non-collapsed concatemer.

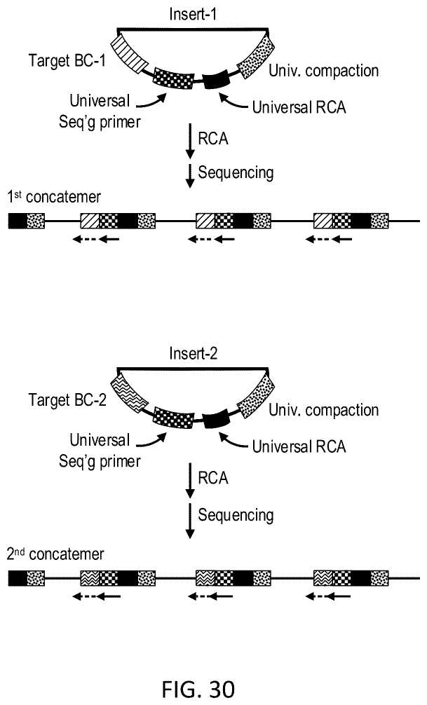

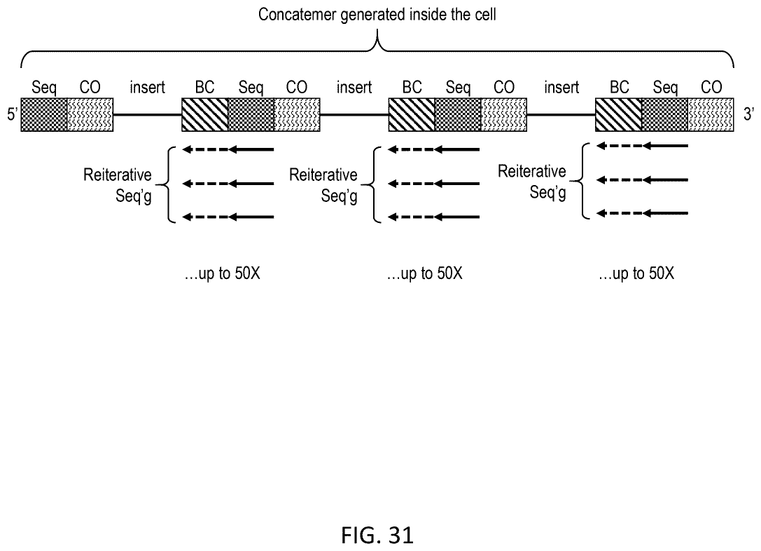

In some embodiments, methods for conducting sequencing reactions that detects in situ at least two different target RNA molecules in a cellular sample further comprising step (f): sequencing the plurality of concatemer molecules inside the cellular sample, which comprises sequencing the first concatemer molecule by conducting no more than 2-30 sequencing cycles to generate a plurality of first sequencing read products, and sequencing the second concatemer molecule by conducting no more than 2-30 sequencing cycles to generate a plurality of second sequencing read products (FIG. 30). In some embodiments, the sequencing of step (f) comprises sequencing no more than 2-30 bases of the first concatemer molecules to generate a plurality of first sequencing read products, and which comprises sequencing no more than 2-30 bases of the second concatemer molecules to generate a plurality of second sequencing read products. In some embodiments, the method comprises sequencing the at least 2-10,000 concatemer molecules inside the cellular sample, which comprises conducting no more than 2-30 sequencing cycles on the 2-10,000 concatemer molecules to generate a plurality of sequencing read products.

In some embodiments, only the first target barcode region of the first concatemer molecules are sequenced (e.g., FIG. 30, top). In some embodiments, at least a portion or the full length of the first target barcode of the first concatemer molecules are sequenced (e.g., FIG. 30, top). In some embodiments, the first target barcode is sequenced and a portion of the first cDNA region (or the first RNA region) of the first concatemer molecules are sequenced. In some embodiments, at least a portion of the first cDNA region (or the first RNA region) of the first concatemer molecules are sequenced.

In some embodiments, only the second target barcode region of the second concatemer molecules are sequenced (e.g., FIG. 30, bottom). In some embodiments, at least a portion or the full length of the second target barcode of the second concatemer molecules are sequenced (e.g., FIG. 30, bottom). In some embodiments, the second target barcode is sequenced and a portion of the second cDNA region (or the second RNA region) of the second concatemer molecules are sequenced. In some embodiments, at least a portion of the second cDNA region (or the second RNA region) of the second concatemer molecules are sequenced.

FIG. 30 is a schematic showing a rolling circle and sequencing workflow inside a cell according to some embodiments, comprising generating first and second concatemers by conducting rolling circle amplification using first and second covalently closed circular molecules (respectively). The first and second concatemers are subjected to a sequencing workflow using universal sequencing primers, sequencing polymerases, and a plurality of nucleotide reagents.

In some embodiments, the sequencing of step (f) comprises contacting the plurality of concatemer molecules inside the cellular sample with (i) a plurality of universal sequencing primers, (ii) a plurality of sequencing polymerases, and (iii) a plurality of nucleotide reagents, under a condition suitable for hybridizing the plurality of universal sequencing primers to their respective universal sequencing primer binding sites on the concatemers. In some embodiments, the sequencing of step (f) further comprises conducting no more than 2-30 sequencing cycles to generate at least a first plurality of sequencing read products by sequencing at least the first target barcode region (Target BC-1), and optionally conducting no more than 2-30 sequencing cycles to generate at least a second plurality of sequencing read products by sequencing at least the second target barcode region (Target BC-2). In some embodiments, the nucleotide reagents comprise multivalent molecules, nucleotides and/or nucleotide analogs.

In some embodiments, the sequencing of step (f) comprises sequencing at least a portion of the first and second nucleic acid concatemers using an optical imaging system comprising a field-of-view (FOV) greater than 1.0 mm².

In some embodiments, in the sequencing of step (f), the plurality of first and second sequencing read products are detectable by imaging, and wherein the sequencing comprises decoding the plurality of first and second sequencing read products from the images obtained during the no more than 2-30 sequencing cycles.

In some embodiments, in the sequencing of step (f), the plurality of the first and second sequencing read products are detectable by imaging, and wherein the sequencing comprises simultaneously imaging the plurality of first and second detectable sequencing read products in the cellular sample (co-localization of the first and second sequencing read products).

In some embodiments, methods for conducting sequencing reactions that detects in situ at least two different target RNA molecules in a cellular sample further comprising step (g): removing the plurality of first sequencing read products from the first concatemer molecules and retaining the first concatemer molecules in the cellular sample, and removing the plurality of second sequencing read products from the second concatemer molecules and retaining the second concatemer molecules in the cellular sample.

In some embodiments, methods further comprising step (h): reiteratively sequencing the plurality of concatemers by repeating steps (f) and (g) at least once, wherein the sequences of the plurality of first sequencing read products confirms the presence of the first target RNA molecules in the cellular sample, and wherein the sequences of the plurality of second sequencing read products confirms the presence of the second target RNA molecules in the cellular sample.

In some embodiments, reiteratively sequencing at least one region of the concatemer comprises repeating steps (f)-(g) at least 2 times, at least 3 times, at least 4 times, at least 5 times, at least 6 times, at least 7 times, at least 8 times, at least 9 times, or at least 10 times.

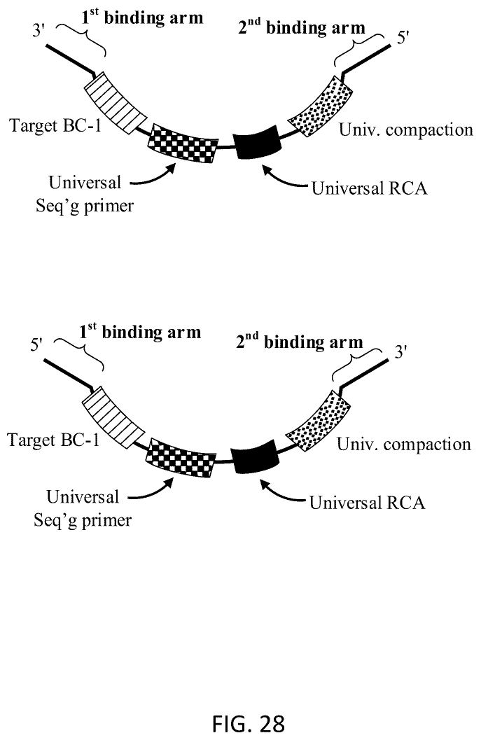

In some embodiments, reiteratively sequencing at least one region of the concatemer comprises repeating steps (f)-(g) up to 10 times, up to 20 times, up to 30 times, up to 40 times, or up to 50 times. An example of reiterative sequence is shown in a schematic in FIGS. 28-31.

FIG. 31 is a schematic showing an example workflow for sequencing a concatemer that is generated inside the cell, according to some embodiments. The concatemer includes tandem repeat units where each unit comprises: (i) a universal sequencing primer binding site (Seq), (ii) universal compaction oligonucleotide binding site (CO), (iii) an insert sequence that corresponds to a given target cDNA, and (iv) a target barcode sequence that corresponds to the given target cDNA (BC). In some embodiments, universal sequencing primers (solid arrows) hybridize to the universal sequencing primer binding sites and no more than 30 sequencing cycles are conducted to generate a plurality of first sequencing read products (dashed arrows), where the first sequencing read products include only the target barcode sequence. The plurality of first sequencing read products are removed from the concatemer, and the sequencing is repeated where no more than 30 sequencing cycles are conducted to generate another plurality of first sequencing read products (dashed arrows), where the first sequencing read products include only the target barcode sequence. The plurality of first sequencing read products are removed from the concatemer, and the sequencing is once again repeated where no more than 30 sequencing cycles are conducted to generate another plurality of first sequencing read products (dashed arrows), where the first sequencing read products include only the target barcode sequence. In some embodiments, the reiterative sequencing can be conducted up to 50 times. The sequences of all of the first sequencing read products can be determined and aligned with a first reference sequence (e.g., reference barcode sequence) to confirm the presence of the first target RNA molecules inside the cellular sample.

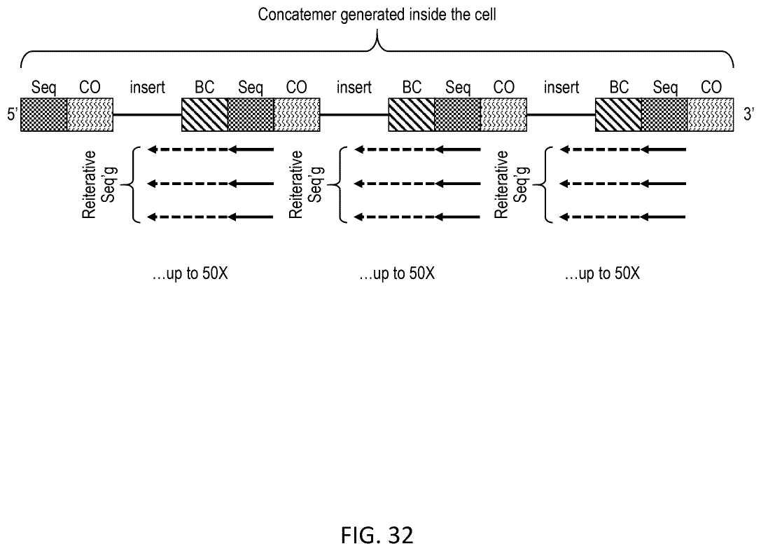

FIG. 32 is a schematic showing an example workflow for sequencing a concatemer that is generated inside the cell, according to some embodiments. The concatemer includes tandem repeat units where each unit comprises: (i) a universal sequencing primer binding site (Seq), (ii) universal compaction oligonucleotide binding site (CO), (iii) an insert sequence that corresponds to a given target cDNA, and (iv) a target barcode sequence that corresponds to the given target cDNA (BC). In some embodiments, universal sequencing primers (solid arrows) hybridize to the universal sequencing primer binding sites and no more than 30 sequencing cycles are conducted to generate a plurality of first sequencing read products (dashed arrows), where the first sequencing read products include the target barcode sequence and a portion of the insert sequence. The plurality of first sequencing read products are removed from the concatemer, and the sequencing is repeated where no more than 30 sequencing cycles are conducted to generate another plurality of first sequencing read products (dashed arrows), where the first sequencing read products include the target barcode sequence and a portion of the insert sequence. The plurality of first sequencing read products are removed from the concatemer, and the sequencing is once again repeated where no more than 30 sequencing cycles are conducted to generate another plurality of first sequencing read products (dashed arrows), where the first sequencing read products include the target barcode sequence and a portion of the insert sequence. In some embodiments, the reiterative sequencing can be conducted up to 50 times. The sequences of all of the first sequencing read products can be determined and aligned with a first reference sequence (e.g., reference barcode sequence and the insert sequence that corresponds to the target RNA) to confirm the presence of the first target RNA molecules inside the cellular sample.

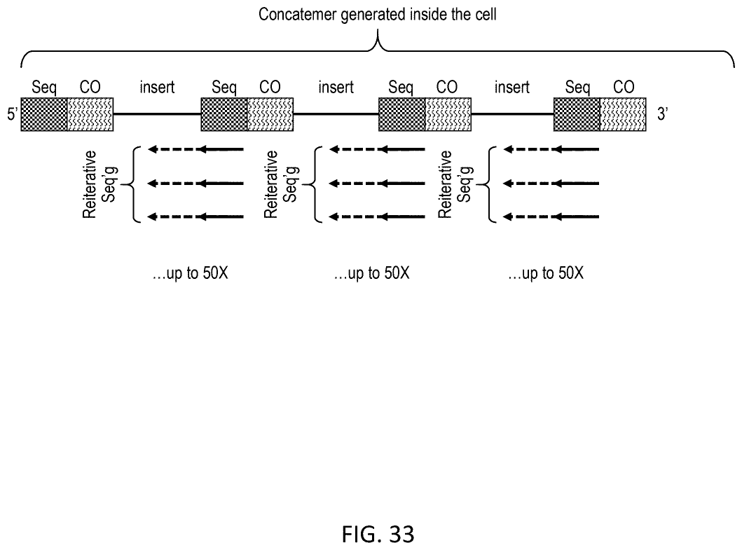

FIG. 33 is a schematic showing an example workflow for sequencing a concatemer that is generated inside the cell, according to some embodiments. The concatemer includes tandem repeat units where each unit comprises: (i) a universal sequencing primer binding site (Seq), (ii) universal compaction oligonucleotide binding site (CO), and (iii) an insert sequence that corresponds to a given target cDNA. In some embodiments, universal sequencing primers (solid arrows) hybridize to the universal sequencing primer binding sites and no more than 30 sequencing cycles are conducted to generate a plurality of first sequencing read products (dashed arrows), where the first sequencing read products include a portion of the insert sequence. The plurality of first sequencing read products are removed from the concatemer, and the sequencing is repeated where no more than 30 sequencing cycles are conducted to generate another plurality of first sequencing read products (dashed arrows), where the first sequencing read products include a portion of the insert sequence. The plurality of first sequencing read products are removed from the concatemer, and the sequencing is once again repeated where no more than 30 sequencing cycles are conducted to generate another plurality of first sequencing read products (dashed arrows), where the first sequencing read products include a portion of the insert sequence. In some embodiments, the reiterative sequencing can be conducted up to 50 times. The sequences of all of the first sequencing read products can be determined and aligned with a first reference sequence (e.g., the insert sequence that corresponds to the target RNA) to confirm the presence of the first target RNA molecules inside the cellular sample.

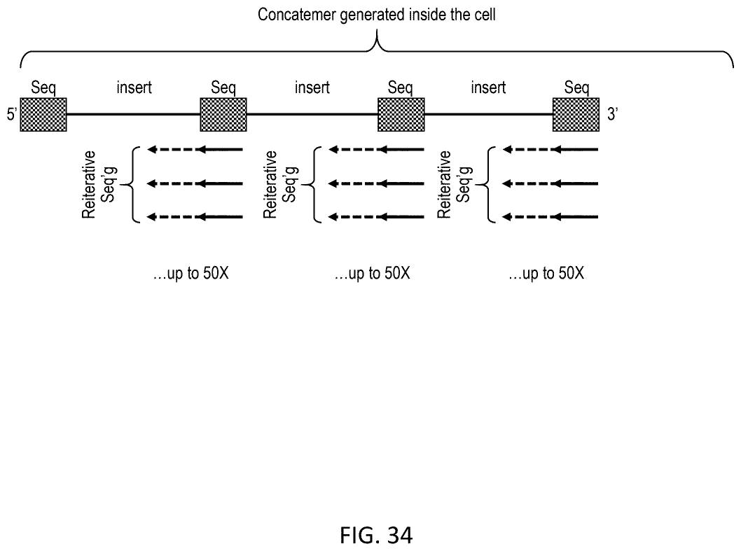

FIG. 34 is a schematic showing an example workflow for sequencing a concatemer that is generated inside the cell, according to some embodiments. The concatemer includes tandem repeat units where each unit comprises: (i) a universal sequencing primer binding site (Seq) and (ii) an insert sequence that corresponds to a given target cDNA. In some embodiments, universal sequencing primers (solid arrows) hybridize to the universal sequencing primer binding sites and no more than 30 sequencing cycles are conducted to generate a plurality of first sequencing read products (dashed arrows), where the first sequencing read products include a portion of the insert sequence. The plurality of first sequencing read products are removed from the concatemer, and the sequencing is repeated where no more than 30 sequencing cycles are conducted to generate another plurality of first sequencing read products (dashed arrows), where the first sequencing read products include a portion of the insert sequence. The plurality of first sequencing read products are removed from the concatemer, and the sequencing is once again repeated where no more than 30 sequencing cycles are conducted to generate another plurality of first sequencing read products (dashed arrows), where the first sequencing read products include a portion of the insert sequence. In some embodiments, the reiterative sequencing can be conducted up to 50 times. The sequences of all of the first sequencing read products can be determined and aligned with a first reference sequence (e.g., the insert sequence that corresponds to the target RNA) to confirm the presence of the first target RNA molecules inside the cellular sample.

In some embodiments, at least one concatemer is sequenced by conducting step (f) once (non-reiterative sequencing). In some embodiments, at least one concatemer is sequenced by conducting steps (f)-(g) once. In some embodiments, at least one concatemer is reiteratively sequenced by conducting steps (f)-(g) at least twice.

In some embodiments, the plurality of universal sequencing primers can be hybridized to concatemer template molecules with a hybridization reagent comprising an SSC buffer (e.g., 2× saline-sodium citrate) buffer with formamide (e.g., 10-20% formamide). The hybridization conditions comprise a temperature of about 20-30° C., for about 10-60 minutes.

In some embodiments, the plurality of sequencing read products can be removed from the concatemers and the plurality of concatemers can be retained inside the cellular sample using a de-hybridization reagent comprising an SSC buffer (e.g., saline-sodium citrate) buffer, with or without formamide, at a temperature that promotes nucleic acid denaturation such as for example 30-90° C.

In some embodiments, the plurality of nucleotide reagents of step (f) comprise a plurality of nucleotides that are detectably labeled or non-labeled. In some embodiments, individual nucleotides are linked to a detectable reporter moiety. In some embodiments, the detectable reporter moiety comprises a fluorophore. In some embodiments, the plurality of detectably labeled nucleotide analogs comprise a plurality of chain terminating nucleotides, where the chain terminating moiety is linked to 3′ nucleotide sugar position to form a 3′ blocked nucleotide analog. In some embodiments, the chain terminating moiety can be removed to convert 3′ blocked nucleotide analog to an extendible nucleotide having a 3′ OH group on the sugar. In some embodiments, the labeled nucleotide analogs are linked to a different fluorophore that corresponds to the nucleo-bases adenine, cytosine, guanine, thymine or uracil, where the different fluorophores emit a fluorescent signal during the sequencing of step (f). In some embodiments, a sequencing cycle comprises (1) contacting the concatemer/sequencing primer duplex with a sequencing polymerase and a detectably labeled chain terminating nucleotide under a condition suitable for polymerase-catalyzed incorporation of the detectably labeled chain terminating nucleotide into the terminal end of the sequencing primer, (2) detecting and imaging the fluorescent signal and color emitted by the incorporated chain terminating nucleotide, and (3) removing the chain terminating moiety (e.g., unblocking) and the fluorophore from the incorporated nucleotide and retaining the concatemer/sequencing primer duplex. In some embodiments, no more than 2-30 sequencing cycles are conducted on the plurality of concatemers inside the cellular sample to generate a plurality of sequencing read products. In some embodiments, the sequence of the first sequencing read product can be determined and aligned with a first reference sequence to confirm the presence of the first target RNA molecules inside the cellular sample. In some embodiments, the sequence of the second sequencing read product can be determined and aligned with a second reference sequence to confirm the presence of the second target RNA molecules inside the cellular sample.

In some embodiments, the sequences of the first and second sequencing read products can be aligned after each round of generating the first and second sequencing read products which are no more than 30 bases in length, or after generating a set of reiterative sequencing read products wherein the first and second sequencing read products which are no more than 30 bases in length. In some embodiments, the sequencing reactions are conducted on a sequencing apparatus having a detector that captures fluorescent signals from the sequencing reactions inside the cellular sample. The sequencing apparatus can be configured to relay the fluorescent signal data captured by the detector to a computer system that is programmed to display images of different fluorescent spots which are co-located in the cellular sample, where individual fluorescent spots correspond to different target RNA molecules. In some embodiments, when the sequencing is conducted using different fluorescently-labeled nucleotide reagents that correspond to different nucleo-bases (e.g., A, G, C, T/U), then the images can have different color fluorescent spots co-located in the same cellular sample at different sequencing cycles.

In some embodiments, out-of-sync phasing and/or pre-phasing events can occur during synchronized sequencing reactions on clonally amplified template amplicons, where the sequencing reactions comprise polymerase-catalyzed sequencing reactions employing detectably labeled chain terminator nucleotides. In some embodiments, a sequencing reaction on one template molecule in the clonally-amplified template molecules moves ahead (e.g., pre-phasing) or fall behind (e.g., phasing) of the sequencing of the other template molecules within the clonally-amplified template molecules. During sequencing, a fluorescent signal is typically detected which corresponds to incorporation of a labeled chain terminator nucleotide. Thus, phasing and pre-phasing events can be detected and monitored using incorporation of a labeled chain terminator nucleotide.

In some embodiments, the plurality of nucleotide reagents of step (f) comprise a plurality of multivalent molecules each comprising a core attached to a plurality of nucleotide-arms, wherein the nucleotide-arms are attached to a nucleotide unit. In some embodiments, individual multivalent molecules are labeled with a detectably reporter moiety. In some embodiments, the detectable reporter moiety comprises a fluorophore. In some embodiments, the core of the multivalent molecule is labeled with a fluorophore, and wherein the fluorophore which is attached to a given core of the multivalent molecule corresponds to the nucleotide base (e.g., adenine, guanine, cytosine, thymine or uracil) of the nucleotide arm. In some embodiments, at least one of the nucleotide arms of the multivalent molecule comprises a linker and/or nucleotide base that is attached to a fluorophore, and wherein the fluorophore which is attached to a given nucleotide base corresponds to the nucleotide base (e.g., adenine, guanine, cytosine, thymine or uracil) of the nucleotide arm. In some embodiments, a sequencing cycle comprises (1) contacting the concatemer/sequencing primer duplex with a first sequencing polymerase to form a complexed polymerase, (2) contacting the complexed polymerase with a detectably labeled multivalent molecule under a condition suitable for binding a complementary nucleotide unit of the multivalent molecule to the complexed polymerase thereby forming a multivalent-binding complex, and the condition is suitable for inhibiting incorporation of the complementary nucleotide unit into the terminal end of the sequencing primer, (3) detecting and imaging the fluorescent signal and color emitted by the bound detectably labeled multivalent molecule, (4) removing the first sequencing polymerase and the bound detectably labeled multivalent molecule, and retaining the concatemer/sequencing primer duplex, (5) contacting the retained concatemer/sequencing primer duplex with a second sequencing polymerase and a non-labeled chain terminating nucleotide under a condition suitable for polymerase-catalyzed incorporation of the non-labeled chain terminating nucleotide into the terminal end of the sequencing primer, and (6) removing the chain terminating moiety (e.g., unblocking) and retaining the concatemer/sequencing primer duplex. In some embodiments, no more than 2-30 sequencing cycles are conducted on the plurality of concatemers inside the cellular sample to generate a plurality of sequencing read products. In some embodiments, the sequence of the first sequencing read product can be determined and aligned with a first reference sequence to confirm the presence of the first target RNA molecules inside the cellular sample. In some embodiments, the sequence of the second sequencing read product can be determined and aligned with a second reference sequence to confirm the presence of the second target RNA molecules inside the cellular sample. In some embodiments, the sequences of the first and second sequencing read products can be aligned after each round of generating the first and second sequencing read products which are no more than 30 bases in length, or after generating a set of reiterative sequencing read products wherein the first and second sequencing read products which are no more than 30 bases in length. In some embodiments, the sequencing reactions are conducted on a sequencing apparatus having a detector that captures fluorescent signals from the sequencing reactions inside the cellular sample. The sequencing apparatus can be configured to relay the fluorescent signal data captured by the detector to a computer system that is programmed to display images of different fluorescent spots which are co-located in the cellular sample, where individual fluorescent spots correspond to different target RNA molecules. In some embodiments, individual cycle times can be achieved in less than 30 minutes. In some embodiments, the field of view (FOV) can exceed 1 mm² and the cycle time for scanning large area (>10 mm²) can be less than 5 minutes.

In some embodiments, when sequencing with detectably labeled multivalent molecules, step (2) in which multivalent-binding complexes are formed and step (3) in which the bound detectably labeled multivalent molecules are imaged and detected, the conditions are gentle compared to sequencing workflows that employ detectable labeled chain terminating nucleotides. For example, steps (2) and (3) can be conducted at a gentle temperature of about 35-45° C., or about 39-42° C. Steps (2) and (3) can be conducted at a gentle temperature which can help retain the compact size and shape of a DNA nanoball during multiple sequencing cycles (e.g., up to 30 cycles) which can improve FWHM (full width half maximum) of a spot image of the DNA nanoball inside a cellular sample. In some embodiments, the DNA nanoball does not unravel during multiple sequencing cycles. In some embodiments, the spot image of the DNA nanoball does not enlarge during multiple sequencing cycles. In some embodiments, the spot image of the DNA nanoball remains a discrete spot during multiple sequencing cycles. The spot image can be represented as a Gaussian spot and the size can be measured as a FWHM. A smaller spot size as indicated by a smaller FWHM typically correlates with an improved image of the spot. In some embodiments, the FWHM of a nanoball spot can be about 10 um or smaller.

In some embodiments, out-of-sync phasing and/or pre-phasing events can occur during synchronized polymerase-catalyzed sequencing reactions employing detectably labeled multivalent molecules. During sequencing, a fluorescent signal can be detected which corresponds to binding of complementary nucleotide unit of a multivalent molecule to the complexed polymerase thereby forming a multivalent-binding complex. Thus, phasing and pre-phasing events can be detected and monitored using binding of labeled multivalent molecules. In some embodiments, when conducting up to 30 sequencing cycles with detectably labeled multivalent molecules, the phasing and/or pre-phasing rate can be less than about 5%, or less than about 1%, or less than about 0.01%, or less than about 0.001%. By contrast, the phasing and/or pre-phasing rates for conducting up to 30 sequencing cycles using labeled chain terminator nucleotides can be about 5%.

### Target-Specific Padlock Probes

In any of the methods described herein, the plurality of RNA or cDNA inside the cellular sample can be amplified to generate amplicons of the RNA or cDNA where the amplicons comprise concatemers. In some embodiments, the plurality of RNA or cDNA molecules inside the cellular sample can be amplified by conducting a padlock probe circularization and rolling circle amplification workflow. In some embodiments, the methods comprise contacting the plurality of RNA or cDNA molecules inside the cellular sample with a plurality of padlock probes, including a first plurality of target-specific padlock probes that hybridize with first target RNA or cDNA molecules, and a second plurality of target-specific padlock probes that hybridize with second target RNA or cDNA molecules.

In some embodiments, the padlock probes comprise single-stranded oligonucleotides. In some embodiments, the padlock probes comprise DNA, RNA, or DNA and RNA. In some embodiments, individual padlock probes comprise an internal region between the first and second terminal regions, where the internal region comprises at least one universal adaptor sequence including a sample barcode sequence, an amplification primer binding site, a sequencing primer binding site, a compaction oligonucleotide binding site and/or a surface capture primer binding site (FIG. 28). In some embodiments, the padlock probes comprise at least one target barcode sequence that corresponds to a given target RNA or target cDNA to which the padlock probes binds. In some embodiments, the padlock probes comprise at least one unique identification sequence (e.g., unique molecular index (UMI)). In some embodiments, the padlock probes comprise at least one restriction enzyme recognition sequence.

In some embodiments, individual padlock probes comprise first and second terminal regions (e.g., first and second binding arms) that hybridize to portions of target RNA or target cDNA molecules to form a plurality of RNA-padlock probe complexes or a plurality of cDNA-padlock probe complexes, wherein individual complexes have the first and second terminal probe regions hybridized to proximal regions of an RNA or cDNA molecule to form a nick or gap between the first and second terminal probe ends. In some embodiments, the first terminal region of an individual padlock probe has a first target-specific sequence that selectively hybridizes to a first region of a target RNA or cDNA molecule, and the second terminal region of the individual padlock probe has a second target-specific sequence that selectively hybridizes to a second region of the same target RNA or cDNA molecule, where a nick or gap is formed between the hybridized first and second terminal regions, thereby circularizing the padlock probe (e.g., FIG. 29).

In some embodiments, the padlock probes comprise canonical nucleotides and/or nucleotide analogs. In some embodiments, the padlock probes are modified to confer resistance to nuclease degradation (e.g., ribonuclease degradation). For example, the padlock probes comprise at least one phosphorothioate diester bond at their 5′ ends which can render the padlock probes resistant to nuclease degradation. In some embodiments, the padlock probes comprise 2-5 or more consecutive phosphorothioate diester bonds at their 5′ ends. In some embodiments, the padlock probes comprise at least one ribonucleotide and/or at least one 2′-O-methyl, 2′-O-methoxyethyl (MOE), 2′ fluoro-base nucleotide. In some embodiments, the padlock probes comprise phosphorylated 3′ ends. In some embodiments, the padlock probes comprise at least one locked nucleic acid (LNA) base. In some embodiments, the padlock probes comprise a phosphorylated 5′ end (e.g., using a polynucleotide kinase).

FIG. 28 is a schematic showing example embodiments of padlock probes. In some embodiments, a padlock probe comprises a single-stranded nucleic acid molecule having two terminal regions (e.g., first and second binding arms) and an internal region. In some embodiments, the first terminal region of an individual padlock probe has a first target-specific sequence that selectively hybridizes to a first region of a target RNA or target cDNA molecule, and the second terminal region of the individual padlock probe has a second target-specific sequence that selectively hybridizes to a second region of the same target RNA or target cDNA molecule. In some embodiments, the internal region of a padlock comprises a target barcode sequence (e.g., Target BC-1 or Target BC-2, left and right schematics respectively) which corresponds to a given target RNA or target cDNA. In some embodiments, the target barcode sequence uniquely identifies the target RNA or target cDNA. In some embodiments, the internal region of a padlock comprises a universal primer binding site for a sequencing primer (or a complementary sequence thereof). In some embodiments, the internal region of a padlock comprises a universal primer binding site for a rolling circle amplification primer (or a complementary sequence thereof). In some embodiments, the internal region of a padlock comprises a universal binding site for a compaction oligonucleotide binding (or a complementary sequence thereof). In some embodiments, the internal region of a padlock probe includes a target barcode sequence and at least one universal primer binding site (e.g., for binding a sequencing primer, for binding a rolling circle amplification primer and/or for binding a compaction oligonucleotide) in any arrangement and orientation (FIG. 28, top and bottom).

In some embodiments, individual padlock probes in a set of padlock probes (e.g., a plurality of padlock probes) comprise first and second terminal regions that hybridize to the same target regions of the target RNA or cDNA molecules to form a plurality of RNA-padlock probe complexes or a plurality of cDNA-padlock probe complexes having the same RNA or cDNA sequence.

In some embodiments, a set of padlock probes (e.g., a plurality of padlock probes) comprise at least two sub-sets of padlock probes. In some embodiments, individual padlock probes in a first sub-set of padlock probes comprise first and second terminal regions that hybridize to the same target regions (e.g., a first target region) of the target RNA or cDNA molecules to form a first plurality of RNA-padlock probe complexes or a first plurality of cDNA-padlock probe complexes having the same RNA or cDNA sequence. In some embodiments, individual padlock probes in a second sub-set of padlock probes comprise first and second terminal regions that hybridize to the same target regions (e.g., a second target region) of the target RNA or cDNA molecules to form a second plurality of RNA-padlock probe complexes or a second plurality of cDNA-padlock probe complexes having the same cDNA sequence. In some embodiments, the first and second sub-sets of padlock probes hybridize to different target regions of the same target RNA or cDNA molecules. In some embodiments, the first and second sub-sets of padlock probes hybridize to different target regions of different target RNA or cDNA molecules. In some embodiments, the set of padlock probes comprise 2-10 sub-sets of padlock probes, or 10-25 sub-sets of padlock probes, or 25-50 sub-sets of padlock probes, or up to 100 sub-sets of padlock probes. In some embodiments, the set of padlock probes comprise at least 100 sub-sets of padlock probes, at least 500 sub-sets of padlock probes, at least 1000 sub-sets of padlock probes, at least 10,000 sub-sets of padlock probes, or more sub-sets of padlock probes.

In some embodiments, the nicks can be enzymatically ligated to generate covalently closed circular padlock probes. In some embodiments, the ligase enzyme can discriminate between matched and mis-matched hybridized ends to ensure target-specific hybridization. In some embodiments, the ligation reaction comprises use of a ligase enzyme, including a T3, T4, T7 or Taq DNA ligase enzyme.

In some embodiments, the size of the gap between the hybridized first and second terminal regions is 1-25 bases. The 3′OH end of hybridized padlock probe can serve as an initiation site for a polymerase-catalyzed fill-in reaction (e.g., gap fill-in reaction) using the target cDNA molecule (or the target RNA molecule) as a template. After the fill-in reaction, the remaining nick can be enzymatically ligated to generate covalently closed circular padlock probes.

In some embodiments, the gap-filling reaction comprises contacting the circularized padlock probe with a DNA polymerase and a plurality of nucleotides. In some embodiments, the DNA polymerase comprises E. coli DNA polymerase I, Klenow fragment of E. coli DNA polymerase I, T7 DNA polymerase, or T4 DNA polymerase. In some embodiments, the ligase enzyme can discriminate between matched and mis-matched hybridized ends to ensure target-specific hybridization. In some embodiments, the ligation reaction comprises use of a ligase enzyme, including a T3, T4, T7 or Taq DNA ligase enzyme.

### Rolling Circle Amplification

In any of the methods described herein, the plurality of covalently closed circular padlock probes can be subjected to a rolling circle amplification reaction to generate a plurality of concatemer molecules each having two or more tandem copies of a unit wherein the unit comprises a target sequence that corresponds to a target RNA molecules and any additional sequence(s) carried by the padlock probes including universal adaptor sequence(s), unique molecular index sequence(s) and/or restriction enzyme recognition sequence(s).

In some embodiments, the rolling circle amplification reaction comprises contacting the covalently closed circularized padlock probes with an amplification primer (e.g., a universal rolling circle amplification primer), a strand-displacing DNA polymerase, and a plurality of nucleotides, under a condition suitable for hybridizing individual amplification primers to a covalently closed padlock probe, and under a condition suitable for conducting primer extension using the covalently closed padlock probe as a template molecule to generate a nucleic acid concatemer. In some embodiments, the plurality of nucleotides in the rolling circle amplification reaction comprise any mixture of two or more of dATP, dGTP, dCTP, dTTP and/or dUTP. In some embodiments, any of the rolling circle amplification reactions described herein can be conducted in the presence or in the absence of a plurality of compaction oligonucleotides.

In some embodiments, when the rolling circle amplification reaction includes a plurality of nucleotide which includes dUTP, the resulting concatemer can be cross-linked to a cross-linking reactive group by treating the cellular sample with a succinimide ester (NHS), maleimide (Sulfo-SMCC), imidoester (DMP), carbodiimide (DCC, EDC) or phenyl azide. In some embodiments, polymerization of the cross-linking reactive group can be initiated with light or UV light. In some embodiments, the resulting concatemer can be cross-linked to a matrix by treating the cellular sample with a cross-linked agarose, cross-linked dextran or cross-linked polyethylene glycol (PEG), polyacrylamide, cellulose alginate or polyamide. In some embodiments, the PEG comprises a sulfo-NHS ester moiety at one or both ends, for example a PEGylated bis(sulfosuccinimidyl) suberate) (e.g., BS(PEG)₉ from Thermo Fisher Scientific, catalog No. 21582).

In some embodiments, the rolling circle amplification reaction can be conducted at a constant temperature (e.g., isothermal) wherein the constant temperature is at room temperature to about 30° C., or about 30-40° C., or about 40-50° C., or about 50-65° C.

In some embodiments, the DNA polymerase having a strand displacing activity can be selected from a group consisting of phi29 DNA polymerase, large fragment of Bst DNA polymerase, large fragment of Bsu DNA polymerase, and Bca (exo-) DNA polymerase, Klenow fragment of E. coli DNA polymerase, T5 polymerase, M-MuLV reverse transcriptase, HIV viral reverse transcriptase, or Deep Vent DNA polymerase. In some embodiments, the phi29 DNA polymerase can be wild type phi29 DNA polymerase (e.g., MagniPhi from Expedeon), or variant EquiPhi29 DNA polymerase (e.g., from Thermo Fisher Scientific), and chimeric QualiPhi DNA polymerase (e.g., from 4basebio).

In some embodiments, the rolling circle amplification primers can be modified to increase resistance to nuclease degradation. In some embodiments, the rolling circle amplification primers comprise at least one phosphorothioate diester bond at their 5′ ends which can render the amplification primers resistant to exonuclease degradation. In some embodiments, the rolling circle amplification primers comprise 2-5 or more consecutive phosphorothioate diester bonds at their 5′ ends. In some embodiments, the rolling circle amplification primers comprise at least one ribonucleotide and/or at least one 2′-O-methyl or 2′-O-methoxyethyl (MOE) nucleotide.

In some embodiments, the rolling circle amplification reaction can be conducted in the presence of a plurality of compaction oligonucleotides which, when hybridized to a concatemer molecule, compacts the size and/or shape of the concatemer to form a compact nanoball. In some embodiments, the compaction oligonucleotides comprise single stranded oligonucleotides having a first region at one end that hybridizes to a portion of a concatemer molecule and a second region at the other end that hybridizes to another portion of the same concatemer molecule, where hybridization of the compaction oligonucleotide to a given concatemer compacts the size and/or shape of the concatemer.

The compaction oligonucleotides include a 5′ region, an optional internal region (intervening region), and a 3′ region. The 5′ and 3′ regions of the compaction oligonucleotide can hybridize to any portions of the concatemer. The 5′ and 3′ regions of the compaction oligonucleotide can hybridize to different portions of the concatemer to pull together distal portions of the concatemer causing compaction of the concatemer to form a DNA nanoball. For example, 5′ region of the compaction oligonucleotide is designed to hybridize to a first portion of the concatemer molecule (e.g., a universal compaction oligonucleotide binding site), and 3′ region of the compaction oligonucleotide is designed to hybridized to a second portion of the concatemer molecule (e.g., a universal compaction oligonucleotide binding site). Inclusion of compaction oligonucleotides during RCA can promote formation of DNA nanoballs having tighter size and shape compared to concatemers generated in the absence of the compaction oligonucleotides. The compact and stable characteristics of the DNA nanoballs improves in situ sequencing accuracy by increasing signal intensity and the nanoballs retain their shape and size during multiple sequencing cycles.

In some embodiments, the compaction oligonucleotides comprise single stranded oligonucleotides comprising DNA, RNA, or a combination of DNA and RNA. The compaction oligonucleotides can be any length, including 20-150 nucleotides, or 30-100 nucleotides, or 40-80 nucleotides in length.

In some embodiments, the compaction oligonucleotides comprises a 5′ region and a 3′ region, and optionally an intervening region between 5′ and 3′ regions. The intervening region can be any length, for example about 2-20 nucleotides in length. The intervening region comprises a homopolymer having consecutive identical bases (e.g., AAA, GGG, CCC, TTT or UUU). The intervening region comprises a non-homopolymer sequence.

The 5′ region of the compaction oligonucleotides can be wholly complementary or partially complementary along its length to a first portion of a concatemer molecule. The 3′ region of the compaction oligonucleotides can be wholly complementary or partially complementary along its length to a second portion of a concatemer molecule. The 5′ region of the compaction oligonucleotides can hybridize to a first universal sequence portion of a concatemer molecule. The 3′ region of the compaction oligonucleotides can hybridize to a second universal sequence portion of a concatemer molecule.

In some embodiments, 5′ region of the compaction oligonucleotide can have the same sequence as 3′ region. The 5′ region of the compaction oligonucleotide can have a sequence that is different from 3′ region. In some embodiments, 3′ region of the compaction oligonucleotide can have a sequence that is a reverse sequence of 5′ region. In some embodiments, 5′ region of the compaction oligonucleotide can have a sequence that is a reverse sequence of 3′ region.

In some embodiments, 3′ region of any of the compaction oligonucleotides can include an additional three bases at the terminal 3′ end which comprises 2′-O-methyl RNA bases (e.g., designated mUmUmU) or the terminal 3′ end lacks additional 2′-O-methyl RNA bases.

In some embodiments, the compaction oligonucleotides comprise one or more modified bases or linkages at their 5′ or 3′ ends to confer certain functionalities. In some embodiments, the compaction oligonucleotides comprise at least one phosphorothioate linkages at their 5′ and/or 3′ ends to confer exonuclease resistance. In some embodiments, at least one nucleotide at or near 3′ end comprises a 2′ fluoro base which confers exonuclease resistance. In some embodiments, 3′ end of the compaction oligonucleotides comprise at least one 2′-O-methyl RNA base which blocks polymerase-catalyzed extension. For example, 3′ end of the compaction oligonucleotide comprises three bases comprising 2′-O-methyl RNA base (e.g., designated mUmUmU). In some embodiments, the compaction oligonucleotides comprise a 3′ inverted dT at their 3′ ends which blocks polymerase-catalyzed extension. In some embodiments, the compaction oligonucleotides comprise 3′ phosphorylation which blocks polymerase-catalyzed extension. In some embodiments, the internal region of the compaction oligonucleotides comprise at least one locked nucleic acid (LNA) which increases the thermal stability of duplexes formed by hybridizing a compaction oligonucleotide to a concatemer molecule. In some embodiments, the compaction oligonucleotides comprise a phosphorylated 5′ end (e.g., using a polynucleotide kinase).

In some embodiments, the compaction oligonucleotide comprises the sequence 5′-CATGTAATGCACGTACTTTCAGGGTAAACATGTAATGCACGTACTTTCAGG GT-3′ (SEQ ID NO: 1). In some embodiments, the compaction oligonucleotides includes an additional three bases at the terminal 3′ end which comprises 2′-O-methyl RNA bases (e.g., designated mUmUmU) or the terminal 3′ end lacks additional 2′-O-methyl RNA bases.

In some embodiments, the compaction oligonucleotides can include at least one region having consecutive guanines. For example, the compaction oligonucleotides can include at least one region having 2, 3, 4, 5, 6 or more consecutive guanines. In some embodiments, the compaction oligonucleotides comprise four consecutive guanines which can form a guanine tetrad structure. The guanine tetrad structure can be stabilized via Hoogsteen hydrogen bonding. The guanine tetrad structure can be stabilized by a central cation including potassium, sodium, lithium, rubidium or cesium.

At least one compaction oligonucleotide can form a guanine tetrad and hybridize to the universal binding sequences in a concatemer which can cause the concatemer to fold to form an intramolecular G-quadruplex structure. The concatemers can self-collapse to form compact nanoballs. Formation of the guanine tetrads and G-quadruplexes in the nanoballs may increase the stability of the nanoballs to retain their compact size and shape which can withstand changes in pH, temperature and/or repeated flows of reagents during sequencing inside the cellular sample.

In some embodiments, the plurality of compaction oligonucleotides in the rolling circle amplification reaction have the same sequence. Alternatively, the plurality of compaction oligonucleotides in the rolling circle amplification reaction comprise a mixture of two or more different populations of compaction oligonucleotides having different sequences.

In some embodiment, the immobilized concatemer template molecule can self-collapse into a compact nucleic acid nanoball. The nanoballs can be imaged and a FWHM measurement can be obtained to give the shape/size of the nanoballs.

In some embodiments, inclusion of compaction oligonucleotides in the rolling circle amplification reaction can promote collapsing of a concatemer into a DNA nanoball. Conducting RCA with compaction oligonucleotides helps retain the compact size and shape of a DNA nanoball during multiple sequencing cycles which can improve FWHM (full width half maximum) of a spot image of the DNA nanoball inside a cellular sample. In some embodiments, the DNA nanoball does not unravel during multiple sequencing cycles. In some embodiments, the spot image of the DNA nanoball does not enlarge during multiple sequencing cycles. In some embodiments, the spot image of the DNA nanoball remains a discrete spot during multiple sequencing cycles. The spot image can be represented as a Gaussian spot and the size can be measured as a FWHM. A smaller spot size as indicated by a smaller FWHM typically correlates with an improved image of the spot. In some embodiments, the FWHM of a nanoball spot can be about 10 um or smaller.

The single-stranded concatemers collapse into compact DNA nanoballs, where each nanoball carries numerous tandem copies of a polynucleotide unit along their lengths, where the polynucleotide unit includes a sequence-of-interest (e.g., that corresponds to target RNA or target cDNA) and at least a universal sequencing primer binding site. Each polynucleotide unit can bind a sequencing primer, a sequencing polymerase and a detectably-labeled nucleotide reagent (e.g., detectably labeled multivalent molecules), to form a detectable sequencing complex (e.g., a detectable ternary complex). Each nanoball carries numerous detectable sequencing complexes. Thus, the compact nature of the nanoballs increases the local concentration of detectably-labeled nucleotide reagents that are used during the sequencing workflow which increases the signal intensity emitted from a nanoball to give a discrete detectable signal which can be imaged as a fluorescent spot inside the cellular sample. Each spot corresponds to a concatemer and each concatemer corresponds to a target RNA molecule in the cellular sample. Multiple spots can be detected and imaged simultaneously in the cellular sample. The DNA nanoballs having compact shape and size that produce increased signal intensity and color differentiation during sequencing.

### Cellular Sample

In any of the methods described herein, the cellular sample can comprise a whole cell, a plurality of whole cells, an intact tissue or an intact tumor. In some embodiments, the cellular sample comprises a fresh cellular sample, a freshly-frozen cellular sample, a sectioned cellular sample, or an FFPE cellular sample. In some embodiments, the cellular sample comprise one or more living cells or non-living cells.

In some embodiments, the cellular sample can be obtained from a virus, fungus, prokaryote or eukaryote. In some embodiments, the cellular sample can be obtained from an animal, insect or plant. In some embodiments, the cellular sample comprises one or more virally-infected cells.

In some embodiments, the cellular sample can be obtained from any organism including human, simian, ape, canine, feline, bovine, equine, murine, porcine, caprine, lupine, ranine, piscine, plant, insect or bacteria.

In some embodiments, the cellular sample can be obtained from any organ including head, neck, brain, breast, ovary, cervix, colon, rectum, endometrium, gallbladder, intestines, bladder, prostate, testicles, liver, lung, kidney, esophagus, pancreas, thyroid, pituitary, thymus, skin, heart, larynx, or other organs.

In any of the methods described herein, the cellular sample can harbor a plurality of RNA which include target RNA and non-target RNA. In some embodiments, cells typically produce RNA by gene expression which includes transcription of DNA (e.g., genomic DNA) into RNA molecules. The transcribed RNA can undergo splicing or may not be spliced. The transcribed RNA can be translated into a polypeptide (e.g., coding RNA), or do not undergo translation but can be processed into tRNA or rRNA (e.g., non-coding RNA).

In some embodiments, the plurality of RNA harbored by the cellular sample includes target and non-target RNA. In some embodiments, the plurality of RNA harbored by the cellular sample comprises wild type RNA, mutant RNA or splice variant RNA. In some embodiments, the plurality of RNA harbored by the cellular sample comprises pre-spliced RNA, partially spliced RNA, or fully spliced RNA. In some embodiments, the plurality of RNA harbored by the cellular sample comprises coding RNA, non-coding RNA, mRNA, tRNA, rRNA, microRNA (miRNA), mature microRNA, or immature microRNA. In some embodiments, the plurality of RNA harbored by the cellular sample comprises housekeeping RNA, cell-specific RNA, tissue-specific RNA or disease-specific RNA. In some embodiments, the plurality of RNA harbored by the cellular sample comprises RNA expressed by one or more cells in response to a stimulus such as heat, light, a chemical or a drug. In some embodiments, the plurality of RNA harbored by the cellular sample comprises RNA found in healthy cells or diseased cells. In some embodiments, the plurality of RNA harbored by the cellular sample comprises RNA transcribed from transgenic DNA sequences that are introduced into the cellular sample using recombinant DNA procedures. For example, the RNA can be transcribed from a transgenic DNA sequence that is controlled by an inducible or constitutive promoter sequence. In some embodiments, the plurality of RNA harbored by the cellular sample comprises RNA that is transcribed from DNA sequences that are not transgenic.

### Culturing Cellular Sample on a Support

In any of the methods described herein, the cellular sample can be cultured on the support. In some embodiments, the methods comprise culturing the cellular sample on the support under a condition suitable for expanding the cellular sample for 2-10 generations or more. The cultured cellular sample can generate a colony of cells. In some embodiments, the methods comprise culturing the cellular sample to confluence or non-confluence. In some embodiments, the methods comprise culturing the cellular sample on the support in a simple or complex cell culture media. For example, the cell culture media comprises D-MEM high glucose (e.g., from Thermo Fisher Scientific, catalog No. 11965118), fetal bovine serum (e.g., 10% FBS; for example from Thermo Fisher Scientific, catalog No. A3160402), MEM non-essential amino acids (e.g., 0.1 mM MEM, for example from Thermo Fisher Scientific, catalog No. 11140050), L-glutamine (e.g., 6 mM L-glutamine, for example from Thermo Fisher Scientific, catalog No. A2916801), MEM sodium pyruvate (e.g., 1 mM sodium pyruvate, for example from Thermo Fisher Scientific, catalog No. 11360070), and an antibiotic (e.g., 1% penicillin-streptomycin-glutamine, for example from Thermo Fisher, catalog No. 10378016). In some embodiments, the methods comprise culturing the cellular sample at a humidity and temperature that is suitable for culturing the cell(s) on the support. Example suitable conditions comprise approximately 37° C. with a humidified atmosphere of approximately 5-10% carbon dioxide in air. The cellular sample can be cultured with suitable aeration with oxygen and/or nitrogen.

### Simple Cell Media

In any of the methods described herein, the term “simple cell media” or related terms refers to a cell media that typically lacks ingredients to support cell growth and/or proliferation in culture. Simple cell media can be used for example to wash, suspend, or dilute the cellular sample. Simple cell media can be mixed with certain ingredients to prepare a cell media that can support cell growth and/or proliferation in culture. A simple cell media comprises any one or any combination of two or more of a buffer, a phosphate compound, a sodium compound, a potassium compound, a calcium compound, a magnesium compound and/or glucose. In some embodiments, the simple cell media comprises PBS (phosphate buffered saline), DPBS (Dulbecco's phosphate-buffered saline), HBSS (Hank's balanced salt solution), DMEM (Dulbecco's Modified Eagle's Medium), EMEM (Eagle's Minimum Essential Medium), and/or EBSS. In some embodiments, the cellular sample can be placed in a simple cell media prior to or during the step of conducting any of the nucleic acid methods described herein.

### Complex Cell Media

In any of the methods described herein, the term “complex cell media” or related terms refers to a cell media that can be used to support cell growth and/or proliferation in culture without supplementation or additives. Complex cell media can include any combination of two or more of a buffering system (e.g., HEPES), inorganic salt(s), amino acid(s), protein(s), polypeptide(s), carbohydrate(s), fatty acid(s), lipid(s), purine(s) and their derivatives (e.g., hypoxanthine), pyrimidine(s) and their derivatives, and/or trace element(s). Complex cell media includes fluids obtained from a fluid or tissue extract. Complex cell media includes artificial cell media. In some embodiments, complex cell media can be a serum-containing media, for example complex cell media includes fluids such as fetal bovine serum, blood plasma, blood serum, lymph fluid, human placental cord serum and amniotic fluid. In some embodiments, complex cell media can be a serum-free media, which are typically (but not necessarily) defined cell culture media. In some embodiments, complex cell media can be a chemically-defined media which typically (but not necessarily) include recombinant polypeptides, and ultra-pure inorganic and/or organic compounds. In some embodiments, complex cell media can be a protein-free media which include for example MEM (minimal essential media) and RPMI-1640 (Roswell Park Memorial Institute). In some embodiments, the complex cell media comprises IMDM (Iscove's Modified Dulbecco's Medium. In some embodiments, the complex cell media comprises DMEM (Dulbecco's Modified Eagle's Medium). In some embodiments, the cellular sample can be placed in a complex cell media prior to or during the step of conducting any of the nucleic acid methods described herein.

In any of the methods described herein, the cellular sample can comprise a fixed cellular sample. In some embodiments, the cellular sample can be treated with a fixation reagent (e.g., a fixing reagent) that preserves the cell and its contents to inhibit degradation and can inhibit cell lysis. For example, the fixation reagent can preserve RNA harbored by the cellular sample. In some embodiments, the fixation reagent inhibits loss of nucleic acids from the cellular sample.

In some embodiments, the fixation reagent can cross-link the RNA to prevent the RNA from escaping the cellular sample. In some embodiments, a cross-linking fixation reagent comprises any combination of an aldehyde, formaldehyde, paraformaldehyde, formalin, glutaraldehyde, imidoesters, N-hydroxysuccinimide esters (NHS) and/or glyoxal (a bifunctional aldehyde).

In some embodiments, the fixation reagent comprises at least one alcohol, including methanol or ethanol. In some embodiments, the fixation reagent comprises at least one ketone, including acetone. In some embodiments, the fixation reagent comprises acetic acid, glacial acetic acid and/or picric acid. In some embodiments, the fixation reagent comprises mercuric chloride. In some embodiments, the fixation reagent comprises a zinc salt comprising zinc sulphate or zinc chloride. In some embodiments, the fixation reagent can denature polypeptides.

In some embodiments, the fixation reagent comprises 4% w/v of paraformaldehyde to water/PBS. In some embodiments, the fixation reagent comprises 10% of 35% formaldehyde at a neutral pH. In some embodiments, the fixation reagent comprises 2% v/v of glutaraldehyde to water/PBS. In some embodiments, the fixation reagent comprises 25% of 37% formaldehyde solution, 70% picric acid and 5% acetic acid.

In some embodiments, the cellular sample can be fixed on the support with 4% paraformaldehyde for about 30-60 minutes and washed with PBS.

In some embodiments, the cellular sample can be stained, de-stained or un-stained.

In any of the methods described herein, the cellular sample can comprise a permeabilized cellular sample. In some embodiments, the methods comprise treating the cellular sample with a permeabilization reagent that alters the cell membrane to permit penetration of experimental reagents into the cells. For example, the permeabilization reagent removes membrane lipids from the cell membrane. In some embodiments, the cellular sample can be treated with a permeabilization reagent which comprises any combination of an organic solvent, detergent, chemical compound, cross-linking agent and/or enzyme. In some embodiments, the organic solvents comprise acetone, ethanol, and methanol. In some embodiments, the detergents comprise saponin, Triton X-100, Tween-20, sodium dodecyl sulfate (SDS), an N-lauroylsarcosine sodium salt solution, or a nonionic polyoxyethylene surfactant (e.g., NP40). In some embodiments, the cross-linking agent comprises paraformaldehyde. In some embodiments, the enzyme comprises trypsin, pepsin or protease (e.g. proteinase K). In some embodiments, the cells can be permeabilized using an alkaline condition, or an acidic condition with a protease enzyme. In some embodiments, the permeabilization reagent comprises water and/or PBS.

For example, the fixed cells can be permeabilized with 70% ethanol for about 30-60 minutes, and the permeabilizing reagent can be exchanged with PBS-T (e.g., PBS with 0.05% Tween-20). In some embodiments, the cells can be post-fixed with 3% paraformaldehyde and 0.1% glutaraldehyde for about 30-60 minutes, and washed with PBS-T multiple times.

In any of the methods described herein, the cellular sample can be infused with a swellable polyelectrolyte hydrogel (U.S. Pat. No. 10,309,879 and Chen 2015 Science 347:543, the contents of these documents are incorporated by reference in their entireties). In some embodiments, a fixed and permeabilized cellular sample can be infused with sodium acrylate, acrylamide and a cross-linker N—N′-methylenebisacrylamide. In some embodiments, ammonium persulfate (APS) initiator and tetramethylethylenediamine (TEMED) accelerator were infused to achieve polymerization. In some embodiments, the cellular sample can be infused with proteinase K for proteolysis and incubated in a digestion buffer. In some embodiments, the gel inside the cellular sample can be swelled by addition of water.

In any of the methods described herein, the plurality of RNAs inside cellular sample can be converted to cDNA. In some embodiments, the methods comprise contacting the plurality of RNA inside the fixed and permeabilized cellular sample with (i) a plurality of reverse transcription primers, (ii) a plurality of reverse transcriptase enzymes, and (iii) a plurality of nucleotides, under a condition suitable for conducting a reverse transcription reaction to generate a plurality of cDNA molecules (e.g., a plurality of first strand cDNA molecules) in the cellular sample. In some embodiments, synthesis of second strand cDNA molecules is omitted. In some embodiments, the RNA inside the cellular sample is not converted into cDNA, where the RNA is hybridized to target-specific padlock probes.

In some embodiments, the reverse transcriptase enzyme exhibits RNA-dependent DNA polymerase activity. In some embodiments, the reverse transcriptase enzyme comprises a reverse transcriptase enzyme from AMV (avian myeloblastosis virus), M-MuLV (moloney murine leukemia virus), or HIV (human immunodeficiency virus). In some embodiment, the reverse transcriptase enzyme comprises a recombinant enzyme that exhibits reduced RNase H activity, for example REVERTAID (e.g., from Thermo Fisher Scientific, catalog No. EP0441). In some embodiments, the reverse transcriptase can be a commercially-available enzyme, including MULTISCRIBE (e.g., from Thermo Fisher Scientific, catalog #4311235), THERMOSCRIPT (e.g., from Thermo Fisher Scientific, catalog #12236-014), or ARRAYSCRIPT (e.g., from Ambion, catalog No. AM2048). In some embodiments, the reverse transcriptase enzyme comprises SUPERSCRIPT II (e.g., catalog No. 18064014), SUPERSCRIPT III (e.g., catalog No. 18080044), or SUPERSCRIPT IV enzymes (e.g., catalog No. 18090010) (all SUPERSCRIPT enzymes from Invitrogen). In some embodiments, the reverse transcription reaction can include an RNase inhibitor.

In some embodiments, the reverse transcription primers comprise a single-stranded oligonucleotide comprising DNA, RNA, or chimeric DNA/RNA. In some embodiments, the reverse transcription primers Any combination of adenine (A), thymine (T), guanine (G), cytosine (C), uracil (U) and/or inosine (I). In some embodiments, the reverse transcription primers can be any length, for example 5-25 bases, or 25-50 bases, or 50-75 bases, or 75-100 bases in length or longer. The reverse transcription primers each comprise a 5′ end and 3′ end. In some embodiments, 3′ end of the reverse transcription primers can include a 3′ OH moiety which serves as a nucleotide polymerization initiation site in a polymerase-catalyzed primer extension reaction. In some embodiments, 3′ end of the reverse transcription primers have a chain terminating moiety which blocks a polymerase-catalyzed primer extension reaction. The chain terminating moiety can be removed to convert 3′ sugar position to an extendible 3′OH.

In some embodiments, the reverse transcription primers are modified to confer resistance to nuclease degradation (e.g., ribonuclease degradation). For example, the reverse transcription primers comprise at least one phosphorothioate diester bond at their 5′ ends which can render the reverse transcription primers resistant to nuclease degradation. In some embodiments, the reverse transcription primers comprise 2-5 or more consecutive phosphorothioate diester bonds at their 5′ ends. In some embodiments, the plurality of reverse transcription primers comprise at least one ribonucleotide and/or at least one 2′-O-methyl, 2′-O-methoxyethyl (MOE), 2′ fluoro-base nucleotide. In some embodiments, the reverse transcription primers comprise phosphorylated 3′ ends. In some embodiments, the reverse transcription primers comprise locked nucleic acid (LNA) bases. In some embodiments, the reverse transcription primers comprise a phosphorylated 5′ end (e.g., using a polynucleotide kinase).

In some embodiments, the entire length of a reverse transcription primer can hybridize to a portion of an RNA molecule. In some embodiments, individual reverse transcription primers comprise a 3′ region having a sequence that hybridizes to a portion of an RNA molecule and a 5′ region that carries a tail that does not hybridize to an RNA molecule. In some embodiments, 5′ tail comprises a universal adaptor sequence including any one or any combination of two or more of a sample barcode sequence, an amplification primer binding site, a sequencing primer binding site, a compaction oligonucleotide binding site and/or a surface capture primer binding site. In some embodiments, 5′ tail comprises a unique identification sequence (e.g., unique molecular index (UMI). In some embodiments, 5′ tail comprises a restriction enzyme recognition sequence. In some embodiments, individual reverse transcription primers comprise at least a portion of 3′ region having a homopolymer sequence, for example poly-A, poly-T, poly-C, poly-G or poly-U. In some embodiments, the reverse transcription primers can hybridize to any portion of an RNA molecule, including 5′ or 3′ end of the RNA molecule, or an internal portion of the RNA molecule.

In some embodiments, the plurality of reverse transcription primers comprises a first sub-population of target-specific reverse transcription primers that hybridize selectively to the first target RNA (e.g., targeted transcriptomics). In some embodiments, the plurality of reverse transcription primers further comprise a second sub-population of target-specific reverse transcription primers that hybridize selectively to the second target RNA. In some embodiments, the target-specific reverse transcription primers comprise a pre-determined sequence at 3′ region which hybridizes to a target RNA molecule. In some embodiments, the pre-determined sequence portion of the reverse transcription primers can be 4-20 bases, or 20-40 bases, or 40-50 bases in length.

In some embodiments, the first sub-population of target-specific reverse transcription primers can selectively hybridize to an RNA transcribed in the cellular sample by a housekeeping gene. In some embodiments, selection of the housekeeping gene may be dependent upon the type of cellular sample to be used for the in situ methods described herein. Example housekeeping genes include glyceraldehyde-3-phosphate dehydrogenase (GAPDH), beta-actins (ACTB), tubulins, PPIA (peptidyl-prolyl cis-trans isomerase), NME4 (NME/NM23 nucleoside diphosphate kinase 4), SMARCALI (SWI/SNF related matrix associated actin dependent regulator of chromatin, subfamily A like 1), and POMK (protein-O-mannose kinase). The skilled artisan can design the first sub-population of target-specific reverse transcription primers to hybridize to RNA transcripts from any of the numerous housekeeping genes.

In some embodiments, the second sub-population of target-specific reverse transcription primers can selectively hybridize to an RNA transcribed from a gene that is expressed in the cellular sample being examined (e.g., a cell-specific or tissue-specific RNA).

In some embodiments, the plurality of reverse transcription primers comprises a first sub-population of random-sequence reverse transcription primers that hybridize to the first target RNA (e.g., whole transcriptomics). In some embodiments, the plurality of reverse transcription primers further comprises a second sub-population of random-sequence reverse transcription primers that hybridize to the second target RNA. In some embodiments, the reverse transcription primers comprise a random and/or degenerate sequence at 3′ region which hybridizes to an RNA molecule. In some embodiments, the random-sequence or the degenerate-sequence portion of the reverse transcription primers can be 4-20 bases, or 20-40 bases, or 40-50 bases in length.

### Nucleotides and Chain-Terminating Nucleotides

In any of the methods described herein, any of the sequencing methods described herein can employ at least one nucleotide. The nucleotides can comprise a base, sugar and at least one phosphate group. In some embodiments, at least one nucleotide in the plurality comprises an aromatic base, a five carbon sugar (e.g., ribose or deoxyribose), and one or more phosphate groups (e.g., 1-10 phosphate groups). The plurality of nucleotides can comprise at least one type of nucleotide selected from a group consisting of dATP, dGTP, dCTP, dTTP and dUTP. The plurality of nucleotides can comprise at a mixture of any combination of two or more types of nucleotides selected from a group consisting of dATP, dGTP, dCTP, dTTP and/or dUTP. In some embodiments, at least one nucleotide in the plurality is not a nucleotide analog. In some embodiments, at least one nucleotide in the plurality comprises a nucleotide analog.

In some embodiments, in any of the methods for sequencing described herein, at least one nucleotide in the plurality of nucleotides comprise a chain of one, two or three phosphorus atoms where the chain is typically attached to the 5′ carbon of the sugar moiety via an ester or phosphoramide linkage. In some embodiments, at least one nucleotide in the plurality is an analog having a phosphorus chain in which the phosphorus atoms are linked together with intervening O, S, NH, methylene or ethylene. In some embodiments, the phosphorus atoms in the chain include substituted side groups including O, S or BH₃. In some embodiments, the chain includes phosphate groups substituted with analogs including phosphoramidate, phosphorothioate, phosphordithioate, and O-methylphosphoroamidite groups.

In some embodiments, in any of the methods for sequencing described herein, at least one nucleotide in the plurality of nucleotides comprises a terminator nucleotide analog having a chain terminating moiety (e.g., blocking moiety) at the sugar 2′ position, at the sugar 3′ position, or at the sugar 2′ and 3′ position. In some embodiments, the chain terminating moiety can inhibit polymerase-catalyzed incorporation of a subsequent nucleotide unit or free nucleotide in a nascent strand during a primer extension reaction. In some embodiments, the chain terminating moiety is attached to 3′ sugar hydroxyl position where the sugar comprises a ribose or deoxyribose sugar moiety. In some embodiments, the chain terminating moiety is removable/cleavable from 3′ sugar hydroxyl position to generate a nucleotide having a 3′OH sugar group which is extendible with a subsequent nucleotide in a polymerase-catalyzed nucleotide incorporation reaction. In some embodiments, the chain terminating moiety comprises an alkyl group, alkenyl group, alkynyl group, allyl group, aryl group, benzyl group, azide group, amine group, amide group, keto group, isocyanate group, phosphate group, thio group, disulfide group, carbonate group, urea group, or silyl group. In some embodiments, the chain terminating moiety is cleavable/removable from the nucleotide, for example by reacting the chain terminating moiety with a chemical agent, pH change, light or heat. In some embodiments, the chain terminating moieties alkyl, alkenyl, alkynyl and allyl are cleavable with tetrakis(triphenylphosphine) palladium (0) (Pd(PPh₃)₄) with piperidine, or with 2,3-Dichloro-5,6-dicyano-1,4-benzo-quinone (DDQ). In some embodiments, the chain terminating moieties aryl and benzyl are cleavable with H2 Pd/C. In some embodiments, the chain terminating moieties amine, amide, keto, isocyanate, phosphate, thio, disulfide are cleavable with phosphine or with a thiol group including beta-mercaptoethanol or dithiothritol (DTT). In some embodiments, the chain terminating moiety carbonate is cleavable with potassium carbonate (K₂CO₃) in MeOH, with triethylamine in pyridine, or with Zn in acetic acid (AcOH). In some embodiments, the chain terminating moieties urea and silyl are cleavable with tetrabutylammonium fluoride, pyridine-HF, with ammonium fluoride, or with triethylamine trihydrofluoride.

In some embodiments, in any of the methods for sequencing described herein, at least one nucleotide in the plurality of nucleotides comprises a terminator nucleotide analog having a chain terminating moiety (e.g., blocking moiety) at the sugar 2′ position, at the sugar 3′ position, or at the sugar 2′ and 3′ position. In some embodiments, the chain terminating moiety comprises an azide, azido or azidomethyl group. In some embodiments, the chain terminating moiety comprises a 3′-O-azido or 3′-O-azidomethyl group. In some embodiments, the chain terminating moieties azide, azido and azidomethyl group are cleavable/removable with a phosphine compound. In some embodiments, the phosphine compound comprises a derivatized tri-alkyl phosphine moiety or a derivatized tri-aryl phosphine moiety. In some embodiments, the phosphine compound comprises Tris(2-carboxyethyl) phosphine (TCEP) or bis-sulfo triphenyl phosphine (BS-TPP) or Tri (hydroxyproyl)phosphine (THPP). In some embodiments, the cleaving agent comprises 4-dimethylaminopyridine (4-DMAP).

In some embodiments, in any of the methods for sequencing described herein, the nucleotide comprises a chain terminating moiety which is selected from a group consisting of 3′-deoxy nucleotides, 2′,3′-dideoxynucleotides, 3′-methyl, 3′-azido, 3′-azidomethyl, 3′-O-azidoalkyl, 3′-O-ethynyl, 3′-O-aminoalkyl, 3′-O-fluoroalkyl, 3′-fluoromethyl, 3′-difluoromethyl, 3′-trifluoromethyl, 3′-sulfonyl, 3′-malonyl, 3′-amino, 3′-O-amino, 3′-sulfhydral, 3′-aminomethyl, 3′-ethyl, 3′butyl, 3′-tert butyl, 3′-Fluorenylmethyloxycarbonyl, 3′ tert-Butyloxycarbonyl, 3′-O-alkyl hydroxylamino group, 3′-phosphorothioate, and 3-O-benzyl, or derivatives thereof.

In some embodiments, in any of the methods for sequencing described herein, the plurality of nucleotides comprises a plurality of nucleotides labeled with detectable reporter moiety. The detectable reporter moiety comprises a fluorophore. In some embodiments, the fluorophore is attached to the nucleotide base. In some embodiments, the fluorophore is attached to the nucleotide base with a linker which is cleavable/removable from the base. In some embodiments, at least one of the nucleotides in the plurality is not labeled with a detectable reporter moiety. In some embodiments, a particular detectable reporter moiety (e.g., fluorophore) that is attached to the nucleotide can correspond to the nucleotide base (e.g., dATP, dGTP, dCTP, dTTP or dUTP) to permit detection and identification of the nucleotide base.

In some embodiments, in any of the methods for sequencing nucleic acid molecules described herein, the cleavable linker on the nucleotide base comprises a cleavable moiety comprising an alkyl group, alkenyl group, alkynyl group, allyl group, aryl group, benzyl group, azide group, amine group, amide group, keto group, isocyanate group, phosphate group, thio group, disulfide group, carbonate group, urea group, or silyl group. In some embodiments, the cleavable linker on the base is cleavable/removable from the base by reacting the cleavable moiety with a chemical agent, pH change, light or heat. In some embodiments, the cleavable moieties alkyl, alkenyl, alkynyl and allyl are cleavable with tetrakis(triphenylphosphine) palladium (0) (Pd(PPh₃)₄) with piperidine, or with 2,3-Dichloro-5,6-dicyano-1,4-benzo-quinone (DDQ). In some embodiments, the cleavable moieties aryl and benzyl are cleavable with H2 Pd/C. In some embodiments, the cleavable moieties amine, amide, keto, isocyanate, phosphate, thio, disulfide are cleavable with phosphine or with a thiol group including beta-mercaptoethanol or dithiothritol (DTT). In some embodiments, the cleavable moiety carbonate is cleavable with potassium carbonate (K₂CO₃) in MeOH, with triethylamine in pyridine, or with Zn in acetic acid (AcOH). In some embodiments, the cleavable moieties urea and silyl are cleavable with tetrabutylammonium fluoride, pyridine-HF, with ammonium fluoride, or with triethylamine trihydrofluoride.

In some embodiments, in any of the methods for sequencing described herein, the cleavable linker on the nucleotide base comprises cleavable moiety including an azide, azido or azidomethyl group. In some embodiments, the cleavable moieties azide, azido and azidomethyl group are cleavable/removable with a phosphine compound. In some embodiments, the phosphine compound comprises a derivatized tri-alkyl phosphine moiety or a derivatized tri-aryl phosphine moiety. In some embodiments, the phosphine compound comprises Tris(2-carboxyethyl) phosphine (TCEP) or bis-sulfo triphenyl phosphine (BS-TPP) or Tri (hydroxyproyl)phosphine (THPP). In some embodiments, the cleaving agent comprises 4-dimethylaminopyridine (4-DMAP).

In some embodiments, in any of the methods for sequencing described herein, the chain terminating moiety (e.g., at the sugar 2′ and/or sugar 3′ position) and the cleavable linker on the nucleotide base have the same or different cleavable moieties. In some embodiments, the chain terminating moiety (e.g., at the sugar 2′ and/or sugar 3′ position) and the detectable reporter moiety linked to the base are chemically cleavable/removable with the same chemical agent. In some embodiments, the chain terminating moiety (e.g., at the sugar 2′ and/or sugar 3′ position) and the detectable reporter moiety linked to the base are chemically cleavable/removable with different chemical agents.

### Supports and Coatings

In any of the methods described herein, the solid support can comprise a flowcell having a coating that promotes cell adhesion. In some embodiments, the flowcell comprises a support which can be a planar or non-planar support. The support can be solid or semi-solid. In some embodiments, the support can be porous, semi-porous or non-porous. The support can be made of any material such as glass, plastic or a polymer material. In some embodiments, the surface of the support can be coated with one or more compounds to produce a passivated layer on the support (FIG. 27). In some embodiments, the passivated layer forms a porous or semi-porous layer. In some embodiments, the support is coated with a lysine compound, poly-lysine compound, arginine compound or an amino-terminated compound. The support can be coated with an unbranched compound, a branched compound, or a mixture of unbranched and branched compounds. In some embodiments, the support is coated with surface primers for capturing nucleic acids from the cellular sample. Alternatively, the support lacks surface primers.

It is to be appreciated that the Detailed Description section, and not any other section, is intended to be used to interpret the claims. Other sections may set forth one or more but not all example embodiments as contemplated by the inventor(s), and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different from those described herein.

References herein to “one embodiment,” “an embodiment,” “an example embodiment,” “some embodiments,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

While preferred embodiments of the present invention have been shown and described herein, it will be obvious to those skilled in the art that such embodiments are provided by way of example only. The breadth and scope of this disclosure should not be limited by any of the above-described example embodiments. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A computer-implemented method for image registration in primary analysis, comprising:
determining, by a processor, coordinates of polonies in a reference coordinate system, wherein the polonies are obtained from flow cell images in one or more reference cycles;
generating, by the processor, one or more template images in the reference coordinate system by registering the polonies to the one or more template images using the coordinates thereof;
obtaining, by the processor, a flow cell image in a cycle; and
determining, by the processor, a plurality of transformations of the flow cell image based on the one or more template images, each of the plurality of transformations corresponding to a subtile of the flow cell image and configured to register the subtile of the flow cell image to the one or more template images.

2. The computer-implemented method of claim 1, further comprising:
obtaining image intensities, sizes, shapes, or their combinations of the polonies from a plurality of subtiles of the flow cell images in the one or more reference cycles.

3. The computer-implemented method of claim 1, wherein determining the coordinates of the polonies in the reference coordinate system is based on one or more fiducial markers external to the flow cell images in the one or more reference cycles and the flow cell image in the cycle.

4-10. (canceled)

11. The computer-implemented method of claim 1 further comprising:
registering, by the processor, subtiles of the flow cell image to the one or more template images using the plurality of transformations.

12. The computer-implemented method of claim 1, wherein the one or more reference cycles includes one of a first 5 cycles, and the cycle is different from the one or more reference cycles.

13. The computer-implemented method of claim 1, wherein the flow cell images are from 1 channel, or 2, 3, or 4 different channels.

14. The computer-implemented method of claim 1, wherein some or all of the polonies are included in the flow cell image.

15. The computer-implemented method of claim 1, wherein some or all of the polonies are included in the subtiles of the flow cell image.

16. The computer-implemented method of claim 1, wherein some or all of the polonies are included in selected regions in the subtiles of the flow cell image.

17-22. (canceled)

23. The computer-implemented method of claim 1, further comprising:
generating, by the processor, one or more transformed images of the one or more template images.

24. (canceled)

25. The computer-implemented method of claim 1, wherein determining the plurality of transformations comprises:
for each of the plurality of transformations,
determining a corresponding cross correlation of a selected region of the subtile with the one or more template images.

26-29. (canceled)

30. The computer-implemented method of claim 1, wherein determining the plurality of transformations comprises:
for each subtile,
determining a shift, d, with a subpixel resolution, based on the corresponding cross correlation.

31. (canceled)

32. The computer-implemented method of claim 1, wherein determining the plurality of transformations comprises:
for each of the plurality of transformations,
determining the transformation of the subtile based on shifts of one or more neighboring subtiles thereof.

33-53. (canceled)

54. The computer-implemented method of claim 1, further comprising:
providing, by the processor, a plurality of nucleic acid template molecules immobilized on a support, wherein each nucleic acid template molecule comprise an insert sequence.

55. The computer-implemented method of claim 54, further comprising:
generating, by a sequencing system, the flow cell images by conducting one or more cycles of sequencing reactions of the plurality of nucleic acid template molecules immobilized on the support.

56-62. (canceled)

63. The computer-implemented method of claim 54, wherein the flow cell images comprises optical signals emitted from nucleotide reagents bound to a unbalanced diversity of nucleotide bases of A, G, C and T/U among the plurality of nucleic acid template molecules immobilized on the support in the one or more cycles.

64. (canceled)

65. (canceled)

66. The method of claim 1, further comprising:
providing, by the processor, a cellular sample having a plurality of concatemer molecules immobilized on a support, wherein each concatemer molecule corresponds to a target RNA of a cellular sample.

67-72. (canceled)

73. A computer-implemented system for image registration in primary analysis, comprising:
one or more hardware processors;
one or more data storage devices storing instructions executable by the one or more hardware processors to cause the one or more hardware processors to perform operations, the operations comprising:
determining coordinates of polonies in a reference coordinate system, wherein the polonies are obtained from flow cell images in one or more reference cycles;
generating one or more template images in the reference coordinate system by registering the polonies to the one or more template images using the coordinates thereof;
obtaining a flow cell image in a cycle; and
determining a plurality of transformations of the flow cell image based on the one or more template images, each of the plurality of transformations corresponding to a subtile of the flow cell image and configured to register the subtile of the flow cell image to the one or more template images.

74. (canceled)

75. One or more non-transitory computer readable storage media encoded with instructions that, when executed by one or more hardware processors, cause the one or more hardware processors to perform operations for image registration in primary analysis, the operations comprising:
determining coordinates of polonies in a reference coordinate system, wherein the polonies are obtained from flow cell images in one or more reference cycles;
generating one or more template images in the reference coordinate system by registering the polonies to the one or more template images using the coordinates thereof;
obtaining a flow cell image in a cycle; and
determining a plurality of transformations of the flow cell image based on the one or more template images, each of the plurality of transformations corresponding to a subtile of the flow cell image and configured to register the subtile of the flow cell image to the one or more template images.

76. (canceled)

77. A method for image registration rescue in primary analysis, comprising:
obtaining, by a processor, a first flow cell image from a first channel in a first flow cycle and a second flow cell image from a second channel in the first flow cycle, wherein the first flow cell image has emission signals from a number of polonies that is less than 1%, 2%, 5%, 10%, or 15% of a total number of polonies that emit signals in flow cell images acquired among all channels in the first flow cycle;
obtaining, by the processor, a first rescue image from the first channel in a rescue flow cycle and a second rescue image from the second channel in the rescue flow cycle;
determining, by the processor, a first plurality of transformations of the first flow cell image based on:
a second plurality of transformations of the second flow cell image;
a third plurality of transformations of the first rescue image; and
a fourth plurality of transformations of the second rescue image,
each of the first plurality of transformations corresponding to a subtile of the first flow cell image and configured to register the subtile to one or more template images or to the second flow cell image.

78-167. (canceled)

168. The method of claim 1, wherein the polonies are of an in situ sample of one or more cells or tissue.

169. The method of claim 1, wherein the polonies are of one or more samples of unbalanced diversity nucleotide bases in one or more cycles of a sequencing run.
